(19) United States
(12) Patent Application Publication
(10) Pub. No.: US 2024/0264182 A1
(43) Pub. Date: Aug. 8, 2024

(54) MULTIMODE SYSTEMS AND METHODS FOR ANALYZING CELLS

(71) Applicant: Agilent Technologies, Inc., Santa Clara, CA (US)

(72) Inventors: Brady Robert Paradis, Santa Clara, CA (US); James Niall Hynes, Little Island (IE); Maria Natalia Romero Filardo, Brookline, MA (US); Jason Dell'Arciprete, Santa Clara, CA (US)

(21) Appl. No.: 18/431,441

(22) Filed: Feb. 2, 2024

Related U.S. Application Data
(60) Provisional application No. 63/483,218, filed on Feb. 3, 2023.

(51) Int. Cl. G01N 35/00; G01N 27/07

(52) U.S. Cl. CPC G01N 35/00594; G01N 27/07

(57) ABSTRACT

Extended duration cell analysis is provided via a device, comprising: a chamber configured to accept: a sample carrier, that includes a plurality of wells having electrodes in electrical communication with an impedance meter; and a cartridge, including a compound and at least one delivery port for the compound; a camera configured to capture images of a cell culture in each well via associated windows in the wells when the sample carrier is positioned at a first location; a fluid handler, in communication with the sample carrier and the cartridge when the sample carrier is positioned at a second location, configured to deliver the compound from the cartridge to a given well based on an impedance measurement of a sample in the given well; and a motion stage configured to move the sample carrier between the first location and the second location.

### CROSS-REFERENCES TO RELATED APPLICATIONS

The present disclosure claims benefit and priority to U.S. Provisional Patent Application No. 63/483,218 filed on 2023 Feb. 3 and titled “MULTIMODE SYSTEMS AND METHODS FOR ANALYZING CELLS”, which is incorporated herein by reference in its entirety.

### FIELD OF TECHNOLOGY

Aspects and embodiments disclosed herein relate generally to the measurement of samples of living cells.

### BACKGROUND

Oxygen consumption rate (OCR) and extracellular acidification rate (ECAR) rates are key indicators of mitochondrial respiration and glycolysis and these measurements provide a systems-level view of cellular metabolic function in cultured cells and ex vivo samples. In addition, impedance measurement of live cells is widely accepted as a label free, non-invasive and quantitative analytical method to assess cell status.

Thus, there exists a need to develop new systems and methods for long-term, metabolism and/or impedance-based measurements of live cells and imaging these cells in real time.

### SUMMARY

In accordance with one aspect, there is provided a device with extended duration measurement capabilities, comprising: a sensing system comprising an array of sensor units configured to generate a first signal in response to a first analyte over an extended duration, and a second signal in response to a second analyte, over the extended duration, each sensor unit of the array of sensor units positioned to correspond with a corresponding well on a sample carrier comprising an array of wells; a stage configured to receive the sample carrier; a motion actuator assembly configured to position at least one of the stage and the sensing system relative to one another on one or more of an x-axis, a z-axis, and a y-axis; a liquid handling system to dispense a substance into at least one well of the sample carrier; a sample control element configured to control a characteristic of samples within at least one well of the sample carrier over the extended duration to be within a predefined amount of another sample within another well of the sample carrier; and a controller operatively connected to the sensing system and the sample control element, configured to: control, for the extended duration, one or more of a temperature, a humidity, and a gas content of an environment surrounding the sample carrier; and acquire data corresponding to the first signal and second signal for at least two points spanning the extended duration.

In some aspects, the extended duration measurement is made in a microchamber with a reduced volume of no greater than 3 microliters produced by the sensor unit of the array of sensor units moving down a predefined positioned into a corresponding well in the sample carrier.

In some aspects, the extended duration measurement is made in a non-continuous manner between a single modality selected from the group consisting of flux measurement, impedance measurement, and imaging.

In some aspects, the extended duration measurement is made in a non-continuous manner between at least two modalities selected from the group consisting of flux measurement, impedance measurement, and imaging.

In some aspects, the control element controls a sample environment to maintain environmental parameters at target levels of an associated well in the sample carrier.

In some aspects, the target levels for the environmental parameters are programmatically changed over a time of the extended duration measurement.

In some aspects, the control element controls the sample environment to achieve a target cellular microenvironment for a biological model in the sample via at least one of direct cellular/intracellular/pericellular/proximate measurements of sample parameters.

In some aspects, the cellular microenvironment is controlled on a per-sample basis.

In some aspects, the target levels for the sample parameters are programmatically changed over a time of the extended duration measurement.

In some aspects, the device further comprises a venting system configured to change a headspace gas composition in a cellular microenvironment.

In some aspects, the sample control element comprises one or both of: a sample temperature control element configured to control the temperature of the sample; or a sample environmental control element comprising one or both of: a gaseous control element configured to control the gas content of one or more of O₂, CO₂, and N₂ content of the sample, or a humidity control element configured to control the humidity of the environment.

In some aspects, the sample control element comprises a heater.

In some aspects, the first signal measures the first analyte in proportion to an O₂ content in a given well and the second signal measure the second analyte in proportion to a pH value in the given well.

In some aspects, the first signal is measured in parallel to the second signal.

In some aspects, the extended duration is between 6 hours and 72 hours, 6 hours to 170 hours, 6 hours to 168 hours between 12 hours and 60 hours, between 24 hours and 48 hours, between 12 hours and 36 hours, between 24 hours and 48 hours, between 36 hours and 60 hours, between 6 hours and 60 hours, between 6 hours and 48 hours, between 6 hours and 36 hours, between 6 hours and 24 hours, between 6 hours and 12 hours, between 60 hours and 72 hours, between 48 hours and 72 hours, between 36 hours and 72 hours, between 24 hours and 72 hours, between 12 hours and 72 hours, between 12 hours and 24 hours, between 24 hours and 36 hours, between 36 hours and 48 hours, or between 48 hours and 60 hours.

In some aspects, the device further comprises an image capture element configured to image a sample or a feature of the sample within each well of a plurality of wells defined in the sample carrier through an opening or a window; wherein the image capture element is configured to capture and process at least one image from each well of the sample carrier.

In some aspects, the sample carrier comprises: a plurality of wells configured to hold a predetermined amount of a sample, wherein each well of the plurality of wells comprises the opening or the window that allows for an image capture element to capture at least one image from each well of the sample carrier.

In some aspects, the device further comprises: an electrode surface comprising a non-conductive carrier on a base of the sample carrier; a plurality of electrode arrays positioned on the sample carrier, wherein each electrode array comprises at least two electrode structures positioned on a single plane and having substantially a same surface area; and a plurality of connection pads located on the sample carrier, wherein each connection pad is in electrical communication with at least one of the electrode structures in each well of the plurality of wells.

In some aspects, a plurality of wells configured to hold a predetermined amount of a sample are positioned above the plurality of electrode arrays, wherein each well of the plurality of wells comprises the opening or the window that allows for the image capture element to capture at least one image from each well of the sample carrier.

In some aspects, the device further comprises: an impedance measurement device configured to: measure impedance changes resulting from attachment of samples within each well of the sample carrier; or stimulate samples with electrical signals within each well of the sample carrier, wherein the electrode surface is at a base of the sample carrier, and wherein the electrode surface comprises a non-conductive carrier; a plurality of electrode arrays positioned on the sample carrier, wherein each electrode array comprises at least two electrode structures positioned on a shared plane and having substantially a same surface area; a plurality of connection pads located on the sample carrier, wherein each connection pad is in electrical communication with at least one of the electrode structures; wherein the impedance element detects a change in electrical impedance between or among the electrode structures or stimulates the sample with electrical signals; and wherein the impedance element detects a change in electrical impedance between or among the electrode structures or stimulation outputs of the sample from electrical signals.

In some aspects, a plurality of wells configured to hold a predetermined amount of a sample are positioned above the plurality of electrode arrays, wherein each well of the plurality of wells comprises the opening or the window that allows for the image capture element to capture at least one image from each well of the sample carrier

In accordance with one aspect, there is provided a device with extended duration measurement capabilities, comprising: a sensing system comprising an array of sensor units configured to generate a first signal in response to a first analyte over an extended duration of at least six hours, and a second signal in response to a second analyte, over the extended duration, each sensor unit of the array of sensor units positioned to correspond with a corresponding well on a sample carrier comprising an array of wells; a stage configured to receive the sample carrier; a motion actuator assembly configured to position one or both of the stage and the sensing system relative to one another on one or more of an x-axis, a z-axis, and a y-axis; a liquid handling system to dispense agents into samples within each well of the sample carrier; a sample control element comprising one or both of: a sample temperature control element configured to control temperature within each well of the sample carrier to be within a predetermined temperature of each other; or a sample environmental control element comprising one or both of: a gaseous control element configured to control O₂, CO₂, and N₂ content of each well of the sample carrier to be within a predetermined ratio of each other; or a humidity control element configured to control a humidity within each well of the sample carrier to be within a predetermined amount of each other; an image capture element, configured to image a sample or a feature of the sample within each well of the sample carrier through an opening, wherein the image capture element is configured to capture at least one image from each well of the sample carrier; an impedance element comprising an electrode surface configured to measure impedance changes resulting from attachment of samples or to stimulate samples with electrical signals within each well of the sample carrier, wherein the electrode surface is at a base of the sample carrier, and wherein the electrode surface comprises a non-conductive carrier; a plurality of electrode arrays positioned on the sample carrier, wherein each electrode array comprises at least two electrode structures positioned on a shared plane and having substantially a same surface area; a plurality of connection pads located on the sample carrier, wherein each connection pad is in electrical communication with at least one of the electrode structures; and wherein the impedance element detects a change in electrical impedance between or among the electrode structures or stimulates the sample with electrical signals; and a signal processing module operatively connected to the sensing system, configured to receive and condition the first signal and the second signal from sensor unit, and process at least one image from the image capture element and measure the change in electrical impedance from the impedance element between or among the electrode structures or stimulation output of the sample from electrical signals.

In accordance with one aspect, there is provided a device with extended duration measurement capabilities comprising: a sensing system comprising an array of sensor units configured to generate a first signal in response to a first analyte over an extended duration of at least six hours, and a second signal in response to a second analyte, over the extended duration, each sensor unit of the array of sensor units positioned to correspond with a corresponding well on a sample carrier comprising an array of wells; a stage configured to receive the sample carrier; a motion actuator assembly configured to position at least one of the stage and the sensing system relative to one another on one or more of an x-axis, a z-axis, and a y-axis; a liquid handling system configured to dispense agents into samples within each well of the sample carrier; a sample control element comprising one or both of: a sample temperature control element configured to control temperature within each well of the sample carrier to be within a predetermined temperature of each other; or a sample environmental control element comprising one or both of: a gaseous control element, configured to control O₂, CO₂, and N₂ content of each well of the sample carrier to be within a predetermined ratio of each other; and a humidity control element configured to control a humidity within each well of the sample carrier to be within a predetermined amount of each other; an impedance element comprising an electrode surface configured to measure impedance changes resulting from attachment of samples or to stimulate samples with electrical signals within each well of the sample carrier, wherein the electrode surface is at a base of the sample carrier, and wherein the electrode surface comprises a non-conductive carrier; a plurality of electrode arrays positioned on the sample carrier, wherein each electrode array comprises at least two electrode structures positioned on the same plane and having substantially the same surface area; a plurality of connection pads located on the sample carrier, wherein each connection pad is in electrical communication with at least one of the electrode structures; and wherein the impedance element detects a change in electrical impedance between or among the electrode structures or stimulates samples held in the sample carrier with electrical signals; and a signal processing module operatively connected to the sensing system, configured to receive and condition the first signal and the second signal from sensor unit, and measure the change in electrical impedance from the impedance element between or among the electrode structures or stimulation output of the sample from electrical signals.

In some aspects, the device further comprises: an image capture element configured to image a sample or a feature of the sample within each well of the sample carrier through an opening, wherein the image capture element is configured to capture at least one image from each well of the sample carrier.

In accordance with one aspect, there is provided a device with extended duration measurement capabilities, comprising: a sensing system comprising an array of sensor units configured to generate a first signal in response to a first analyte over an extended duration of at least six hours, and a second signal in response to a second analyte, over the extended duration, each sensor unit of the array of sensor units positioned to correspond with a corresponding well on a sample carrier comprising an array of wells; a stage configured to receive the sample carrier; a motion actuator assembly configured to position at least one of the stage and the sensing system relative to one another on one or more of an x-axis, a z-axis, and a y-axis; a liquid handling system configured to dispense agents into samples within each well of the sample carrier; a sample control element comprising one or both of: a sample temperature control element configured to control temperature within each well of the sample carrier to be within a predetermined temperature of each other; or a sample environmental control element comprising one or both of: a gaseous control element, configured to control O₂, CO₂, and N₂ content of each well of the sample carrier to be within a predetermined ratio of each other; or a humidity control element configured to control a humidity within each well of the sample carrier to be within a predetermined amount of each other; an image capture element configured to image a sample or a feature of the sample within each well of the sample carrier through an opening, wherein the image capture element is configured to capture at least one image from each well of the sample carrier; and a signal processing module operatively connected to the sensing system, configured to receive and condition the first signal and the second signal from sensor unit, and process at least one image from the image capture element.

In some aspects, the device further comprises: an impedance element comprising an electrode surface configured to measure impedance changes resulting from attachment of samples or to stimulate samples with electrical signals within each well of the sample carrier, wherein the electrode surface is at a base of the sample carrier, and wherein the electrode surface comprises a non-conductive carrier; a plurality of electrode arrays positioned on the sample carrier, wherein each electrode array comprises at least two electrode structures positioned on the same plane and having substantially the same surface area; a plurality of connection pads located on the sample carrier, wherein each connection pad is in electrical communication with at least one of the electrode structures; and wherein the impedance element detects a change in electrical impedance between or among the electrode structures or stimulates the sample with electrical signals.

In accordance with one aspect, there is provided a device with extended duration measurement capabilities comprising: an impedance element comprising an electrode surface configured to perform one or both of: measurement of impedance changes resulting from attachment of a sample; or stimulation of a sample with an electrical signal within each well of a plurality of wells defined in a sample carrier, wherein the electrode surface is at a base of the sample carrier, and wherein the electrode surface comprises a non-conductive carrier; a plurality of electrode arrays positioned on the sample carrier, wherein each electrode array comprises at least two electrode structures positioned on a single plane and having substantially a same surface area; a plurality of connection pads located on the sample carrier, wherein each connection pad is in electrical communication with at least one of the electrode structures, wherein the impedance element detects a change in electrical impedance between or among the electrode structures or stimulates the sample with electrical signals; an image capture element configured to image a sample or a feature of the sample within each well of the sample carrier through an opening, wherein the image capture element is configured to capture at least one image from each well of the sample carrier; and a signal processing module operatively connected to the impedance element, configured to measure the change in electrical impedance from the impedance element and process at least one image from the image capture element.

In accordance with one aspect, there is provided a sample carrier, comprising: a plurality of wells configured to hold a predetermined amount of a sample, wherein each well of the plurality of wells comprises an opening that allows for an image capture element to capture at least one image from each well of the sample carrier; an electrode surface comprising a non-conductive carrier on a base of the sample carrier; a plurality of electrode arrays positioned on the sample carrier, wherein each electrode array comprises at least two electrode structures positioned on a single plane and having substantially a same surface area; a plurality of connection pads located on the sample carrier, wherein each connection pad is in electrical communication with at least one of the electrode structures in each well of the plurality of wells; and a plurality of structures that when mated with a sensor unit of an array of sensor units create a microchamber with a reduced volume.

In some aspects, the reduced volume is less than or equal to 3 microliters.

In some aspects, structures of the plurality of structures are shelves, lips, bumps, or stops that are configured to control how far the sensor unit is able to project downward into the plurality of wells to a predefined distance.

In some aspects, the sample carrier is a microtiter plate, a flow chip, or a 3D tissue or spheroid formation/measuring plate.

In some aspects, one or more wells of the sample carrier are made of materials that limit gas diffusion.

In some aspects, one or more wells of the sample carrier comprise a window through the electrodes, that allows for viewing the cell sample or imaging from the bottom of the well.

In some aspects, one or more wells of the sample carrier do not comprise a window through the electrodes such that viewing the cell sample or imaging is performed from a top of the well opposite to where the electrodes are defined.

In some aspects, the sample carrier comprises a lid.

In some aspects, the lid comprises one or more sensors that measure at least one of O₂, pH, and CO₂.

In some aspects, the sample carrier comprises a cartridge.

In some aspects, the cartridge comprises one or more sensors or compound/substance ports.

In accordance with one aspect, there is provided an analytical device, comprising: a sample carrier comprising a plurality of wells, wherein each well of the plurality of wells: is in fluid isolation from each other wells of the plurality of wells and includes an electrode configured: for measuring impedance of a sample disposed within a given well; and to define a window through which the sample is visible from outside of the sample carrier; a flux detector, configured to individually address each well of the plurality of wells of the sample carrier and detect a first analyte; an image capture element configured to image a sample disposed in a well of the plurality of wells of the sample carrier through the window and to capture an image from each well of the plurality of wells of the sample carrier; and an environmental control module for maintaining environmental parameters ambient to the sample carrier within a predetermined range for a duration of at least six hours at a time.

In some aspects, the environmental control module maintains a CO₂ concentration, an O₂ concentration, and an N₂ concentration in an atmosphere of an environment surrounding the plurality of wells.

In some aspects, the device further comprises: a flux cartridge that is moveable, relative to the sample carrier, on an axis that is substantially perpendicular to a plane that intersects each well of the plurality of wells of the sample carrier, wherein the flux cartridge comprises a plurality of heads, wherein: the flux cartridge is configured such that each well of the plurality of wells of the sample carrier is addressable by a head from the plurality of heads; and each head of the plurality of heads, which addresses a given well, comprises a surface proximal to the sample carrier, that defines a reaction chamber within the well, and is configured to limit a volume of liquid or evaporation from the reaction chamber.

In some aspects, each well of the plurality of wells comprises a volume defining member configured to: limit a range of motion between the sample carrier and a second element of the device; or define a minimum non-zero distance between the sample carrier and the second element of the device.

In some aspects, the volume defining member comprises at least one of: a shelf, a bump; a lip; and a positional control for a motor that moves the sample carrier relative to the sensor array that stops at a certain distance above a base of a corresponding well.

In some aspects, the sample carrier is movable relative to the flux detector and the image capture element to permit the flux detector and the imaging element sequential access to the sample carrier.

In some aspects, the device further comprises: a liquid handling module configured to deliver a liquid to the sample carrier.

In some aspects, the sample carrier is movable relative to the liquid handling module.

In some aspects, the liquid handling module is configured to deliver the liquid to an individual well of the plurality of wells.

In some aspects, the flux detector is configured to detect a second analyte.

In accordance with one aspect, there is provided a device, comprising: a chamber configured to accept: a sample carrier, that includes a plurality of wells; and a cartridge, including a compound; a camera, disposed in the chamber beneath where the sample carrier is accepted into the chamber, configured to capture images of contents of individual wells of the plurality of wells; a sensor, disposed in the chamber, configured to monitor cell growth in the individual wells of the plurality of wells; a temperature controller, configured to regulate a temperature of samples held in the individual wells of the plurality of wells and the sensor; a fluid handler, in communication with the sample carrier and the compound, configured to deliver the compound from the cartridge to a given well of the plurality of wells based on one or more of pH of the contents of the given well and an image of the given well captured by the camera.

In some aspects the device further comprises an environmental controller, configured to regulate a temperature of an atmosphere in the chamber, a CO₂ concentration of the atmosphere, and an O₂ concentration of the atmosphere.

In accordance with one aspect, there is provided a device, comprising: a chamber configured to accept: a sample carrier, that includes a plurality of wells, each well of the plurality of wells having a first electrode in contact with a first side of the well and a second electrode contact with a second side, opposite to the first side, of the well that are each in electrical communication with an electrical measurement module on the sample carrier; and a cartridge, including a compound and at least one delivery port for the compound; a temperature controller, configured to regulate a temperature of samples held in individual wells of the plurality of wells and the electrical characteristic measurement module; and a fluid handler, in communication with the sample carrier and the cartridge, configured to deliver the at least one compound from the cartridge to a given well of the plurality of wells and a measurement of sample in the given well taken by the electrical measurement module between the first electrical contact and the second electrical contact.

In some aspects, the measurement of sample is measurement of cell growth in the given well as an impedance value or is a measurement of cell stimulation.

In some aspects, the device further comprises: an environmental controller, configured to regulate a temperature of an atmosphere in the chamber, a CO₂ concentration of the atmosphere, and an O₂ concentration of the atmosphere.

In accordance with one aspect, there is provided a device, comprising: a chamber configured to accept: a sample carrier, that includes a plurality of wells, wherein each well of the plurality of wells having a first electrode in contact with a first side of the well and a second electrode in contact with a second side, opposite to the first side, of the well that are each in electrical communication with an impedance meter on the sample carrier; and a cartridge, including a compound and at least one delivery port for the compound; a camera, disposed in the chamber below where the sample carrier is accepted, configured to capture images of a cell culture in each individual well of the plurality of wells via an associated window in each individual well when the sample carrier is positioned at a first location in the chamber; a fluid handler, in communication with the sample carrier and the cartridge when the sample carrier is positioned at a second location in the chamber, configured to deliver the compound from the cartridge to a given well of the plurality of wells based on an impedance measurement of a sample in the given well taken by the impedance meter between the first electrical contact and the second electrical contact; and a motion stage in contact with the sample carrier configured to move the sample carrier between the first location and the second location.

In some aspects, the device further comprises: a temperature controller, configured to regulate a temperature of samples held in the individual wells of the plurality of wells.

In some aspects, the device further comprises an environmental controller, configured to regulate a temperature of an atmosphere in the chamber, a CO₂ concentration of the atmosphere, and an O₂ concentration of the atmosphere.

In accordance with one aspect, there is provided a method of using a device, comprising: loading a sample carrier comprising one or more cell samples, each sample disposed within a corresponding well of the sample carrier, into the device.

In some aspects, the sample is analyzed over an extended duration between 6 hours and 72 hours.

In some aspects, the cell samples comprise live cells.

In accordance with one aspect, there is provided a method of analyzing a cell sample, comprising: providing a device; and loading a sample carrier comprising one or more cell samples, each sample disposed within a corresponding well of the sample carrier, into the device; and analyzing the cell sample.

In some aspects, the sample is analyzed over an extended duration between 6 hours and 72 hours.

In some aspects, the method is further comprising positioning one or both of the stage and the sensing system relative to one another on one or more of an x-axis, a z-axis, and a y-axis.

In some aspects, the method is further comprising dispensing a compound into the sample within each well of the sample carrier.

In some aspects, the method is further comprising controlling a temperature within each well of the sample carrier to be within a predetermined temperature of each other.

In some aspects, the method is further comprising controlling a gas content of each well of the sample carrier to be within a predetermined ratio of each other.

In some aspects, the method is comprising generating a first signal in response to a first analyte over an extended duration, and a second signal in response to a second analyte over the extended duration.

In some aspects, the method is further comprising receiving and conditioning the first signal and the second signal from the sensor unit.

In some aspects, the method is further comprising calculating one or more metabolic flux parameters, including at least one of: oxygen consumption rate (OCR), extracellular acidification rate (ECAR), and/or proton efflux rate (PER).

In some aspects, the method is further comprising imaging a sample or a feature of the sample within each well of the sample carrier through an opening.

In some aspects, the method is further comprising processing at least one image from the image capture element.

In some aspects, the method is further comprising measuring impedance changes of the sample.

In some aspects, the sample comprises live cells.

In some aspects, the sample comprises one or more of loose cells, cell constructs, loose tissue, tissue constructs, organelles, enzymes, cell products or byproducts, and conditioned medium.

In some aspects, the sample comprises mammalian cells or tissue.

In some aspects, the sample comprises stem cells.

In some aspects, the sample comprises cells of the cardiovascular system.

In some aspects, the sample comprises non-mammalian cells or tissue.

In some aspects, the sample comprises single-celled organisms.

In some aspects, wherein the sample comprises whole animal model tissues.

In some aspects, the sample comprises whole plant model tissues or plant model cells.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a front perspective view of an device for analyzing live cells, according to one embodiment;

FIG. 2 is a back perspective view of an device for analyzing live cells, according to one embodiment;

FIG. 3 is a side view of an device for analyzing live cells, according to one embodiment;

FIG. 4 is a top view of an device for analyzing live cells, according to one embodiment;

FIG. 5 is a side view of select components of an device for analyzing live cells, according to one embodiment;

FIG. 6 is a schematic drawing of a system for analyzing live cells, according to one embodiment;

FIG. 7 is a schematic drawing of a system for analyzing live cells, according to one embodiment;

FIG. 8 is a schematic drawing of select components of a system for analyzing live cells, according to one embodiment;

FIG. 9 is a schematic drawing of select components of an device for analyzing live cells, according to one embodiment;

FIGS. 10A-10D are graphs showing oxygen consumption rate (OCR) or extracellular acidification rate (ECAR) of live cells analyzed by the methods disclosed herein, according to one embodiment, in particular, FIGS. 10A-10B are OCR readings from a system as disclosed herein and a comparative system, respectively, showing an improved, stable performance at 0-15 minutes from the system as compared to the comparative device;

FIGS. 11A-11B are graphs showing oxygen consumption rate (OCR) of live cells analyzed by the methods disclosed herein, according to one embodiment, in particular FIGS. 11A-11B are OCR readings from a system as disclosed herein and a comparative system, respectively, demonstrating results with significantly lower variation, particularly with metformin treated cells (lower line);

FIG. 12 is a table showing average evaporation of a substance (e.g., media) contained in the sample carrier analyzed by the methods disclosed herein, according to one embodiment;

FIGS. 13A-13B are comparative illustrations of a spheroid;

FIG. 14 is a block diagram illustrating a multi-detection system according to an embodiment;

FIG. 15 is a block diagram illustrating a multi-detection system according to an embodiment;

FIG. 16 is a block diagram illustrating a multi-detection system according to an embodiment;

FIG. 17 is a block diagram illustrating a multi-detection system according to an embodiment;

FIG. 18 is a block diagram illustrating a multi-detection system according to an embodiment;

FIG. 19 is a diagram of a non-imaging analyzing subsystem according to an embodiment;

FIG. 20 is a diagram illustrating an injection subsystem according to an embodiment;

FIG. 21 is a diagram illustrating a multi-detection system according to an embodiment;

FIG. 22A is a perspective view illustrating an environmental control subsystem according to an embodiment;

FIG. 22B is a rear view illustrating the environmental control subsystem according to the embodiment;

FIG. 22C is a front view illustrating the environmental control subsystem according to the embodiment;

FIG. 23 is a functional block diagram that illustrates the control of modalities of the device according to an embodiment; and

FIG. 24 is a flowchart of a control method of a multi-detection system according to an example embodiment;

FIG. 25A is a first diagram illustrating a liquid immersion objective according to an embodiment;

FIG. 25B is a second diagram illustrating the liquid immersion objective according to the embodiment;

FIG. 26 is a diagram illustrating a fluid pump system according to an embodiment;

FIG. 27 is a diagram illustrating an objective coupling according to an embodiment;

FIG. 28A is a perspective view illustrating a liquid immersion objective according to a first embodiment;

FIG. 28B is a top view illustrating the liquid immersion objective according to the first embodiment;

FIG. 28C is a first cross-sectional view, taken along line A-A in FIG. 28B, illustrating the liquid immersion objective according to the first embodiment in a state in which a liquid bulb is provided;

FIG. 28D is a second cross-sectional view, taken along line A-A in FIG. 28B, illustrating the liquid immersion objective according to the first embodiment, over which a sample carrier (e.g., a microplate) is provided;

FIG. 29A is a top view illustrating a liquid immersion objective according to a second embodiment;

FIG. 29B is a first cross-sectional view, taken along line B-B in FIG. 29A, illustrating the liquid immersion objective according to the second embodiment, in a state in which a liquid bulb is provided;

FIG. 29C is a second cross-sectional view, taken along line B-B in FIG. 29A, illustrating the liquid immersion objective according to the second embodiment, over which a sample carrier (e.g., a microplate) is provided;

FIG. 30A is a top view illustrating a liquid immersion objective according to a third embodiment;

FIG. 30B is a first cross-sectional view, taken along line C-C in FIG. 30A, illustrating the liquid immersion objective according to the third embodiment, in a state in which a liquid bulb is provided;

FIG. 30C is a second cross-sectional view, taken along line C-C in FIG. 30A, illustrating the liquid immersion objective according to the third embodiment, over which a sample carrier (e.g., a microplate) is provided;

FIG. 31A is a top view illustrating a liquid immersion objective according to a fourth embodiment;

FIG. 31B is a first cross-sectional view, taken along line D-D in FIG. 31A, illustrating the liquid immersion objective according to the fourth embodiment, in a state in which a liquid bulb is provided;

FIG. 31C is a second cross-sectional view, taken along line D-D in FIG. 31A, illustrating the liquid immersion objective according to the fourth embodiment, over which a sample carrier (e.g., a microplate) is provided;

FIG. 32A is a first diagram of a multi-detection system in a laser point scanning confocal modality according to an embodiment;

FIG. 32B is a second diagram of the multi-detection system in a wide field or spinning disk confocal modality according to the embodiment;

FIG. 33 is a diagram of an example user interface according to an embodiment;

FIG. 34 is a schematic diagram showing a cross-sectional view of a transfer module, according to one embodiment;

FIG. 35 is a drawing of a side view of a transfer module, according to one embodiment;

FIG. 36 includes graphs showing precision of measurements taken with an device having a thermally conductive excitation source, according to one embodiment;

FIGS. 37A-37C show Mito toxicity results in a negative MTI value;

FIGS. 38A-38C show Mito toxicity results in a positive MTI value;

FIG. 39 includes exemplary MTI detection graphs;

FIG. 40 includes graphs showing kinetic dose response OCR data for 3 test compounds;

FIG. 41 is a graph showing Z′ values achieved using MitoTox assay and MTI-based analysis, according to one embodiment;

FIG. 42 illustrates a light source;

FIG. 43 illustrates relay optics;

FIG. 44 illustrates the structure of the excitation-emission separation device;

FIG. 45 illustrates a holder and associated optical accessory elements;

FIG. 46 illustrates a view of a sample carrier and imaging thereof;

FIGS. 47A-47C provide schematic representation of a device with two electrode structures;

FIG. 48 illustrates an example multimodal analysis device;

FIG. 49 shows a schematic system diagram of an embodiment of a system for analyzing live cells;

FIG. 50 shows an exploded view of the sample carrier and cartridge of FIG. 49;

FIG. 51 and FIG. 52 show plan side views, respectively, of the stage without sample carrier.

FIG. 53 and FIG. 54 show a top view and a perspective view of a bottom surface a well of a sample carrier.

FIG. 55 shows a feedback mechanism for controlling gas concentration in a well of a sample carrier.

FIGS. 56A-56C are graphs showing the oxygen consumption rate (OCR) of live cells analyzed by the methods disclosed herein, according to one embodiment, in particular, FIGS. 56A-56C are three experimental replicates of OCR readings from an analytical instrument as disclosed herein (left) and a comparative analytical instrument (right), demonstrating results with significantly lower variation, particularly at lower OCR rates when cells were plated at lower densities or after cells were treated with respiration inhibitors (Oligomycin or Rotenone+Antimycin A), from the analytical instrument as compared to the comparative instrument;

FIGS. 57A-57B are graphs of the same data showing basal oxygen consumption rate (OCR) of live cells analyzed by the methods disclosed herein, according to one embodiment, in particular, FIGS. 57A-57B are basal OCR readings from an analytical instrument as disclosed herein (left) and a comparative analytical instrument (right), demonstrating results with significantly lower variation, particularly at lower OCR rates when cells were plated at lower densities, from the analytical instrument as compared to the comparative instrument;

FIG. 58 is a graph showing the standard deviations of basal oxygen consumption rates (OCR) of live cells analyzed by the methods disclosed herein, according to one embodiment, across three experimental replicates, in particular, FIG. 58 is the standard deviations of basal OCR readings from an analytical instrument as disclosed herein (gray) and a comparative analytical instrument (black) demonstrating results with significantly lower variation from the analytical instrument as compared to the comparative instrument.

### DETAILED DESCRIPTION

The disclosure provides, at least in part, systems, methods, and consumables that allow for long-term measurements of cell samples. Disclosed herein are also multimode systems, methods, and consumables that perform bioenergy-based measurements (e.g., measurements of metabolic flux), electronics-based excitation or stimulation, electronics-based signal measurement (e.g., field potential recording, impedance measurement), and imaging. The disclosure also provides, at least in part, temperature/environmental control of parameters, such as, temperature, gas (O₂, CO₂, N₂, etc.), humidity, and atmospheric pressure. Any combination of these components are also disclosed herein.

The systems (e.g., instruments, apparatuses, and devices) and methods (e.g., assays) described herein can include, or use, one or more components, for example, a flux measurement system with extended duration measurement capabilities, an impedance measurement system, an imaging measurement system, or any combination thereof. In some embodiments, the flux measurement system can include elements for temperature/environmental control, fluid handling, or both. Conventional systems and methods may not be suitable for long-term measurements, at least in part, because of significant evaporation from the wells/sample media as well as compound/substance ports. The systems and methods described herein can control the sample environment or micro-environment to allow for allow for long-term measurements. Such control can include, for example, liquid handling, temperature control, gas control, humidity control, or any combination thereof. In some embodiments, the evaporation of the compound/substance ports can be addressed by injections of compounds via liquid handling instead of loading the compound/substance ports in the cartridge before the assay. In some embodiments, the calibration can be shortened, or even removed, when a time-based detection approach is adopted. In some embodiments, the systems or methods described herein can control the level of CO₂ to allow cell samples to proliferate. In some embodiments, the systems and methods described herein include, or uses, an impedance measurement system that is suitable for use in combination with a flux measurement system described herein.

Conventional systems and methods for separate measurements of extracellular flux, impedance, and imaging may not always be suitable for long-term measurements of cell samples, including simultaneous measurements of extracellular flux, impedance, and imaging. For example, conventional systems and methods may cause hypoxic shock to cell samples. L During long-term extracellular flux assays, evaporation of compound/substance port volumes in cartridge is a limiting factor, and therefore assays longer than six hours may not be performed without adding fluid handling. Imaging may be interfered by electrodes.

In an aspect, the disclosure provides an device that is capable of measuring one or more metabolic parameters of a cellular sample in a sample carrier at specified intervals in real-time; injecting one or more chemical compounds, exchanging cellular growth or running media, and controlling temperature and/or environmental conditions (e.g., gas, humidity) via a preloaded cartridge; simultaneously measuring one or more cellular functions via attachment/detachment of the cellular sample by measuring impedance in real-time; and facilitating long-term measurements.

In another aspect, the disclosure provides an device that is capable of measuring one or more metabolic parameters of a cellular sample in a sample carrier at specified intervals in real-time; injecting one or more chemical compounds, exchanging cellular growth or running media, and controlling temperature and/or environmental conditions (e.g., gas, humidity) via an embedded fluid handling device; simultaneously measuring one or more cellular functions via attachment/detachment of the cellular sample by measuring impedance in real-time; and facilitating long-term measurements.

In yet another aspect, the disclosure provides an device that is capable of measuring one or more metabolic parameters of a cellular sample in a sample carrier at specified intervals in real-time; injecting one or more chemical compounds, exchanging cellular growth or running media, and controlling temperature and/or environmental conditions (e.g., gas, humidity) via a preloaded cartridge; simultaneously measuring one or more cellular functions via attachment/detachment of the cellular sample by measuring impedance in real-time; and simultaneously imaging the cellular sample by visualizing through a specified area without electrodes or a gap in impedance conductors at the bottom of the sample carrier.

In still another aspect, the disclosure provides an device that is capable of measuring one or more metabolic parameters of a cellular sample in a sample carrier at specified intervals in real-time; injecting one or more chemical compounds, exchanging cellular growth or running media, and controlling temperature and/or environmental conditions (e.g., gas, humidity) via a preloaded cartridge; simultaneously measuring one or more cellular functions via attachment/detachment of the cellular sample by measuring impedance in real-time; and simultaneously imaging the cellular sample by visualizing through transparent impedance conductors at the bottom of a sample carrier.

In an aspect, the disclosure provides an device that is capable of measuring one or more metabolic parameters of a suspended cellular sample that flows into a measurement chamber from a biological growth chamber or processing unit at specified intervals in real-time; exposing the sample to one or more chemical compounds, refreshing the sample with growth or running media, and controlling temperature and/or environmental conditions (e.g., gas, humidity); simultaneously imaging the cellular sample and performing image-based fluorescence measurements; and/or impedance measurements.

In another aspect, the disclosure provides an device that is capable of measuring one or more metabolic parameters of a suspended cellular sample that flows into a measurement chamber from a biological growth chamber or bioprocessing unit at specified intervals in real-time; exposing or not exposing the sample to one or more chemical compounds, refreshing the sample with growth or running media, and controlling temperature and/or environmental conditions (e.g., gas, humidity); simultaneously imaging the cellular sample and performance image-based fluorescence measurements; and reflowing the cellular sample to the biological growth chamber or bioprocessing unit at specified intervals for further cellular proliferation, which can repeated until a time specified by a user.

In yet another aspect, the disclosure provides an device that is capable of measuring one or more metabolic parameters of a cellular sample in a sample carrier at specified intervals in real-time by monitoring one or more analytes in media at specified heights above the sample; injecting one or more chemical compounds, exchanging cellular growth or running media, and controlling temperature and/or environmental conditions (gas, humidity, etc.) via specific controllers and media via an embedded fluid handling device; and simultaneously measuring cellular functions via attachment/detachment of the cellular sample by measuring impedance in real-time.

In yet another aspect, the disclosure provides an device that is capable of measuring one or more metabolic parameters of a cellular sample in a sample carrier at specified intervals in real-time by monitoring analytes using a lid with spines with analyte sensors extended in media at specified heights above the sample; using a robotics/handler system to remove the lid with spines and place a cover or cartridge on the sample carrier; measuring one or more metabolic parameters of a cellular sample in a sample carrier at specified intervals in real-time by creating a microchamber with a cartridge that has analyte sensors at the distal end; injecting one or more chemical compounds, exchanging cellular growth or running media, and controlling temperature and/or environmental conditions (gas, humidity, etc.) via specific controllers and media via an embedded fluid handling device or by prefilled/or a user filled cartridge compound/substance port, and optionally adding media and/or washing the media in the well plate; removing the cartridge and place an analyte sensing monitoring lid with spines on top of the sample carrier; and simultaneously measuring one or more cellular functions via attachment/detachment of the cellular sample by measuring impedance in real-time.

### Definitions

Unless defined otherwise, all technical and scientific terms used herein have the same meaning as commonly understood by one of ordinary skill in the art to which the invention pertains.

As used herein, the articles “a” and “an” refer to one or to more than one (e.g., to at least one) of the grammatical object of the article.

“About” and “approximately” as the term used herein shall generally mean an acceptable degree of error for the quantity measured given the nature or precision of the measurements. Exemplary degrees of error are within 20 percent (%), typically, within 10%, and more typically, within 5% of a given value or range of values.

“Acquire” or “acquiring” as the term used herein refers to obtaining possession of a physical entity, or a value, e.g., a numerical value, by “directly acquiring” or “indirectly acquiring” the physical entity or value. “Directly acquiring” means performing a process (e.g., performing a synthetic or analytical method) to obtain the physical entity or value. “Indirectly acquiring” refers to receiving the physical entity or value from another party or source (e.g., a third-party laboratory that directly acquired the physical entity or value). Directly acquiring a physical entity includes performing a process that includes a physical change in a physical substance, e.g., a starting material. Exemplary changes include making a physical entity from two or more starting materials, shearing or fragmenting a substance, separating or purifying a substance, combining two or more separate entities into a mixture, performing a chemical reaction that includes breaking or forming a covalent or non-covalent bond. Directly acquiring a value includes performing a process that includes a physical change in a sample or another substance, e.g., performing an analytical process which includes a physical change in a substance, e.g., a sample, analyte, or reagent (sometimes referred to herein as “physical analysis”), performing an analytical method, e.g., a method which includes one or more of the following: separating or purifying a substance, e.g., an analyte, or a fragment or other derivative thereof, from another substance; combining an analyte, or fragment or other derivative thereof, with another substance, e.g., a buffer, solvent, or reactant; or changing the structure of an analyte, or a fragment or other derivative thereof, e.g., by breaking or forming a covalent or non-covalent bond, between a first and a second atom of the analyte; or by changing the structure of a reagent, or a fragment or other derivative thereof, e.g., by breaking or forming a covalent or non-covalent bond, between a first and a second atom of the reagent. In an embodiment, directly acquiring encompasses a direct measurement. In an embodiment, indirectly acquiring encompasses an inference.

“Acquiring a sample” as the term used herein refers to obtaining possession of a sample, e.g., a sample described herein, by “directly acquiring” or “indirectly acquiring” the sample. “Directly acquiring a sample” means performing a process (e.g., performing a physical method such as a surgery or extraction) to obtain the sample. “Indirectly acquiring a sample” refers to receiving the sample from another party or source (e.g., a third-party laboratory that directly acquired the sample). Directly acquiring a sample includes performing a process that includes a physical change in a physical substance, e.g., a starting material, such as a tissue, e.g., a tissue in a human patient or a tissue that has was previously isolated from a patient. Exemplary changes include making a physical entity from a starting material; dissecting or scraping a tissue; separating or purifying a substance; combining two or more separate entities into a mixture; or performing a chemical reaction that includes breaking or forming a covalent or non-covalent bond.

“Ambient temperature” as the term used herein refers to the air temperature of the environment or immediate surroundings. Ambient temperature may also be referred to as baseline temperature or the temperature of the device or object before temperature control is activated. In certain embodiments, ambient temperature may be between 1° C. and 60° C. In certain embodiments, ambient temperature may be between 18° C. to 25° C. In certain embodiments, ambient temperature may be between 1° C. to 5° C. In certain embodiments, ambient temperature may be between 32° C. to 60° C.

“Basal mitochondrial ATP production rate” as the term used herein refers to the rate of ATP production by mitochondria in a cell sample before the cell sample is contacted with an ATP synthase inhibitor, a mitochondrial uncoupling agent, and an electron transport chain (ETC) inhibitor to form a reaction mixture. In an embodiment, the basal mitochondrial ATP production rate is calculated by subtracting the minimum oxygen consumption rate (oligo OCR) to a measurement (e.g., the last measurement, or an average of a number of measurements) of oxygen consumption rate before the first contacting of the cell sample with any of the ATP synthase inhibitor, mitochondrial uncoupling agent, or ETC inhibitor (basal OCR) and multiplying by a constant between 2.45 and 2.86 (called P/O ratio)*2 (to convert oxygen atoms to oxygen molecules). In an embodiment, the constant is 2.75.

“Bioenergetic capacity” as the term used herein refers to the level of increase in glycolytic and/or mitochondrial activity that a cell can affect, utilize, and/or induce. In an embodiment, the bioenergetic capacity is determined in response to increased energy demand and/or in response to inhibition/perturbation of energy-generation. In an embodiment, the bioenergetic capacity comprises a value for oxygen consumption (e.g., an oxygen consumption rate (OCR)) and a value for proton efflux (e.g., a proton efflux rate (PER)). In an embodiment, the value for oxygen consumption (e.g., OCR) is in response to mitochondrial uncoupling. In an embodiment, the value for proton efflux (e.g., PER) in in response to ATPase inhibition. In an embodiment the PER is glycolytic PER (glycoPER), which mathematically removes the contribution of CO₂.

“Bioenergetic poise” as the term used herein refers to the balance between aerobic and glycolytic energy production. In an embodiment, the bioenergetic poise describes the proportion of ATP generated by glycolysis of oxidative phosphorylation. In an embodiment, the bioenergetic poise comprises a relationship, e.g., a ratio, between ATP made by mitochondria and ATP made by glycolysis, between ATP made by mitochondria and total ATP production, between ATP made by glycolysis and total ATP production, or any combination thereof.

“Bioenergetic work” as the term used herein refers to the amount of ATP being generated by a cell.

“Cell sample” as the term used herein refers to a sample that comprises a cell or a cell product or byproduct. In an embodiment, the cell sample comprises a plurality of cells. In an embodiment, the cell is disposed in a medium. The cell sample may be or comprise one or more of cells, tissue, cell or tissue constructs, organelles, enzymes, and/or conditioned medium.

“Cellular metabolic function” as the term used herein refers to a living organism's ability to perform chemical reactions necessary to maintain life. In embodiments, cellular metabolic function of a cell sample may be monitored by measuring OCR and ECAR.

“Extracellular acidification rate (ECAR)” as the term used herein refers to a measurement of proton extrusion in the extracellular medium over time. ECAR may be reported as rate of change of pH units, e.g., milli-pH/minute (mpH/min), over assay run time.

“Glycolysis” or “glycolytic activity” as the term used herein refers to the cellular metabolic function of converting glucose is into lactate.

“Mitochondrial respiration” as the term used herein refers to the metabolic reactions and processes requiring oxygen that take place in mitochondria to convert the energy stored in macronutrients into ATP.

“Mitochondrial toxicity index” (also referred to as “mitotox index” or “MTI”) as the term used herein refers to index values derived from OCR measurements. MTI is a parameter that provides information for both the type and magnitude of mitochondrial toxicity. Positive MTI values (typically between 0 and 1) identify mitochondrial toxicity due to uncoupling, and conversely, negative MTI values (typically between 0 and −1) identify mitochondrial toxicity due to inhibition.

“Or” is used herein to mean, and is used interchangeably with, the term “and/or”, unless context clearly indicates otherwise. The use of the term “and/or” in some places herein does not mean that uses of the term “or” are not interchangeable with the term “and/or” unless the context clearly indicates otherwise.

“Oxygen consumption rate (OCR)” as the term used herein refers to a quantitative measurement of oxygen consumption by the sample over time. Accordingly, OCR may provide a measure of cellular and mitochondrial respiration over time. OCR values may be reported in rate of change of O₂ content, e.g., picomole/minute (pmol/min) over assay run time.

In one embodiment OCR includes those scenarios in which oxygen consumption is not determined in a completely sealed system, e.g., a system allows oxygen back diffusion or substantial oxygen back diffusion to the sample, or where oxygen consumption is oxygen depletion in the sample corrected for oxygen back diffusion to the sample, or oxygen consumption is oxygen depletion without being corrected for oxygen back diffusion to the sample, or the oxygen consumption is determined in a sealed system, e.g., a system that does not allow oxygen back diffusion or substantial oxygen back diffusion to the sample, or oxygen consumption equals, or substantially equals, to oxygen depletion in the sample.

In one embodiment, oxygen consumption is determined directly or indirectly, e.g., inferred from a measured oxygen gradient, e.g., within a test well, or across a capillary, or by measuring oxygen at a preselected time point.

In one embodiment, oxygen consumption is reported in units other than rate of change of O₂ content, e.g. sensor response per unit time (such as, microseconds/min, relative fluorescence units/min).

“Primary cell” as the term used herein refers to a cell isolated or harvested directly from a subject, organ, or tissue. For example, primary cells can be isolated from blood obtained from a living subject. Primary cells can be isolated or harvested using enzymatic or mechanical methods. Once isolated or harvested, primary cells can be cultured in media containing essential nutrients and growth factors to support proliferation. Primary cells can be suspension cells that do not require attachment for growth (e.g., anchorage-independent cells) or adherent cells that require attachment for growth (e.g., anchorage-dependent cells).

“Proton efflux rate (PER)” as the term used herein refers to a quantitative measure of extracellular acidification that accounts for media buffering capacity and plate geometry. PER values may be reported in rate of change of H⁺, e.g., picomole/minute (pmol/min) over assay run time. H⁺ is a quantifiable analyte proportional to pH value.

“Sample” as the term used herein refers to a biological sample obtained or derived from a source of interest. In an embodiment, the source of interest comprises an organism, such as an animal or human. The source of the sample can be blood or a blood constituent; a bodily fluid; a solid tissue as from a fresh, frozen and/or preserved organ, tissue, biopsy, resection, smear, or aspirate; or cells from any time in gestation or development of a subject. In an embodiment, the source of the sample is blood or a blood constituent. In an embodiment, the sample is a primary sample, e.g., obtained directly from a source of interest by any appropriate means. In an embodiment, the sample is a preparation that is obtained by processing (e.g., by removing one or more components of and/or by adding one or more agents to) a primary sample.

“Sample carrier” as the term used herein refers to a substrate in which a sample can be carried. In an embodiment, the sample carrier may contain one or more wells. Exemplary sample carriers include, but are not limited to, a microplate, a microtiter plate, a multi-well plate, a single-well plate, a micro-well plate, a microfluidic-chip, microfluidic device, a dish, a slide, a flask, and a tube. The samples carrier can be used to hold various types of samples, including, but not limited to, cells, tissues, small organisms, animal models, multicellular structures, and 3D samples. As used herein, at least one well of the sample carrier can mean at least 1, 2, 3, 4, 5, 6, 12, 18, 24, 30, 36, 42, 48, 54, 60, 66, 72, 78, 84, 90, 96, 192, 288, 384, or 1536 wells, or any number of wells in between or more. As used herein, at least two wells of the sample carrier can mean at least 2, 3, 4, 5, 6, 12, 18, 24, 30, 36, 42, 48, 54, 60, 66, 72, 78, 84, 90, 96, 192, 288, 384, or 1536 wells, or any number of wells in between or more.

Systems with Extended Duration Capabilities and Multimode Systems

Without wishing to be bound by theory, it is believed that in some embodiments, the systems, consumables, and methods described herein are particularly suitable for long-term measurements of living cell samples.

In an aspect, the disclosure provides components that measure cellular bioenergy parameters, for example, metabolic flux parameters, such as oxygen consumption rate (OCR), extracellular acidification rate (ECAR), and/or proton efflux rate (PER) in real-time. In another aspect, the disclosure provides components that measure cellular electrical properties, such as, cellular impedance, and allow for electronic excitation of signals that interface with the cellular sample. In yet another aspect, the disclosure provides optical and/or imaging components, such as a microscope or inverted microscope with high-definition camera for bright field imaging and/or fluorescence imaging of cells with or without labels. In still another aspect, the disclosure provides real-time temperature/environmental control, optionally with monitoring/feedback, which is typically desired to create a more physiologically relevant measurement/sample environment. This temperature/environmental control can include, for example, temperature, humidity, atmospheric control, and gas control (oxygen, carbon dioxide, nitrogen, etc.). In another aspect, the disclosure provides injection or fluidic control of compounds to measure and quantify the interaction between target compounds and cellular activity.

In another aspect, the disclosure provides multimode systems comprising a combination of the components described above with one another in different pairs. Exemplary components of the multimode systems are further described below.

### Bioenergy Measurement, e.g., Extracellular Flux Measurement, Components

The bioenergy measurement, e.g., extracellular flux measurement, components of the system can include, for example, the formation of the microchamber, electro-optics, and/or fluorescent analyte sensors that respond in response to analyte concentration. In some embodiments, LEDs can be used to excite the analyte sensors and a detection device can be used for measuring the signal change with respect to time. The signals can be measured in any of the available detection modes including, for example, intensity, DLR, TRF, ratio-metric, ToF, etc. In some embodiments, the system can moves a z-axis component to form a microchamber between the cartridge consumable and the sample carrier (e.g., a micro-well plate). In some embodiments, a consumable that has the microelectrodes of the impedance components is used and both parameters are measured at the same time.

Other exemplary extracellular flux components of the system are described, e.g., in the section titled “Bioenergy Measurement Module” herein.

### Electrical Measurement, e.g., Electronic Excitation and Cellular Impedance Measurement, Component

The electrical measurement, e.g., electronic excitation and impedance measurement, components of the system can include, for example, a consumable with embedded microelectrodes on the cell-seeding surface. These microelectrodes can be made of materials that are easily formed and are compatible with cell growth. In some embodiments, the microelectrodes are optimized for low impedance properties to maximize accuracy of the measurements and excitation pulses. In some embodiments, the microelectrodes are arranged in a way such that the space between opposing polarity connections is minimized while increasing the length of electrodes or connected electrodes to increase the potential between microelectrodes. To read the impedance measurements, a low power signal can be excited at either end of the microelectrode seeding surface. The real and imaginary components of the impedance can then be measured. In some embodiments, the microelectrodes are excited with a very low alternating current and measured at the opposite polarity microelectrodes. The measurement of the current and voltage at the opposite side compared to the current and voltage measured at the source electrodes can present the opportunity to measure the real and imaginary components of the impedance of the cellular sample. This electronic pulse can also be used to stimulate cells that respond to electrical pulses.

Other exemplary electronic excitation and cellular impedance measurement components of the system are described, e.g., in the section titled “Electrical Measurement Module” herein.

### Imaging and Optical Components

The imaging and optical components of the system can allow for detection modes such as fluorescence intensity, luminescence, fluorescence polarization, time-resolved fluorescence, Alpha, and UV-Vis absorbance, fluorescence, phase contrast, bright field, high contrast bright field, color bright field, and phase contrast, etc. The system components can include, for example, filter cubes, image processing elements, a camera such as a CMOS or CCD device, objectives, LEDs and Lasers, and routines to allow for optimal image or measurement collection.

Other exemplary imaging components of the system are described, e.g., in the sections titled “Imaging Module” and “Optical Module” herein.

### Consumable Components

In some embodiments, the system comprises an interface to interact with a consumable. The consumable can be any cell sample holding consumable. Exemplary consumables include, but are not limited to, a flow chip, a microtiter plate with any number of wells, a 2D cell culture, and a 3D tissue or spheroid formation/measuring plate. In some embodiments, the consumable comprises a microelectrode if an impedance measurement or electrical excitation is desired. In some embodiments, the consumable is capable of forming a microchamber to allow for a flux measurement. In some embodiments, the consumable is made of materials that limit gas diffusion to increase flux sensitivity. To image the cell samples, the components that make up the image system can be configured to read from below or above the consumable. If imaging from below, the consumable may have an opening or a window through the microelectrode to view the cell sample. The opening or window is made of a clear, transparent plastic or glass that is free from microelectrodes and can be imaged through the bottom or top surface. If imaging from the top, the consumable may have any features above the sample, such as a flux measurement cartridge, removed to view the sample.

Other exemplary consumable components are described, e.g., in the section titled “Consumables” herein.

### System Functions

The system can be setup by a user to make measurements of specified modes (imaging, flux, impedance, etc.). The user can also configure the length of measurements, number of injections, incubation time, imaging settings, etc. The system can be configured to automate the movement of consumables or measurements of the consumables in the system.

### Bioenergy Measurement Module

The devices and methods described herein provide for the comprehensive view of cellular metabolic function in cultured cell samples and ex vivo samples over extended durations, lasting longer than previously available devices were able to provide. Unlike prior devices, which suffered from significant evaporation losses and the accumulation of metabolites from the samples that would not be present in vivo over a corresponding amount of time, the described extended duration device controls various characteristics for the samples, including temperature, humidity, atmospheric content, etc., to allow for analysis of metabolic function in cultured cell samples and ex vivo samples for continuous time periods of over six hours (e.g., up to seventy-two hours, 150 hours, etc.) without requiring human operator intervention. Various analysis systems can be included in the device, including flux, impedance, and imaging systems used to identify characteristics of the samples over time to a researcher, and to a control device (e.g., a computer) used to monitor and manage the conditions in the cells to maintain one or more characteristics within a predefined range over the extended duration. Accordingly, the described device is able to measure metabolic parameters in real time to control the injection of various chemical compounds, exchange cellular growth or running media, and to control environmental conditions to thereby facilitate long-term measurements.

In various embodiments, measurements in “incubator like” conditions are achieved by controlling CO₂ within the sample chamber, thereby circumventing the need for additional buffering agents (such as HEPES) that are typically used in longer term measurements. These buffering agents can be problematic for some biological models. CO₂ control to facilitates longer-term metabolic interrogation. Gas control also facilities metabolic interrogation at lower O₂ concentrations (e.g., lower O₂ achieved for example via N₂ purging), which replicates in vivo conditions or are used to model a particular disease state, (e.g. imposition of hypoxia insults, and/or cycling such as for ischemia reperfusion modelling, or longer-term tumor modelling). The levels of gases are controlled by a feedback mechanisms that control gas purging, which can include a fan to more rapidly alter the CO₂ and/or O₂ concentration at desired time points.

Bioenergetic capacity drives biological processes of cells, with cellular metabolism being a central indicator of biological function and cell health. The devices and methods disclosed herein may be used to measure metabolic pathways of cells with high throughput screening techniques. Thus, the devices and methods disclosed herein may be employed to determine and/or quantify key indicators of healthy cell function, predictions of cellular performance in in vitro disease models and compound/substance discovery, through modulation of metabolic targets, signaling, and substrates, with the aim of better understanding the disease state, allowing insight into appropriate therapies to change the disease state, a healthy phenotype, and/or to optimize and enhance cell performance.

The devices and methods disclosed herein may be employed to measure two main metabolic pathways, mitochondrial respiration and glycolysis, for live cells in real time, to provide functional kinetic measurements of cellular bioenergetic capacity.

The devices and methods disclosed herein may be provided to facilitate testing of disease models and critical cell processes including activation, proliferation, differentiation, cell death, cellular homeostasis, and/or disease progression; therapeutic discovery by revealing and validating potential therapeutic compound/substance targets; and optimize the engineering and manufacturing of cell therapies.

In one embodiment, the mitochondrial respiration, glycolic activity and/or metabolic poise is a temporal measurement of a cell's activity independent of the media/buffer surrounding the cell. Creating a microchamber allows sensitive measurements of cellular activity to be detected. A change in the cell mitochondrial respiration and/or glycolytic activity results in micro-changes of O₂, CO₂, lactate in the immediate environment surrounding the cell in real time, this change in the immediate environment is detected by the device by OCR, ECAR, and/or PER measurements.

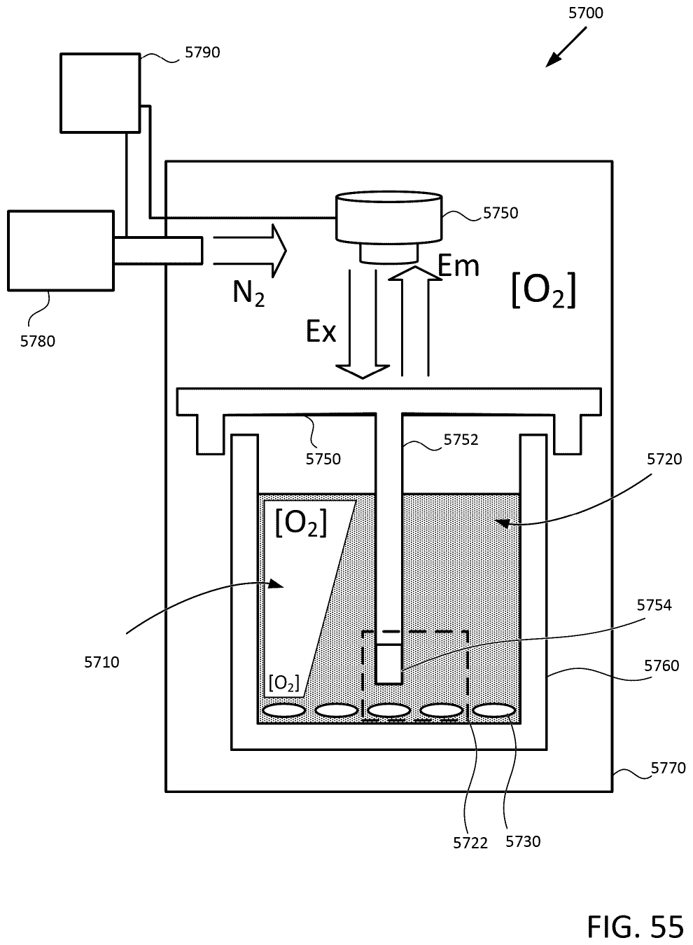

In one embodiment, the changes in cell mitochondrial respiration, glycolytic activity, and/or metabolic poise have a feedback loop that facilitates maintenance of, or transition to, a desired metabolic phenotype. This can be achieved, for example by nutrient addition via an onboard liquid handling device, or altered sample environment conditions (e.g., by altering O₂ concentration). For example, in FIG. 55, a feedback mechanism 5700 is shown in which an oxygen concentration 5710 in a cell growth medium 5720 (in which various cells 5730 are growing) is measured by an oxygen sensor 5754 attached to the distal tip of a sensor spine 5752 in a region 5722 proximal to the oxygen sensor 5754. Although an oxygen sensor 5754 is discussed herein as a non-limiting example, various other sensors for measuring different gas compositions may be used in addition to or instead of oxygen sensors 5754. The growth medium 5720 is held within a well 5760 or other compartment that is sealed or semi-sealed by a lid 5750 (in which the sensor spine 5752 is defined) relative to a measurement chamber 5770, which is also sealed or semi-sealed relative to an external environment. A measurement device 5750 receives signals from the sensor spine 5752, which are communicated to a signal processor 5790 that calculates the measured O₂ concentration 5710 in the region 5722 in real time to determine whether (and how much) N₂ to feed into the chamber 5770 from an N₂ blower 5780 to regulate the amount of O₂ or other gasses in the chamber 5770 and/or the well 5760 (e.g., by pushing out undesired gases with inflowing N₂).

In another embodiment, the mitochondrial respiration and/or glycolytic activity is a temporal measurement of a cellular activity influenced by the media/buffer surrounding the cell by the addition of gases, therapeutic drug targets or agents that impact the cell activity such as ATP synthase inhibitor, mitochondrial uncoupling agent, or ETC inhibitor to the media that influence the cell.

In particular, the devices and methods disclosed herein may be employed to measure oxygen consumption rate (OCR), extracellular acidification rate (ECAR), proton efflux rate (PER), adenosine triphosphate (ATP) production rate, and other parameters of a plurality of cell samples in a multi-well sample carrier. OCR and ECAR or PER may be used to determine mitochondrial respiration and glycolysis as well as ATP production rate. The measurements obtainable by the devices and methods disclosed herein may provide a comprehensive view of cellular metabolic function in cultured cell samples and ex vivo samples.

It should be noted that cell samples as described herein may include loose cells, cell constructs, loose tissue, and tissue construct samples. Cell samples may be or include organelles, enzymes, cell products or byproducts, and/or conditioned medium. Parameters for each cell sample (each well) may be independently and selectively measured. In particular embodiments, live cell samples may be tested, for example, without a significant reduction in cell viability. The devices and methods described herein may provide a lower dissolved oxygen or OCR detection limit, greater consistency in accurateness, improved temperature control, and improved automation over conventional devices and methods.

Conventional systems are susceptible to humidity and contamination caused by factors such as laboratory environment, storage, and manufacturing processes, tend to experience motion errors over time, including inconsistencies in movement/buildup of debris, and are susceptible to evaporation, edge well temperature gradients, and long warm up times caused by an environmental heating approach. The devices and methods disclosed herein contain components that overcome these drawbacks of the conventional systems, resulting in improved measurement performance which surprisingly provides a lower detection limit of O₂ and improved precision of measurements.

The combination of hardware and analysis software provided in the devices disclosed herein allows real-time monitoring of live cells in areas such as immunology and disease using rare, ex vivo, and genetically engineered cells to build better disease models. The enhancements disclosed herein improve measurement performance. These enhancements generally make it easier to identify novel compound/substance targets, validate target effect on cellular function, optimize disease models, and determine compound/substance safety and antitumor potential of T cell therapies going from research laboratories to biopharma therapeutic development and toxicity programs.

The device disclosed herein is capable of delivering better precision at a low oxygen consumption rate (OCR), allowing analysts to confidently interrogate more immune cell types, as well as cell types that are bioenergetically compromised.

The devices and methods disclosed herein provide the ability to analyze live cells in an extended temperature range. For instance, the temperature control element and controlled temperature zone that is smaller than the headspace of the housing contribute to improvements over previous devices.

The devices and methods disclosed herein provide more uniformity in heating the temperature control element which may improve cell biology at a consistent temperature and sensing with the device sensors, reducing systemic edge effects.

The devices and methods disclosed herein can provide temperature control at a faster start up time than previous devices.

The devices and methods disclosed herein include electronic optics boards capable of performing at humidity levels as high as 95%. Performance of previous devices is often less than optimal at 70%-80% humidity. Thus, the device may be transported, stored, or used in territorial regions of high humidity, or if there is a desire to control higher humidity inside of a device.

The devices and methods disclosed herein provide improved performance and detection at the lower levels of OCR that previously appeared as noise, which allows analysis of damaged or compromised immune cells, thereby widening the different types of cells that can be analyzed by the device.

The two major pathways to produce energy, mitochondrial respiration, and glycolysis, involve cellular consumption of oxygen and efflux of protons, respectively. The devices and methods disclosed herein include sensors, e.g., label-free sensors, to detect extracellular changes in analytes and measure rates of cellular respiration, glycolysis, and ATP production. The device described herein may be employed for determining extracellular, intracellular, and pericellular analytes.

In accordance with certain embodiments, disclosed herein is a system, also referred to as an device herein. The device may include a stage adapted to support a multi-well sample carrier, also referred to as a sample carrier or a sample carrier cartridge herein. The device may include a sensor adapted to sense a cell constituent associated with the cell sample in a well of the multi-well sample carrier. The device may include a dispensing system adapted to introduce fluids into the well. The device may include a plunger adapted to receive a barrier to create a reduced volume of media within the well including at least a portion of the cells, the barrier adapted for insertion into the well by relative movement of the stage and the plunger.

In particular, the device may include a plurality of sensors, each sensor adapted to sense a cell constituent of a corresponding well of the multi-well sample carrier. Thus, the device may include an array of sensors. The sensors may independently and selectively sense the cell constituent of each well. The dispensing system may include one or more injectors. The dispensing system may be configured to introduce fluids or agents independently and selectively into each well. The plunger may be adapted to independently and selectively be inserted into each well.

The device may include a motion actuator assembly, also referred to as an elevator mechanism herein, constructed and arranged to position or orient one or more components along at least one coordinate axis. The motion actuator assembly may include one or more high torque motors configured to drive system components.

The motion actuator assembly may include at least one axis actuator assembly. In some embodiments, the motion actuator assembly may include at least one x-axis actuator assembly configured to position the stage relative to the sensor. The x-axis actuator assembly may additionally or alternatively be configured to position the sensor relative to the stage. The x-axis actuator assembly may additionally or alternatively be configured to position the stage relative to the housing. The motion actuator assembly may include at least one z-axis actuator assembly configured to position the sensor and/or dispensing system relative to the stage. The z-axis actuator assembly may additionally or alternatively be configured to position the stage relative to the sensor and/or dispensing system. The motion actuator assembly may include at least one y-axis actuator assembly configured to position the stage relative to the sensor. The y-axis actuator assembly may additionally or alternatively be configured to position the sensor relative to the stage.

In use, the motion actuator assembly may be configured to align or substantially align the array of sensor units and/or injectors with corresponding wells of the multi-well sample carrier positioned on the stage. In use, the motion actuator assembly may be configured to effectuate a fluid communication between one or more components, e.g., a sensor unit or an injector of the dispensing system, and a sample within a well of the multi-well sample carrier.

In an exemplary embodiment, one or more sensor may be adapted to sense changes in oxygen level and pH (proton concentration) of the cellular media associated with the metabolic activity of the cell sample in a well of the multi-well sample carrier. The stage, sensor, and dispensing system may cooperate to simultaneously measure a basal oxygen consumption rate and a basal extracellular acidification rate of the cell sample using the sensor. Thereafter, the dispensing system may be used to sequentially administer to the cell sample one or more agent. In an exemplary embodiment, the one or more agent may include mitochondrial ATP synthase inhibitor (Oligomycin A), mitochondrial uncoupling agent BAM15, and/or a mixture of mitochondrial Complex I and Complex III inhibitors (rotenone and antimycin A, respectively). The sensors may measure oxygen consumption rate and extracellular acidification rate, optionally substantially simultaneously, after each dispensing of the one or more agent. An additional agent, for example, a modulator reagent, can be optionally dispensed before the dispensing of described reagents or an extracellular membrane ionophore monensin can be injected after the injection of rotenone/antimycin A to the cells. The same measurements of oxygen consumption rate and extracellular acidification rate may be performed after each dispensing.

Components of the device are further described in, e.g., U.S. Pat. No. 7,276,351 titled “Method and device for measuring multiple physiological properties of cells” and U.S. Pat. No. 8,658,349, titled “Cell analysis device and method,” each of which is incorporated herein by reference in its entirety for all purposes.

One or more of the following features may be included. The sensor may be configured to analyze the constituent without disturbing the cells. The well may include a step. The plunger or barrier may be adapted to stir the media prior to analysis of the constituent.

The sensor may be a photoluminescent based sensor. The sensor may be, for example, a fluorescent sensor, a luminescent sensor, an ISFET sensor, a surface plasmon resonance sensor, a sensor based on an optical diffraction principle, a sensor based on a principle of Wood's anomaly, an acoustic sensor, or a microwave sensor. At least a portion of the well may be adapted to receive the sensor. The reduced volume of media effectuated by the plunger may include the sensor, and/or at least a portion of the barrier may include the sensor.

The device may comprise a light source, e.g., a fluorescent light, light emitting diode (LED), or laser, configured to excite a sensor of the sensor unit to generate a signal responsive to the target analyte or property being measured. In some embodiments, the light source may be configured to produce a reference signal. Fluctuations in intensity from the light source may be corrected proportionally to drift by monitoring the reference signal produced by the light source. The light source may be positioned on a thermally conductive printed circuit assembly configured to minimize drift from the light source. In some embodiments, the thermally conductive printed circuit assembly may be formed of a material configured to minimize drift generated by heat-induced fluctuations of the light source by at least 20%, e.g., at least 15%, 10%, 5%, or 1%.

In certain embodiments, the one or more sensor may be adapted to analyze (determine the presence or concentration of) an extracellular constituent in a well, such as CO₂, O₂, Ca⁺⁺, H⁺, or a consumed or secreted cellular metabolite. Analytes proportional to O₂ content include, for example, CO₂, O₂. Analytes proportional to pH of a sample include, for example, Ca⁺⁺, H⁺. More than one analyte, e.g., at least one analyte, may be measured to analyze the extracellular constituent.

The one or more sensor may be adapted to analyze a first extracellular constituent. In some embodiments, the one or more sensor may be adapted to analyze a plurality of extracellular constituents, e.g., more than one, more than two, more than three, more than four, or more constituents. Each sensor may analyze the plurality of constituents simultaneously. Each sensor may analyze the plurality of constituents individually, e.g., sequentially. The disclosure generally describes a sensor unit configured to analyze a first target analyte, e.g., at least one analyte proportional to O₂ content, and a second target analyte, e.g., at least one analyte proportional to pH value. However, it should be understood that the sensor unit may be configured to analyze additional or alternative target analytes.

In certain embodiments, the sensor is an optical sensor. The optical sensor may be a fluorescent or phosphorescent based sensor. The sensor may alternatively utilize solid-state, nanoparticulate, microparticulate, and/or magnetic sensors, or the like. For instance, solid state sensors may include one or more spots or films on the lid, base, projections, or combination thereof, where particle base sensors may generally be in solution or in suspension. Alternatively, in one aspect, particle based sensors can be loaded into cells or coated onto a surface. Nonetheless, such sensors can include optical, O₂, pH, temperature, CO₂, or combinations thereof.

Furthermore, in one aspect, the sensor can be an electrochemical, or potentiometric sensor. Additionally or alternatively, electrodes may also be included in the well in order to measure electrical characteristics, including impedance. Notwithstanding the sensor selected, in one aspect, and as discussed above, it should be understood that the well or chamber may also contain one or more reference probes which generates a signal of known value for device calibration in the form of any of the sensors discussed above.

One exemplary sensor unit is an oxygen-sensitive photoluminescent dye. The photoluminescent dye may be selected from any oxygen sensitive photoluminescent dye. A suitable dye may be selected based on the intended use of the probe. A non-exhaustive list of suitable oxygen sensitive photoluminescent dyes includes specifically, but not exclusively, ruthenium(II)-bipyridyl and ruthenium(II)-diphenylphenanothroline complexes, porphyrin-ketones such as platinum(II)-octaethylporphine-ketone, platinum(II)-porphyrin such as platinum(II)-tetrakis(pentafluorophenyl)porphine, palladium(II)-porphyrin such as palladium(II)-tetrakis(pentafluorophenyl)porphine, phosphorescent metallocomplexes of tetrabenzoporphyrins, chlorins, azaporphyrins, and long-decay luminescent complexes of iridium(III) or osmium(II).

Typically, in such embodiments, the hydrophobic oxygen-sensitive photoluminescent dye may be compounded with a suitable oxygen-permeable and hydrophobic carrier matrix. A suitable oxygen-permeable hydrophobic carrier matrix may be selected based on the nature of the intended biological sample to be tested and the selected dye. A non-exhaustive list of suitable polymers for use as the oxygen-permeable hydrophobic carrier matrix includes specifically, but not exclusively, polystryrene, polycarbonate, polysulfone, polyvinyl chloride and some co-polymers. An alternative is to stain oxygen-permeable micro-beads with an oxygen-sensitive photoluminescent dye, mix the stained beads with silicone or polyurethane, and applying the mixture as a polymeric coating.

Regardless of the type of solid sensor selected, in one aspect for example only, the sensor may be embedded in a permeable medium, such as a permeable medium selected from hydrogel, silicone, and matrigel. In some aspects, the sensor is attached at least one of the projections by solidifying or removing the medium (such as by drying, curing, cooling, evaporating or other technique). The solid-state sensor can be applied by dipping or spotting the distal end of at least one of projections in a mixture of a fluorescent indicator in a medium.

However, it should be appreciated that in certain aspects, the sensor can be spotted or dipped onto all or a portion of one or more of the projections. It should further be appreciated that in certain aspects, the sensor can be removably connectable to the body of one or more projections of the assembly. It should further be appreciated that in certain aspects, the sensors can be integrally formed with one or more projections. Integrally forming the sensors on one or a plurality of projections can be achieved by one or more techniques, such as vapor deposition, chemical coating, spin coating, dipping, and robotic spotting.

The dispensing system may include one or more injectors configured to introduce fluids or agents independently and selectively into each well. In some embodiments, the dispensing system may include an array of injectors, e.g., at least one injector positioned to correspond with each well of the sample carrier. In some embodiments, the dispensing system may comprise one or more movable injectors, each configured to introduce fluids or agents into a plurality of wells of the sample carrier.

In certain embodiments, in order to actuate movement of the one or more injectors, e.g., across a plurality of wells, the device may comprise an injector motion actuator assembly positioned to drive the at least one injector. The injector motion actuator assembly may drive the one or more injector across a row of wells, a column of wells, or in a pre-selected pattern across any configuration of wells.

Thus, the device may have 1, 2, 3, 4, 5, 6, 7, 8, 9, or 10 moveable injectors positioned to be driven across a plurality of wells, row of wells, or column of wells. Alternatively, the dispensing system may have an array of one or more injectors, e.g., 1, 2, 3, 4, 5, 6, 7, 8, 9, or 10 fixedly positioned to correspond with each well. The device may have a ratio of wells to injectors of 1:1 to 1:384, e.g., 1:1, 1:2, 1:3, 1:4, 1:8, 1:12, 1:24, 1:36, 1:48, 1:64, 1:72, 1:96, 1:192, or 1:384. The device may have a ratio of injectors to wells of 1:1 to 1:384, e.g., 1:1, 1:2, 1:3, 1:4, 1:8, 1:12, 1:24, 1:36, 1:48, 1:64, 1:72, 1:96, 1:192, or 1:384.

The assembly and processes according to example aspects of the disclosure can be well suited to measuring constituents in all different types of samples, such as biological samples. In one aspect, for instance, the systems and processes according to example aspects of the disclosure can be used to measure one or more constituents or a parameter related to the constituent in cellular material. The one or more constituents may be contained in a medium surrounding the cells or can be contained within the cells themselves. In some embodiments, the biological sample being tested may contain cellular material derived from cells, such as cellular organelles, mitochondria, cellular extracts, cell products or byproducts, or conditioned medium. The measurements can be completed in a label-free manner.

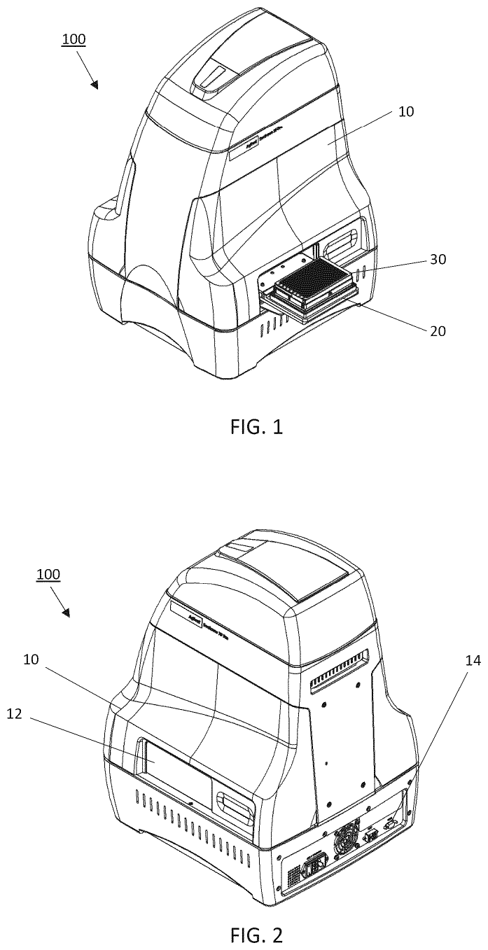

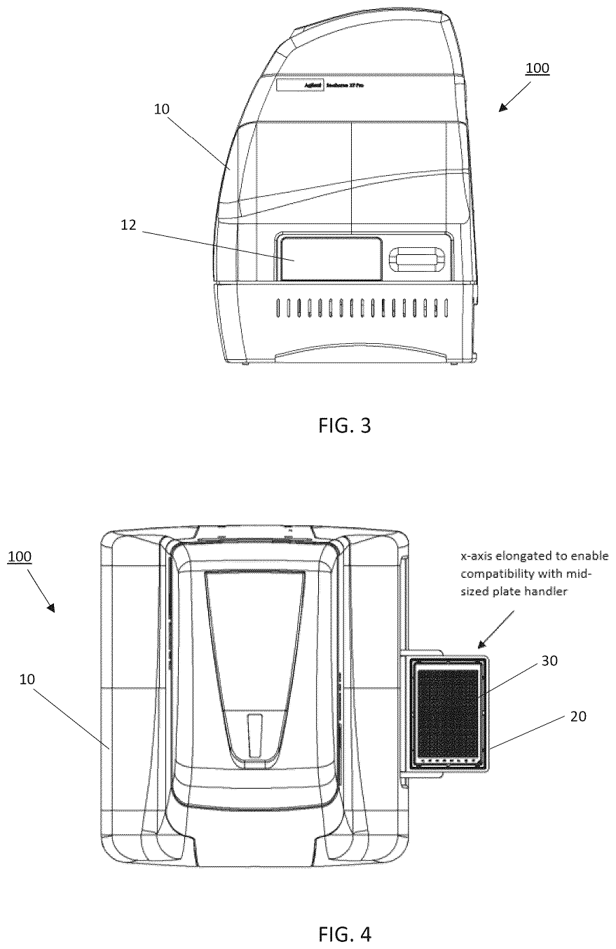

An exemplary system is shown in FIGS. 1-4. As shown in FIGS. 1-4, the device or device 100 includes a housing 10 having an opening on a side wall of the housing 10. The opening may optionally be closeable by a door 12. Within the housing 10 there is provided a stage 20 adapted to receive a multi-well sample carrier 30. The stage 20 may be movable to be positioned within the housing 10 or exterior to the housing 10 through the opening by an x-axis actuator assembly. The door 12 may be shut when the stage 20 is positioned within the housing 10 for testing. The housing may include one or more electronic port 14 connectable to a computer and/or power source.

The electronic port 14 may be compatible with one or more of USB, mini-USB, HDMI, DVI, dual DVI, mini-DVI, micro-DVI, display port, mini display port, VGA, mini-VGA, RS-232, Ethernet/LAN, or any other electronic port capable of transmitting data. The device shown in FIGS. 1-4 includes an electronic port 14, however, it should be noted that the device may be connectable to an external computer by any means known in the art, for example, wireless fidelity network (WiFi), ultrahigh frequency radio waves (also known as Bluetooth®), or any other data transmitting connection. In embodiments, the device may be connectable to an external computer through the cloud.

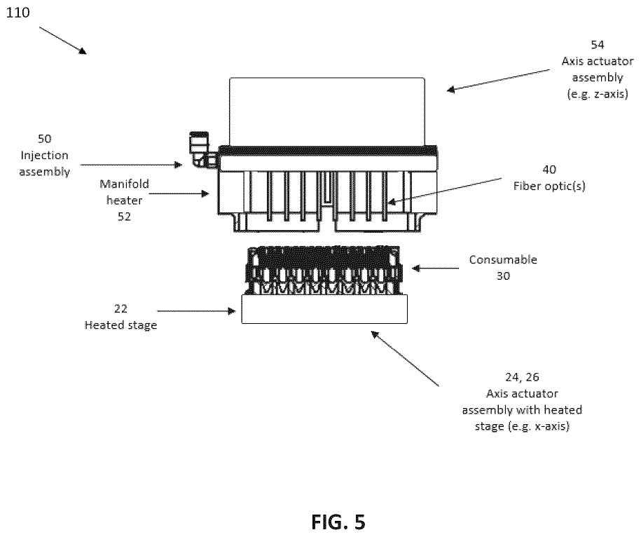

An exemplary assembly 110 is shown in FIG. 5. The assembly 110 may be contained within housing 10 shown in FIGS. 1-4. The assembly 110 includes the components of a sensing system 40 (e.g., fiber optic) comprising an array of sensor units and dispensing system 50 comprising an array of injectors disposed on a manifold. In some embodiments, the manifold includes holes where pressurized air can be forced through injection substance/material ports on a sensor cartridge that have substance/material ports that correspond to the holes in the manifold and is ‘sealed’ by a gasket and a force applied to the manifold. One or more component of the manifold may be independently movable on a z-axis as directed by the z-axis actuator assembly 54 of a motion actuator assembly. Temperature of the manifold and/or cartridge may be controlled by manifold temperature controller 52. The assembly 110 includes stage 20 adapted to receive multi-well sample carrier 30 (with a cartridge shown on top). Temperature of the samples within multi-well sample carrier 30 may be controlled by sample temperature control element 22. The stage 20 is movable along an x-axis as directed by the x-axis actuator assembly 24 of the motion actuator assembly. The motion actuator assembly also includes a y-axis actuator assembly 26 configured to move stage 20 along a y-axis.

The device may include an automated measurement system. The device may also include or be connectable to a computer, with the automated measurement system being in electrical communication with the computer. In certain embodiments, the device may also include a controller for effecting the addition of one or more fluids or agents to one or more of the wells of the microplate. The controller may operate the sensor to effectuate the sensing of one or more constituent in the one or more wells of the microplate. The system may be in communication with the controller and the sensor via a graphical user interface residing on the computer. The graphical user interface may be configured to receive instructions for the design of a multi-well experiment in accordance with the methods disclosed herein, instruct the controller to execute the multi-well experiment, and to receive the data acquired by the sensor in response to the execution of the multi-well experiment.

In certain embodiments, the graphical user interface may include a plurality of display areas, each area being attributed to one of the wells. The graphical user interface may be configured to receive instructions written in respective areas attributed to one of the wells for the design of a multi-well experiment, and receive the data acquired by the sensors in response to the execution of the multi-well experiment for display in a respective area attributed to one of the wells. Thus, the methods, executable by the controller, may be independently and selectively applied to one or more wells through instruction from the graphic user interface.

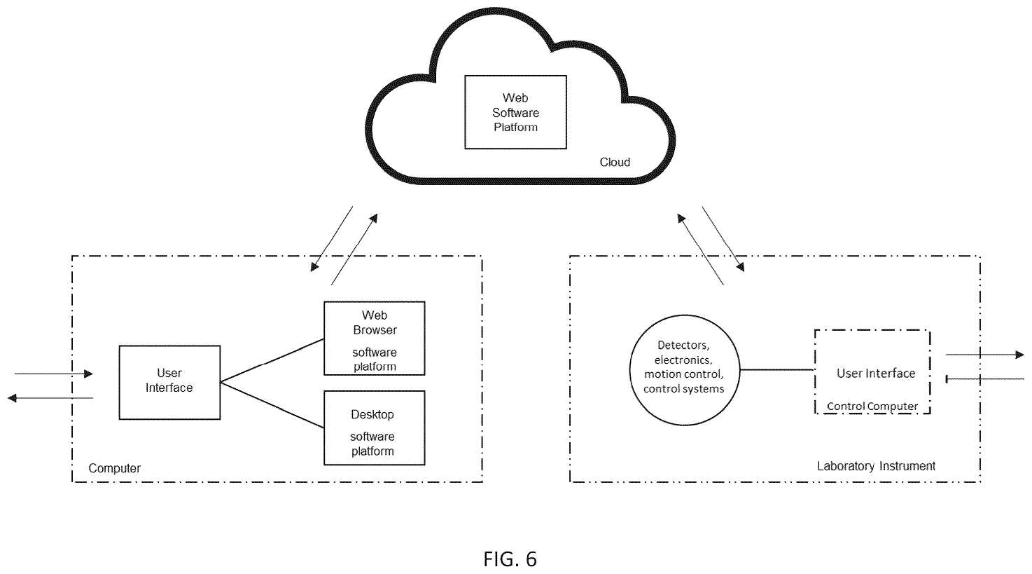

FIG. 6 shows an exemplary system including the system (laboratory device) connectable to a cloud-based computing network and a computer through the cloud-based network. The system includes detectors or sensor units and other electronics, such as the signal processing module and motion actuators. The detectors and electronics are controllable by one or more controller such as a motion controller operably connected to the motion actuator assembly and a control system operably connected to the sensing system and/or dispensing system. Protocols for the system components may be provided through the user interface accessible on the computing device or cloud-based computing network. The user interface may be provided on a web browser software platform and/or on a desktop software platform. It should be noted that the desktop software platform may be provided on a desktop computer, laptop computer, and/or tablet or other mobile device. The web browser software platform may provide cloud-based data processing, cloud-based data storage, and/or the cloud-based connection between the computer and the system. Other mechanisms for connecting to the cloud may be used, for example, desktop software or driver software. A data storage module may also be included in the system, for example, a local memory storage device, e.g., servers, external drives, portable drives, and/or a cloud-based memory storage device. The data storage module may store historical data, protocols, data processing algorithms, and/or controller executable instructions.

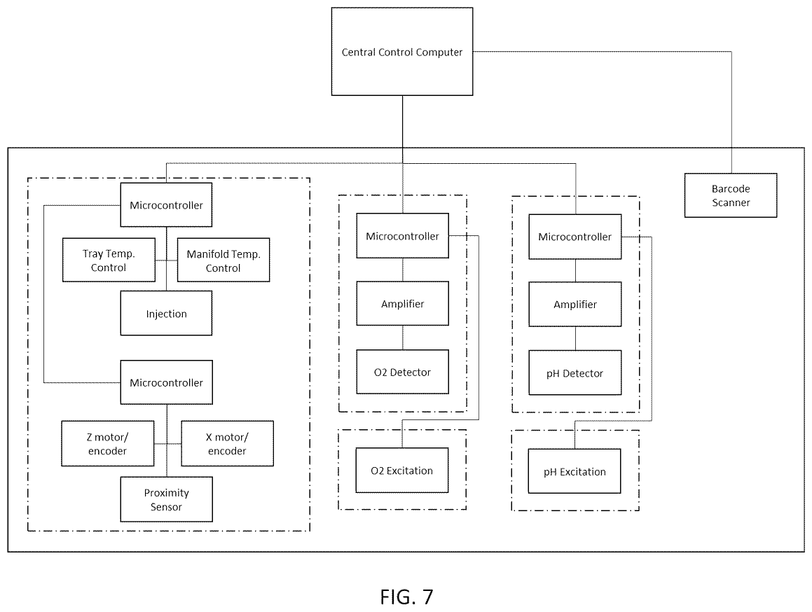

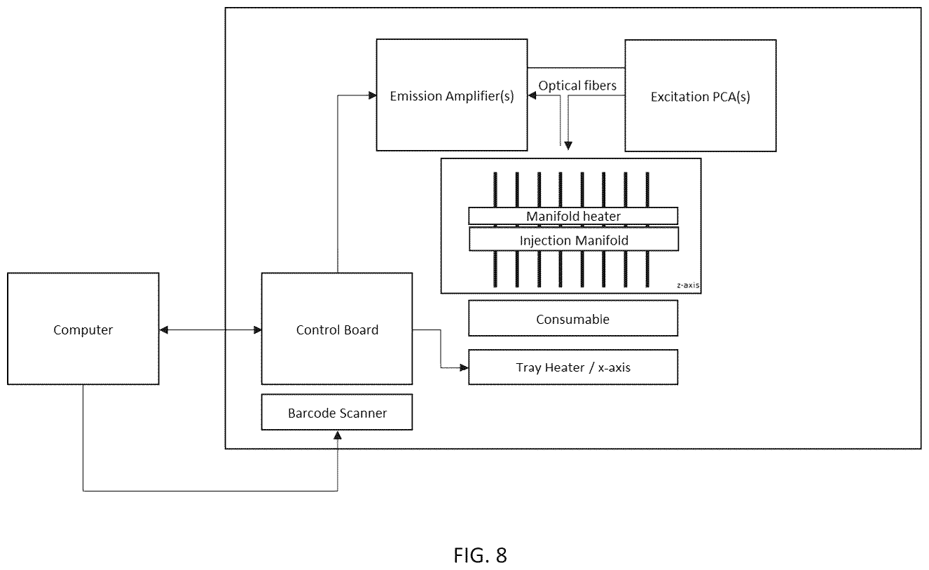

FIGS. 7-8 are schematic diagrams of the systems disclosed herein and electronic components shown in more detail. FIG. 7 is a diagram of the system operably connected to a central control computer. The baseboard includes a microcontroller or system controller operably connected to temperature control elements for the manifold and tray (i.e., sample temperature control element) and a dispensing system or injection unit. A further microcontroller, also referred to as “motion controller” herein, is shown operably connecting the controller and motion actuator assembly including a z motor operating the z-axis actuator assembly and an x motor operating the x-axis and optionally y-axis actuator assembly. The device described herein may comprise stepper motors with higher torque that improve precision in measurements over the life of the device and reduce the need to provide maintenance and/or replace motor components.

A proximity and/or encoder sensor is also provided as part of the motion actuator assembly configured to sense relative positioning of the stage or multi-well sample carrier and other device components, such as the sensor units and dispensing system injectors. The proximity sensor may be configured to generate a notification signal, and optionally pause a protocol, if a component is positioned within a predetermined distance from another component, e.g., a sensor unit within a predetermined distance from a corresponding well of the sample carrier. Additionally or alternatively, the proximity sensor may be configured to generate a notification signal, and optionally pause a protocol, if the opening on the side wall of the housing is ajar and/or external light is detected within the housing.

The system may also contain a stall sensing module programmed to generate a notification signal, and optionally pause a protocol, e.g., halt motor movement, if a predetermined protocol step is not completed within a predetermined time interval. The stall sensing module may be configured to detect stalls through the use of encoders. For instance, the encoders may operate by looking for timing related delays in the encoder travel and flag a stall.

The diagram of FIG. 7 also includes sensing units for an O₂ analyte and a pH analyte operably connected to a signal processing module comprising an amplifier and microcontroller configured to receive and amplify signals from the sensor units. The signal processing module is further operably connected to the system controller and central control computer. The system further includes a barcode scanner configured to scan a barcode encoding information operably transmittable to the central control computer.

FIG. 8 is a schematic diagram of the system showing the computer operably connectable to the system control board or system controller and barcode scanner. The barcode scanner is configured to decode and transmit information from the barcode to the computer. The system controller is operably connected to the tray heater or sample temperature control element configured to control temperature of the consumable or samples within a multi-well sample carrier. The system controller is also operably connected to the emission amplifier or signal processing module. The signal processing module is operably connected to the optical fibers or sensor units. In some embodiments, the system controller is also operably connected to the manifold heater or manifold temperature control element configured to control temperature of the injection manifold or dispensing system. Optionally, a separate system controller may be provided operably connected to the manifold heater or manifold temperature control element.

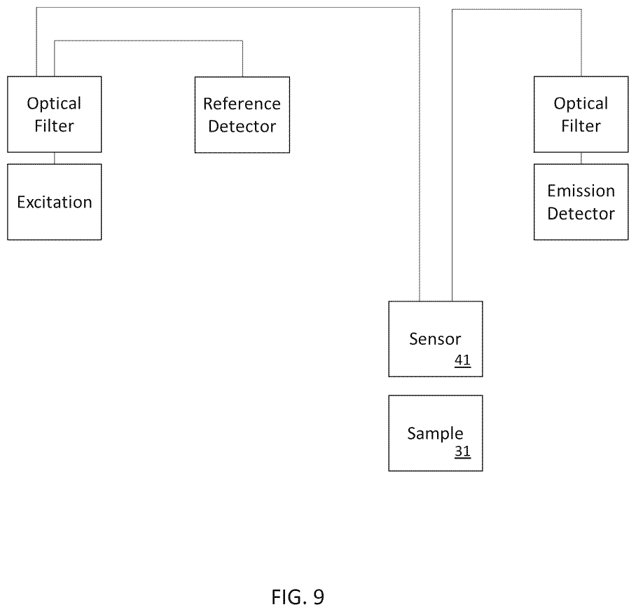

FIG. 9 shows an exemplary sensor unit 41 deployed within a well 31. The exemplary sensor unit 31 is a fluorescent sensor. Disposed on the surface of the well 31 there may be a fluorophore having fluorescent properties dependent on at least one of the presence and the concentration of a constituent in the well 31. The sensor unit 41 may include a housing for receiving a wave guide for at least one of stimulating the fluorophore and for receiving fluorescent emissions from the fluorophore.

The disclosure provides a method, device, and measurement system for adding a test compound to a well and measuring a constituent of the well with a sensor. The method may be performed as a high-throughput assay, by adding one or more test compound to one or more wells, respectively, or multiple of the same or different test compounds to multiple wells of a microplate. In certain embodiments, the test compound is introduced while a sensor probe remains in equilibrium with, e.g., remains submerged within, the liquid contained within each well. In such embodiments, because the sensor probe remains submerged during compound delivery, equilibration time may be reduced. Thus, a system and a method are provided for storing and dispensing a single preselected test compound, or preselected concentration of the compound per well.

In certain embodiments, the device and method store and deliver one or more test compounds or target agents per well. Test compounds may be delivered using a supply of compressed gas from a remote source to actuate the compound delivery. In certain embodiments, both the sensor probe and test compound delivery structure are incorporated within a single disposable cartridge. A pneumatic multiplexer is also described that, when temporarily attached to the cartridge, allows a single actuator to initiate the delivery of test compound from multiple ports using a supply of compressed gas from a remote source.

In one aspect, there is provided a cartridge adapted to mate with a multi-well sample carrier having a plurality of wells. The cartridge may include a substantially planar element having a plurality of regions corresponding to a common number of respective openings of the wells in the multi-well sample carrier. At least one port may be formed in the cartridge in at least one region, the port being adapted to deliver a test fluid, e.g., an aqueous solution of a candidate compound/substance compound or other agent, to the respective well. The cartridge may also include at least one of a) a sensor or portion thereof adapted to analyze a constituent in a well and b) an aperture adapted to receive a sensor located in a sub region of the at least one region of the cartridge.

Components and features of the cartridge are further described in, e.g., U.S. Pat. No. 9,170,255 titled “Cell analysis device and method,” which is incorporated herein by reference in its entirety for all purposes.

The device may include an elevator mechanism adapted to move the cartridge relative to the stage or the plate to dispose the sensor in the well, typically multiple sensors in multiple wells simultaneously. A pressure source adapted to be mated fluidically with the cartridge may be provided, to deliver the test fluid from a port in the cartridge to a well. The device may also include a multiplexer disposed between the pressure source and the cartridge, the multiplexer being adapted to be in fluidic communication with a plurality of ports formed in the cartridge. The multiplexer may be in fluidic communication selectively with exclusive sets of ports formed in the cartridge. A controller may be provided to control the elevator mechanism, the multiplexer, and/or the pressure source to enable delivery of test fluid from a given port or set of ports to a corresponding well or set of wells when an associated sensor is disposed in the well. The controller may be in communication with the computer or graphical interface, as previously described.

In certain exemplary embodiments, the aperture of the cartridge adapted to receive the sensor may comprise a sensor sleeve structure having a surface proximal to a well of the multi-well sample carrier. Disposed on the surface may be a fluorophore having fluorescent properties dependent on at least one of the presence and the concentration of a constituent in the well. The sensor sleeve may include an elongate housing for receiving a wave guide for at least one of stimulating the fluorophore and for receiving fluorescent emissions from the fluorophore.

An array of sensors corresponding to an array of wells may be integral with the cartridge, but may also be separate elements mated with and disposed within apertures formed in the cartridge. The sensor array may be mounted compliantly relative to the sample carrier.

Methods of analyzing cells with the device disclosed herein are provided. The methods may be employed to measure cells disposed in media in a multi-well sample carrier. The method may include one or more of disposing as least a portion of a sensor in media in a well in the multi-well sample carrier, analyzing a constituent related to the cells within the media in the well, delivering a test fluid to the well while the sensor remains disposed in the media in the well, and further analyzing the constituent to determine any change therein. In certain embodiments, one or more constituent may be analyzed substantially simultaneously. In particular, a rate change of the one or more constituent may be measured over the assay time, for example, to determine metabolic or other activity of the cell sample.

The analyzing step may include analyzing respective constituents related to respective cells within media in respective wells. The respective constituents may be the same constituent. The delivering step may include delivering respective test fluids or target agents to the respective wells while respective sensors remain disposed within media in respective wells. The respective test fluids or agents may include the same test fluid or agent.

The step of analyzing may include analyzing respective constituents related to respective cells within media in respective wells to determine any respective changes therein. The delivering step and the further analyzing step may be repeated. A different test fluid or agent or an additional aliquot of the same test fluid or agent may be delivered between measurements. The method may include substantially maintaining equilibration between the sensor and the media during the delivery step or maintaining thermal equilibrium between the test fluid and the media during the delivery step.

The methods may include controlling temperature and/or an environment of the cell samples before, during, and/or after the analyzing step. In certain embodiments, the methods may include controlling temperature and/or an environment of the cell samples throughout performance of the analytical method. Controlling environment may include, for example, controlling relative humidity (RH) and/or a composition of the environmental gas, such as N₂, O₂, and/or CO₂ concentration. For example, in certain embodiments, controlling environment may include inducing a hypoxic environment by purging the air with N₂ gas.

The method may further include imaging or scanning the samples during the analyzing step, during the delivering step, and/or subsequent to the analyzing step and/or the delivering step.

The devices and methods disclosed herein may be used to analyze biological samples, also referred to as cell samples herein. In particular, the devices and methods disclosed herein may be used to analyze live cell samples. The samples may comprise or be in the form of one or more of loose cells, cell constructs, loose tissue, tissue constructs, organelles, enzymes, cell products or byproducts, and conditioned medium. The cell samples may comprise mammalian cells or tissue. The cell samples may comprise non-mammalian cells or tissue. The samples may comprise animal cells or tissue. The samples may comprise insect cells or tissue. The samples may comprise plant cells or tissue, e.g., seeds, pods, or other plant materials. The samples may comprise single-celled organisms, e.g., microorganisms. In certain exemplary embodiments, the sample may comprise whole plant or animal model tissues, e.g., zebrafish, C. elegans, drosophila.

The biological material being analyzed may comprise a cellular material. The biological material may contain living cells comprising bacteria cells, fungus cells, yeast cells, prokaryotic cells, eukaryotic cells, insect cells, or the like. The cells can be animal cells, human cells, immune cells, or immortal cells.

Exemplary cells include human T cells (CD4+, Pan CD3+, CD8+, PBMC, e.g., naïve, activated, effector and memory), mouse T cells (spleen derived CD8 naive and activated), immortalized mouse myoblast cells (e.g., C2C12), Jurkat cells, lung cancer cell models (A549, PC9, H1373), leukemia cancer cell model (THP-1), human hepatoma cells (e.g., HepG2), human epidermoid carcinoma cells (e.g., A431), and analysis of entire organisms, such as zebrafish, C. elegans, and drosophila. Certain aspects of the devices and methods disclosed herein enable analysis of live cells requiring a temperature of 28° C.-40° C., without the need to place the device in a temperature-controlled room.

The devices and methods disclosed herein may be employed to facilitate research in the fields of cancer, immunology, toxicology, compound/substance discovery, and immunotherapy, among others.

In one aspect, the cell sample is obtained or derived from a subject, such as a human or non-human animal. In one aspect, the subject is a mouse, which, in an aspect, has, or is at risk of having, a disorder. Nonetheless, in an aspect, the cell sample can include a primary cell, a cell isolated or harvested directly from a living tissue or organ, a cultured cell, and/or an immortalized cell. For instance, the cell sample can include a primary cell, or a cell isolated or harvested directly from a living tissue or organ, and then cultured ex vivo. In an aspect, the cell sample includes a cell that has been modified, e.g., genetically engineered for heterologous expression of a gene of interest, and/or genetically engineered for inhibition expression of a gene, such as cells from knock out mouse or CRISPR KO libraries. Nonetheless, in one aspect, the cell sample includes a stem cell or a cell derived from a stem cell. Nonetheless, regardless of the cell used, in one aspect, the cell sample includes a medium, e.g., a culture medium or a growth medium, where the cell can be disposed in the medium. Furthermore, as would be understood, in one aspect, the cell sample comprises a plurality of cells, e.g., a plurality of cells described herein.

The cells being tested can comprise any suitable cell sample, including but not limited to cultured cells, primary cells, human cells, neurons, T cells, B cells, epithelial cells, muscle cells, stem cells, induced pluripotent stem cells, immortalized cells, pathogen-infected cells, bacterial cells, fungal cells, plant cells, archaeal cells, mammalian cells, bird cells, insect cells, reptile cells, amphibian cells, and the like. The cells being tested may also comprise a monolayer of cells, two-dimensional cell samples, three-dimensional cell samples, such as tissue samples, cell spheroids, organoids, biopsied samples, cell scaffolds, organs-on-a-chip, and the like. Examples of parameters that may be measured and are related to the above cell functions include carbon dioxide concentration, oxygen concentration or oxygen partial pressure, calcium ions, hydrogen ions, and the like. However, in one aspect, the measured parameter is oxygen concentration, such as oxygen consumption. Through these tests, one can gain an understanding of what drives cell phenotype and function and/or an accurate picture of the cellular environment or microenvironment.

The assembly and process according to example aspects of the present disclosure can be used to measure live cell metabolic data, or (micro)environmental conditions of any viable cell. The cellular material being tested, for instance, can comprise bacteria cells, fungus cells, yeast cells, prokaryotic cells, eukaryotic cells, and the like. Cells that can be tested include mammalian cells including animal cells and human cells. Particular cells that can be tested include cancer cells, immune cells, immortal cells, primary cells, induced pluripotent stem cells, cells infected with viral or bacterial pathogens, and the like.

For example, in one aspect, the assembly and process according to example aspects of the disclosure can be used to assist in immunotherapy. Immunotherapy is a type of treatment that bolsters a patient's immune system for fighting cancer, infections, and other diseases. Immunotherapy processes, for instance, can include adoptive cell based therapies, such as the production of T cells, Natural Killer (NK) cells, monocytes, macrophages, combinations thereof and the like. During T cell therapy, for instance, T cells are removed from a patient's blood. The T cells are then sent to a bioreactor and expanded or cultivated. In addition, the T cells can be changed so that they have specific proteins called receptors. The receptors on the T cells are designed to recognize and target unwanted cells in the body, such as cancer cells. The modified T cells are cultivated in a bioreactor to achieve a certain cell density and then supplied to a patient's body for fighting cancer or other diseases. T cell therapy can also be referred to as adoptive T cell therapy or T-cell transfer therapy, one example of which is referred to chimeric antigen receptor (CAR) T cell therapy. The use of T cells for adoptive T cell therapy or T-cell transfer therapy has recently proliferated due to great success in combating blood diseases. In some embodiments, aspects of the present invention may be used to monitor the health of T cells used in adoptive T cell therapy or T-cell transfer therapy. In some embodiments, aspects of the present invention may be used to monitor T cell activation, T cell exhaustion, T cell metabolism including of starting material and modified products, and the like.

NK cells are a type of cytotoxic lymphocyte that can seek out and destroy infected cells within the body. NK cells can display very fast immune reaction responses. Consequently, the use of NK cells in anticancer therapy has grown tremendously in interest and popularity. There is only a limited number of NK cells in the blood of a mammal, however, requiring that NK cells be grown to relatively high cell densities within bioreactors.

The culturing of cells, such as T cells, NK cells, or other mammalian cells, typically requires a somewhat complex process from inoculation to use in patients. The assembly and process of the present disclosure can be used to monitor cell metabolism during any point in the culturing process to ensure that the cells are healthy, and/or have the desired metabolic phenotype, and that the media in which the cells are growing contains an optimized level of nutrients. The system and process, for instance, can be used to make adjustments for assuring the metabolic fitness of the cells as they are growing.

In addition to immune cells, the metabolism of cancer cells can also be monitored for providing an understanding of which nutrients fuel the cancer cells. For example, the assembly and process according to example aspects of the present disclosure can reveal mechanisms or components that impact the metabolism of the cancer cells for inhibiting growth. The assembly and process according to example aspects of the present disclosure can also be used to determine the speed at which the cancer cells may proliferate. The system and process of the present disclosure is also well suited for use in toxicology. For instance, the process and assembly of the present disclosure can be used to detect mitochondrial liabilities among potential therapeutics. The risk of mitochondrial toxicity, for instance, can be assessed with high specificity and sensitivity. In this manner, the mechanism of action of some mitochondrial toxicants can be determined.

### Electrical Measurement Module

In accordance with certain embodiments, the system further comprises an electrical measurement module configured for measuring various electrical characteristics of the samples held in the wells of a sample carrier. In various embodiments, the electrical measurement module monitors one or more of an impedance, inductance, resistance, or capacitance of a sample held in each well, and provides an electrical signal of the measured characteristic to a control module to track changes in the electrical characteristic over an extended duration (e.g., between 6-72 hours). In other embodiments, the electrical measurement module stimulates the samples held in the wells of the sample carrier and measures electrical signal of the stimulated cells.

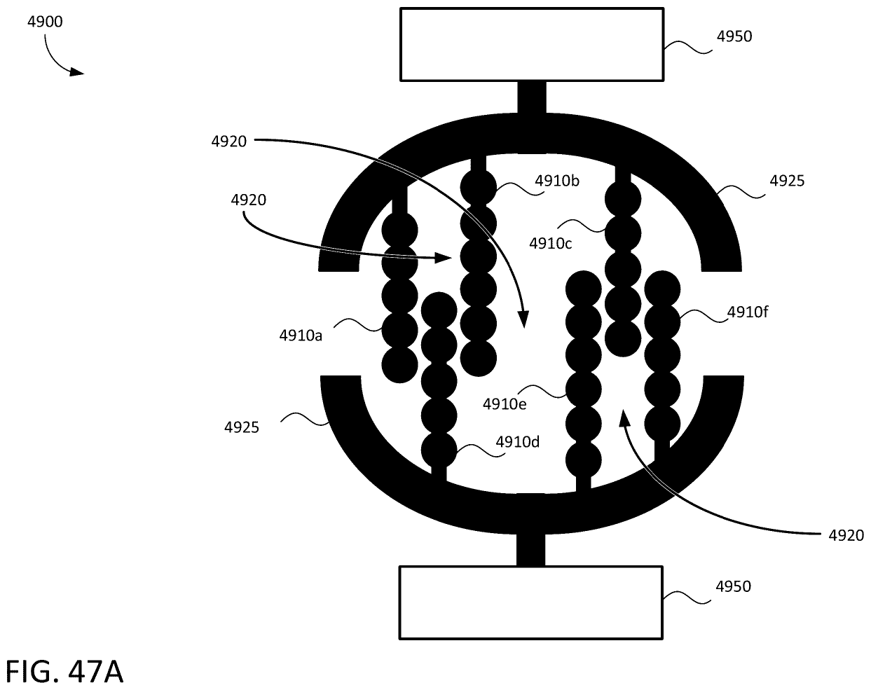

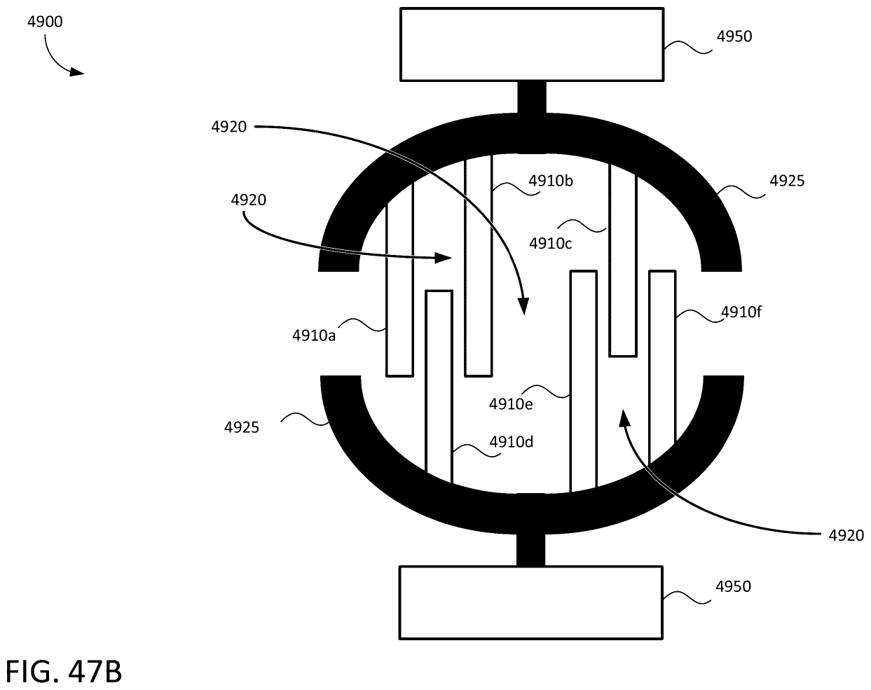

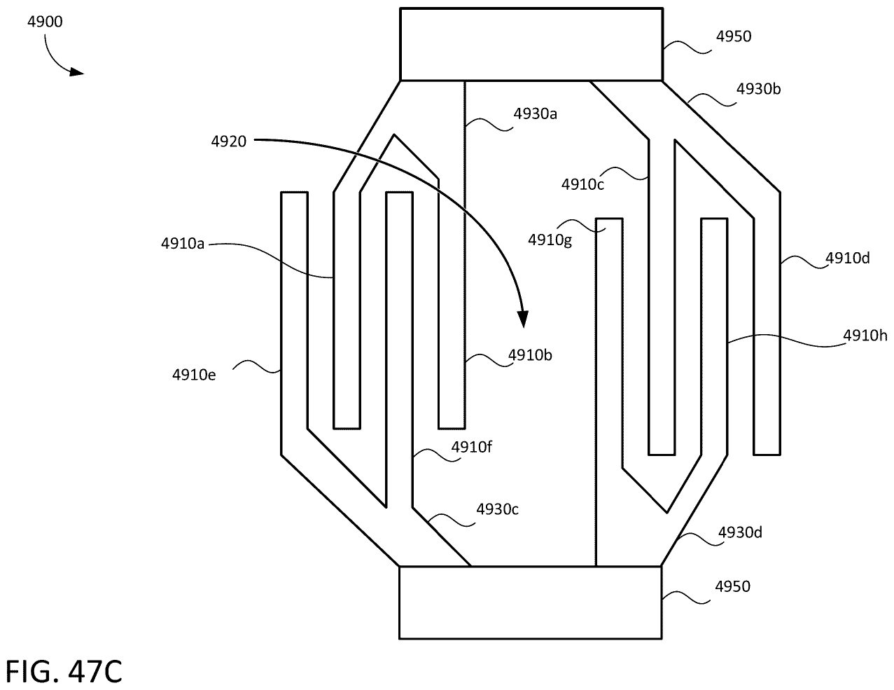

FIG. 47A is a schematic representation of a consumable 4900 with two electrode structures of the same or similar areas deposited on a substrate in which one or more wells are formed (e.g., a sample carrier). The first electrode structure has electrode elements 4910a-c and second electrode structure has electrode elements 4910d-f (generally or collectively, electrode elements 4910). Electrode elements within an electrode structure are connected to each other by arc-shaped connection electrode bus 4925. Like the electrode elements 4910, such connection-buses 4925 are also made of electrically-conductive material (e.g. gold film, platinum film, gold film over a chromium or titanium film). These electrically-conductive connection-paths or connection buses 4925 may have an insulating coating. The electrode elements 4910 comprise electrode lines with connected circles added on the line. The overall area of electrode elements 4910 and gaps between electrode elements 4910 may correspond to, or may be slightly larger than, or may be slightly smaller than, the bottom of a well (e.g., a cylinder shaped well, a conical shaped well, or a cubic shaped well), for example, a 24-well sample carrier, a 96-well sample carrier, or 384-well sample carrier that are commonly used. The whole surfaces of the wells may be covered with electrodes to ensure that the molecular interactions occurring on the bottom surface of the well can contribute to the impedance change. This arrangement has an advantage that non-uniform molecular interaction occurring on the bottom surface of these wells would result in only a small variation in the impedance measured between electrode elements 4910. Although illustrated with three electrode elements 4910 extending from each connection bus 4925, in various embodiments, more or fewer electrode elements 4910 of different lengths, widths, and surface features may be used.

Connection pads 4950 that can be connected to an external impedance measurement circuit. 4930 is the electrical connection traces that connects the connection pad to the electrode elements 4910. Such connection traces can extend in any direction in the plane of the electrodes.

One or more gaps, or windows 4920, are defined between the electrode elements 4910 to allow for imaging of the various contents of the wells in which the consumable 4900 is disposed. In various embodiments, a window 4920 may be centrally located in the consumable 4900 to correspond to a center of a well, but various sub-windows 4920 may also be defined, such that an electrode structure 4910, connection bus 4925, or contract pad 4950 does not occupy the space. These sub-windows 4920 may be aligned with micro-wells or other sub-divisions defined within the well or various features of a sample to be imaged.

FIG. 47B is a schematic representation of a consumable 4900 with two electrode structures of similar areas deposited on a substrate. As illustrated in FIG. 47B, the electrode elements 4910a-f are rectangular lines and together form an interdigitated electrode structure unit, although other shapes and sizes may be used in various embodiments. Similar to FIG. 47A, the electrode elements 4910 within each electrode structure are connected through arc-shaped, electrically conductive paths or electrode buses 4925. Connection pads 4950 are connected to electrode structures through the electrical connection traces 4930. One or more gaps, or windows 4920, are defined between the electrode elements 4910 to allow for imaging of the various contents of the wells in which the consumable 4900 is disposed. In various embodiments, a window 4920 may be centrally located in the consumable 4900 to correspond to a center of a well, but various sub-windows 4920 may also be defined, such that an electrode structure 4910, connection bus 4925, or contract pad 4950 does not occupy the space. These sub-windows 4920 may be aligned with micro-wells or other sub-divisions defined within the well or various features of a sample to be imaged.

FIG. 47C is a schematic representation of a consumable 4900 with electrode structures 4930a-d of similar areas deposited on a substrate. The electrode structures 4930a-d comprise multiple interconnected electrode elements 4910a-h. The electrode elements 4910 are rectangular lines and together form an interdigitated electrode structure unit, although other shapes and sizes may be used in various embodiments. Different from FIG. 47A and FIG. 47B, the electrode structures having electrode elements 4910a-c and 4920a-d are connected to connection pads 4950. One or more gaps, or windows 4920, are defined between the electrode elements 4910 to allow for imaging of the various contents of the wells in which the consumable 4900 is disposed. In various embodiments, a window 4920 may be centrally located in the consumable 4900 to correspond to a center of a well, but various sub-windows 4920 may also be defined, such that an electrode structure 4910, connection bus 4925, or contract pad 4950 does not occupy the space. These sub-windows 4920 may be aligned with micro-wells or other sub-divisions defined within the well or various features of a sample to be imaged.

Examples for the electrical measurement modules are further described in, e.g., U.S. Pat. No. 7,470,533 titled “Impedance based devices and methods for use in assays” which is incorporated herein by reference in its entirety for all purposes.

### Temperature Control

The device described herein includes one or more temperature control elements designed to reduce temperature gradient between outer (e.g., border) and inner wells of the multi-well sample carrier. A sample temperature control element and a manifold temperature control element are described herein. The temperature control elements may be designed to control temperature independently from one another. The temperature control elements are generally formed of a temperature conductive material which is optionally positioned in close proximity or in direct contact with one or more components, such as the multi-well sample carrier, sensor units, and/or injectors. For instance, the sample temperature control element may be dimensioned to fit the multi-well sample carrier. The manifold temperature control element may be dimensioned to fit the sensors, injectors, and/or the cartridge and, optionally, cover the multi-well sample carrier when the cartridge is positioned to mate with the multi-well sample carrier, e.g., when the sensor units and/or injectors are in fluid communication with the wells of the multi-well sample carrier. In some embodiments, a micro-environment that includes a manifold and heater and a heated component that surrounds the sensor cartridge and a tray heater that is in direct contact with the sample carrier is formed, which allows for maintaining the temperature for an extended period of time. The manifold temperature control element may be configured to mate with the sample temperature control element to cover the multi-well sample carrier.

The design of the temperature control elements forms a controlled temperature zone or microenvironment within the device. The controlled temperature zone generally comprises the array of wells of the sample carrier. In particular, the controlled temperature zone does not comprise a headspace of the housing, or a substantially large portion of the headspace, for example, temperature control does not extend to the entire internal chamber of the device, such that temperature of components outside the controlled temperature zone is not substantially altered, e.g., increased or decreased, by activation of the temperature control elements. In some embodiments, a volume of the controlled temperature zone does not exceed a volume of the sample carrier by more than 1, 2, 3, 4, 5, 6, 7, 8, 9, or 10-fold. In some embodiments, a volume of the controlled temperature zone does not exceed 10%, e.g., 9%, 8%, 7%, 6%, 5%, 4%, 3%, 2%, or 1%, of a volume of the housing.

It was surprisingly discovered that the design of the temperature control element allowed operation of the device at a temperature lower than expected, for example, at a temperature of 8° C. or lower, as compared to the typical low end operational temperature of 12° C. The low end of operational temperature is sometimes limited by heat produced by the system components, such as motors or motor control components, power supplies, circuit boards, and light sources. The lower operational temperature allows the device to be used to examine sample types that could previously not be examined with such a device, e.g., zebrafish, whole cell organisms, or non-mammalian cells. Thus, in some embodiments, the temperature control element may control temperature of the sample within each well to be less than 12° C., for example, less than 10, 9, 8, 7, 6, 5, 4, 3, 2, or 1° C.

The creation of a controlled temperature zone or microenvironment generally allows the device to bring the temperature of samples within each well of the sample carrier to be within a predetermined range of a target temperature within about 5 hours, 3 hours, 1 hour, 45 minutes, 30 minutes, 15 minutes, 10 minutes, 5 minutes, 3 minutes, or 1 minute of activation of the temperature control element and/or introduction of the sample carrier into the controlled temperature zone.

Furthermore, the design of the temperature control elements enables the device to achieve temperature uniformity and a greater range of operational temperatures than previous designs. The greater operational temperature range allows the device to be used with a greater variety of cell types, such as non-mammalian cells which may require lower or higher temperatures than previously achievable, improving viability during the assay. The greater operational temperature may improve sensitivity of the sensing units, for example, allowing the device to have a lower OCR detection limit than previous devices. In some embodiments, the uniformity and/or precision of the measurements are improved.

The manifold temperature control element may be configured to control temperature of the target agent and/or sensor units to be within 3° C., e.g., 2° C., 1° C., 0.6° C., 0.5° C., 0.4° C., 0.3° C., 0.2° C., or 0.1° C., of another injector and/or sensor unit. In certain embodiments, the manifold temperature control element may be configured to control temperature of the target agent and/or sensor units and the sample temperature control element is configured to control temperature of the samples within the array of wells of the sample carrier to be within 3° C., e.g., 2° C., 1° C., 0.6° C., 0.5° C., 0.4° C., 0.3° C., 0.2° C., or 0.1° C., of one another. Thus, the temperature control elements disclosed herein may generally maintain uniformity of temperature between different samples in the sample carrier, e.g., internal and border samples of the sample carrier, and/or between the cartridge components and their corresponding samples in the sample carrier.

In some embodiments, the sample temperature control element is configured to control the temperature of samples within each well of the sample carrier to be within a predetermined range. Exemplary predetermined ranges include 0° C.-70° C. above ambient temperature, e.g., 8° C.-20° C. above ambient temperature, e.g., 0, 1, 2, 3, 4, 5, 6, 7, 8, 9, 10, 11, 12, 13, 14, 15, 16, 17, 18, 19, 20, 30, 40, 50, 60, or 70° C. above ambient temperature. In some embodiments, the sample temperature control element is configured to control the temperature of samples, e.g., two identical or substantially identical samples, within each well of the sample carrier such that a sensor signal in response to a level, production, or consumption of a target analyte does not differ more than a predetermined amount between two identical or substantially identical samples, for instance, does not differ more than 10%, e.g., 5%, 3%, 1% or 0.1% between the two identical or substantially identical samples, e.g., when the samples are analyzed under the same or substantially the same conditions. In particular, the temperature control element may be configured to reduce or inhibit fluctuations in sensor readings, e.g., photoluminescence sensor readings, cell metabolism and other functions, and/or analyte concentration that may be produced as a result of temperature differentials.

The design of the temperature control elements reduces evaporation of the samples during execution of the protocol. Evaporation can affect cellular function when it is severe enough to change the concentration of analytes in the media. Uniformity in temperature achieved by the sample temperature control element and/or the manifold temperature control element has shown a reduced evaporation of the sample as compared to conventional devices. In some embodiments, the temperature control element may be configured to control evaporation of the samples within the array of wells to be less than 25%, e.g., less than 20%, 15%, 12%, 10%, 9%, 8%, 7%, 6%, 5%, 4%, 3%, 2%, or 1%. Evaporation may be controlled by such percentages for long duration assay, such as a 6-hour assay, 8-hour assay, 10-hour assay, or longer. Furthermore, the multi-well sample carrier may be designed to reduce evaporation during the cell culture and incubation process.

It was surprisingly found that the design of the temperature control elements provides a lower detection limit of O₂ and improved precision of measurements. For example, the system disclosed herein may have an OCR detection range of 2000 pmol/min to 0.01 pmol/min, e.g., 700 pmol/min to 0.01 pmol/min, e.g., 50 pmol/min to 0.01 pmol/min. In some embodiments, the system may have an improved lower OCR detection limit of less than 50 pmol/min, e.g., less than 40 pmol/min, 30 pmol/min, 20 pmol/min, 10 pmol/min, 5 pmol/min, 3 pmol/min, 1 pmol/min, 0.1 pmol/min, or 0.01 pmol/min.

Additionally, the design of the temperature control elements may reduce, limit, or inhibit differential (gradient) diffusion of gases in the sample carrier, cartridge, and/or internal environment near the sample carrier or controlled temperature zone. The temperature control elements may be configured to control, e.g., reduce, limit, or inhibit, the diffusion of gases inside the controlled temperature zone, cartridge, sample carrier, such that a composition of gases in the environment does not vary significantly during the assay, e.g., does not vary more than 1%, 2%, 4%, 6%, 8%, 10%, 12%, 14%, 16%, 18%, or 20% during the assay.

### Environmental Control

The device described herein may include or be associated with one or more environmental control module designed to control the environment surrounding the multi-well sample carrier. The environmental control module may be designed to control environmental gas and/or relative humidity (RH) of the environment surrounding the samples. For example, the environmental control module may be configured to control one or more of N₂, O₂, and CO₂ concentration of the gas surrounding the samples. RH may be increased or decreased by the environmental control module. For example, RH may be decreased to less than 75%, 65%, 55%, 45%, or 35% or RH may be increased to greater than 65%, 75%, 85%, or 95%. The environmental control module may enable use of the device for ischemia/reperfusion modelling and other controlled gas experiments.

The environmental control module may comprise a source of a gas, e.g., one or more of N₂, O₂, and CO₂, fluidly connected to the sample carrier. The environmental control module may form a controlled environment zone which comprises the array of wells of the sample carrier. The controlled environment zone may be open or closed to the ambient environment. The environmental control module may comprise a pump or fan configured to direct gases to or clear gases from the sample carrier.

In certain embodiments, the environmental control module is incorporated in the device. The controlled environment zone may be formed in a sealed container, e.g., hermetically sealed container. The environment may be formed by moving a heated component to surround or cover or enclose the heated sample carrier. This heated component may be made of thermally conductive material, e.g. metals, aluminum, steel, etc. These thermally conductive materials may be anodized to reduce/eliminate electrical conductivity. The thermally conductive heated component may also block stray light (ambient light). In some embodiments, the container is substantially enclosed such that there is minimal air flow. The container may house the sample carrier, for example, the stage holding the sample carrier. In some embodiments, the container may house the cartridge with the sample carrier. To form the controlled environment zone, the sealed container may be fluidly connected to the source of gas and purged with one or more selected gas accordingly.

In certain embodiments, the environmental control module is associated with the device. For example, in some embodiments, the device may be placed in a gas-controlled incubator or hypoxia chamber. Thus, the device may be configured for use within a gas-controlled environment, e.g., formed of materials suitable for use within a gas-controlled environment, such as materials with low gas solubility.

The environmental control module may be integrated with system software, e.g., operably connected to the controller and/or system processor. The software may be programmed to cycle the environmental control module in accordance with a selected protocol.

The environmental control module can be integrated with system software, e.g., operably connected to the controller and/or system processor taking inputs from measurements of the cellular microenvironment (e.g., intracellular O₂, pericellular O₂, or O₂ measurements proximate to the cell sample), thereby allowing environmental control to deliver a target cellular microenvironment. The software can be programmed to cycle the environmental control module to deliver the target microenvironment in accordance with a selected protocol.

### Imaging Module

In accordance with certain embodiments, the system further comprises an imaging module configured to capture and process images of samples held in the sample carrier. An example imaging module includes an image capture element, such as a camera or array of cameras, and the associated accessory optical components that aid the image capture element in imaging samples or a features of the samples within each well of the sample carrier through a window on an opposite side of the sample carrier from which the plurality of wells are defined. The image capture element or the sample carrier may be moved relative to one another by a motion stage to position the camera or array of cameras in alignment with the windows into the wells so that the contents can be imaged.

In various embodiments, a light source is associated with the imaging module to illuminate the samples, fluorescent labels, etc. The light source may be place on the same side of the sample carrier as the image capture element (e.g., beneath the sample carrier, as a flash or direct light), an opposite side of the sample carrier (e.g., as a backlight), or another portion of the cavity (e.g., as ambient light). Additionally, the light source may be configured to produce light within the visible spectrum, infrared spectrum, ultraviolet spectrum, and combinations thereof, which the image capture element is configured to detect. In various embodiments, the image capture element or a controller may color shift portions of the image captured outside of the visible spectrum into the visible spectrum, apply gray scaling, color correction, or the like. Example light sources are further described in, e.g., U.S. Pat. No. 10,072,982 titled “Universal multidetection system for microplates” which is incorporated herein by reference in its entirety for all purposes.

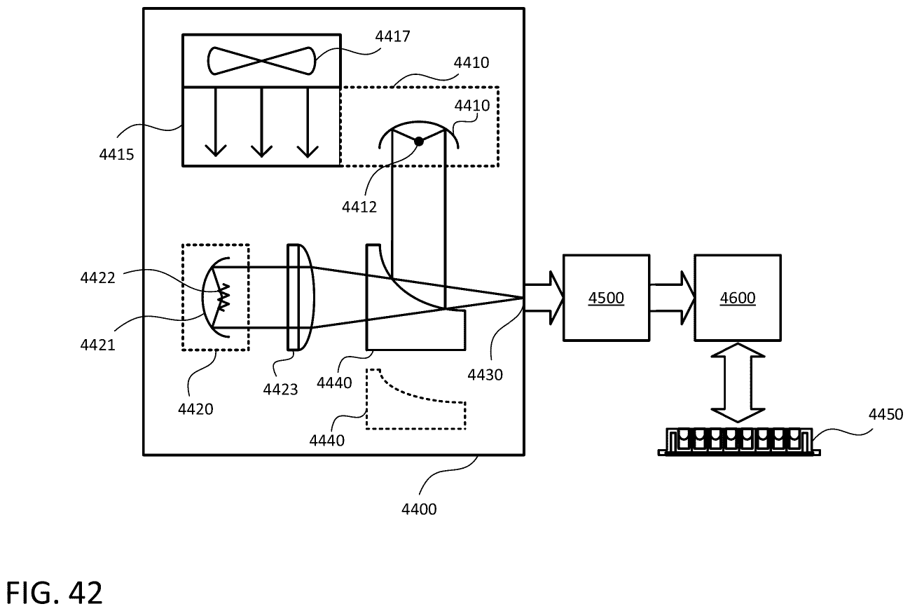

FIG. 42 illustrates a light source 4400, according to an exemplary embodiment of the present disclosure. In some embodiments, the light source 4400 comprises two light generating devices: a Xenon flash lamp 4410 and a Tungsten lamp 4420. In other embodiments the light source 4400 may comprise a Xenon continuous wave lamp, a light emitting diode (LED), a laser, or any other light-generating device.

Tungsten sources are very stable, and their radiation extends from blue in the visible spectrum to the far IR, and peaks around 1 m. They are most suitable for measurements in the visible and IR regions of the spectrum. In contrast, Xenon flash sources deliver most of their radiation in the deep UV, UV, and short visible spectral ranges. In addition, Xenon flash sources provide a very fast burst of light, lasting for several microseconds with a fast decay, and are therefore suitable for time resolved measurements in modern multi-detection systems.

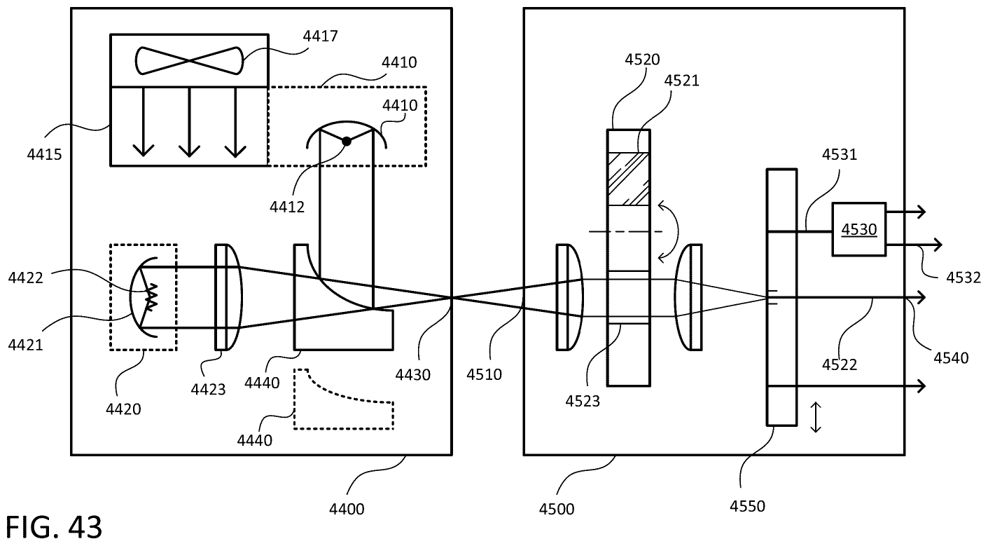

The Xenon flash lamp 4410 has a parabolic reflector 4411 positioned such that the arc 4412 of the lamp 4410 is located near the focal point of the reflector 4411, providing an essentially collimated beam from the reflector 4411. The Tungsten lamp 4420 has a parabolic reflector 4421 positioned such that the filament 4422 of the lamp 4420 is located near the focal point of the reflector 4421, providing an essentially collimated beam from the reflector 4421. FIG. 42 shows that a lens 4423 may be used to focus the beam from the reflector 4421 onto the exit portal 4430 of the light source 4400. As shown in FIG. 43, relay optics may be used to focus the beam onto the entrance of an optical fiber, according to embodiments of the present disclosure. Alternatively, the lens 4423 may focus the beam from the reflector 4421 directly onto the entrance of an optical fiber within an excitation spectral device 4500.

In various embodiments, the excitation spectral device 4500 has two spectral selection devices, which differ by the physical technology by which they separate light with different wavelengths. The first device is a filter selection device 4520, which has a variety of user-replaceable filters 4521. The second device is a double monochromator 4530.

The first path directs the light through one of the filters 4521 in the filter selection device 4520, which transmits a narrow band of the light. The light then propagates through optical fiber 4522 to the exit port 4540. The second path bypasses the filters 4521 by directing the light through a hole 4523 in the filter selection device 4520. The light then continues via an optical fiber 4531, which accepts a circular image of the arc or filament spot from the light source 4400 formed at the entry port 4510, and shapes the light spot into a slit shape to match it to the input slit of the double monochromator 4530. The monochromator 4530 selects a narrow band of the light, and then the optical fiber 4521 changes the shape of the light from the exit slit shape of the monochromator 4530 into a circular shape that resembles the shape of a well in the sample carrier 4700.

The light path selector 4550 can move relative to the filter selection device 4520, providing the ability to guide light to the exit port 4540 that was spectrally selected by the filters 4521 or the monochromator 4530.

The movable off-axis parabolic reflector 4440 has two working locations. In the first location, depicted by a solid line in FIG. 42, the reflector 4440 reflects and focuses light from the reflector 4411. In the second location, depicted by a dashed line in FIG. 42, the reflector 4440 stays out of the way of light from the reflector 4421. This arrangement allows light from either lamp to be focused at the same location. Further, the fan 4417 directs air across the fins 4415 of a cooling extrusion for the Xenon source 4410 and onto the Tungsten source 4420. This arrangement allows both sources to share a single cooling system.

The arrangement of two light sources in close proximity to each other, with their optical axes offset, and preferably at an angle of approximately 90 degrees to each other, allows for a very compact illumination system with a shared cooling system. The use of parabolic reflectors around the light sources, in combination with off-axis parabolic reflectors, results in very highly efficient coupling of light from the arc and filament into the system. Here the final focusing point of both light sources is the same. This system allows a more compact arrangement than a system which utilizes separate light source compartments with separate exit light points for each compartment, thus requiring a mechanical movement of the optical relay system to switch between sources.

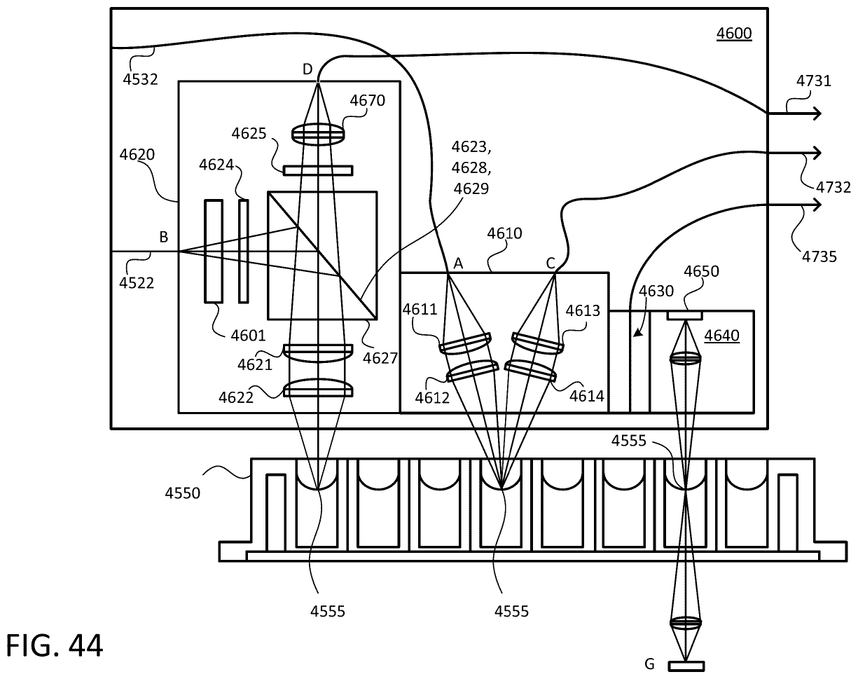

FIG. 44 illustrates the structure of the excitation-emission separation device 4600 according to an exemplary embodiment of the present invention. The general purpose of the excitation-emission separation device 4600 is to irradiate the sample with excitation light and/or gather emission light from the sample. The excitation-emission separation device 4600 can be positioned above or below the sample carrier 4550 relative to the surface that the wells are defined in, or have one positioned above the sample carrier 4450 and the other positioned below.

The sample carrier 4450 includes a substrate in which several wells are defined to contain samples for analysis. Each well includes a volume defining member configured that limits a range of motion between the substrate and a second element of the system and/or that defines a minimum non-zero distance between the substrate and the second element of the system (e.g., to prevent the second element from touching a sample held in the well). In various embodiments, these volume defining member comprises shelves, raised bumps, and stops at a certain point above a base of a corresponding well that define the volume and shape of the well, and stand-off distance between the well, other wells in the sample carrier 4450, and other elements of the system that operate with the sample carrier 4450.

In some embodiments, several light paths may be used, based on the measurement technique. For absorbance measurements, the excitation and emission light are preferably collinear. As shown in FIG. 44, the absorbance measurements are conducted in block 4640, in which a well illuminated with excitation light from below at point G. This excitation light may come from the monochromator 4530 or the filter selection device 4520. A detector 4650 is placed on the opposite side of the well to capture emission light that passes through the sample.

For luminescence measurements, no excitation light is required, and only emission light is gathered from the sample by the excitation-emission separation device 4600. In block 4630, a single fiber optic bundle 4735 is used to maximize the light gathering capability of the system and thus improve the signal.

For fluorescence measurements, two optical paths are available to irradiate the sample with excitation light and to gather emission light from the sample. These paths can be optimized to further enhance the overall system performance.

Block 4620 depicts a first optical path for fluorescence measurements, which can use a partially reflective mirror or a dichroic mirror so that excitation light and emission light are collinear when entering and exiting the sample, respectively. Light is delivered to Block 4620 by the optical fiber 4532. The movable aperture 4601 has several openings with diameters preferably ranging from approximately 1.5 mm to 4 mm, and is placed in front of the guide fiber 4522. An image of the opening placed in front of the optical fiber 4522 is formed in the well 4555 by lenses 4621 and 4622. The size of the opening of the movable aperture 4601 is selected to fill the well as completely as possible with light, while preventing light from entering adjacent wells and causing cross-talk.

The light is reflected by a partially transmitting mirror 4623 on a movable holder 4627. More than one mirror can be placed onto the holder 4627. Some mirrors can be dichroic mirrors to improve the signal, as all excitation light is reflected towards the well, and all emission light is transmitted towards exit fiber. The dichroic mirrors can also improve the signal-to-noise ratio of the measurement system, as residual excitation light that reaches the well and is reflected by the meniscus lens is blocked from reaching the exit fiber. The emission light from the well is gathered onto the fiber optic bundle 4731 by lenses 4621, 4622, and 4670. A collective lens 4670 in front of the fiber optic bundle 4731 ensures that emission light from the full depth of the well is collected, thus increasing the system signal.

The high energy collection characteristics of the system assure low detection limits and allow for various levels of fluid to produce acceptable results without the need to refocus the optical system based on the fluid volume. This is in contrast with, for example, the confocal style measurements described in U.S. Pat. No. 6,097,025, (which is incorporated herein by reference in its entirety), which uses a confocal optical system that collects light only from the small portion of the well.

In some embodiments, linear polarizers 4624 and 4625 are included in the holder 4627, and the same motion that positions appropriate mirrors in the light path also can be used to select polarizers for fluorescence polarization measurements. This eliminates the need for a separate mechanism to switch the polarizers, and thus improves the reliability of the system.

Block 4610 depicts a second optical path for fluorescence measurements, which uses a tilted V arrangement of optics for direct well illumination and light gathering. This allows the system to channel the full amount of light from the fiber optic 4532 into the well 4555. The numerical aperture of the optics 4611 and 4612 is matched to the fiber optic 4532 for this purpose. The cone of excitation light enters the well and excites the contents of the well via the first leg of the V. The emission light is collected by the second leg of the V. The numerical aperture of lenses 4614 and 4613 matches the exit fiber optic 4732. The V is tilted with respect to the vertical plane to direct excitation light that is specularly reflected from the surface of the well away from the light collecting leg of the V. Therefore, this arrangement introduces a spatial separation of emission and excitation light in addition to the spectral separation, and significantly improves the signal-to-noise ratio. This tilted V arrangement can also be used to conduct fluorescence polarization measurements.

The entry ports A and B of the excitation-emission separation device 4600 accept fiber bundles from the excitation spectral device 4500. Fibers can be positioned to direct light that is spectrally separated by filters in the excitation spectral device 4500 into input B of Block 4620. Fibers can also be positioned to direct light spectrally separated by monochromators in the excitation spectral device 4500 into input A of Block 4610. Alternatively the inputs can be reconfigured by switching fibers 4522 and 4532. This switching may be accomplished manually. The emission light is gathered by fibers 4731 and 4732 from ports C and D. The placement of fibers 4731 and 4732 in the exit ports C and D determines the origin of the emission light in the fibers.

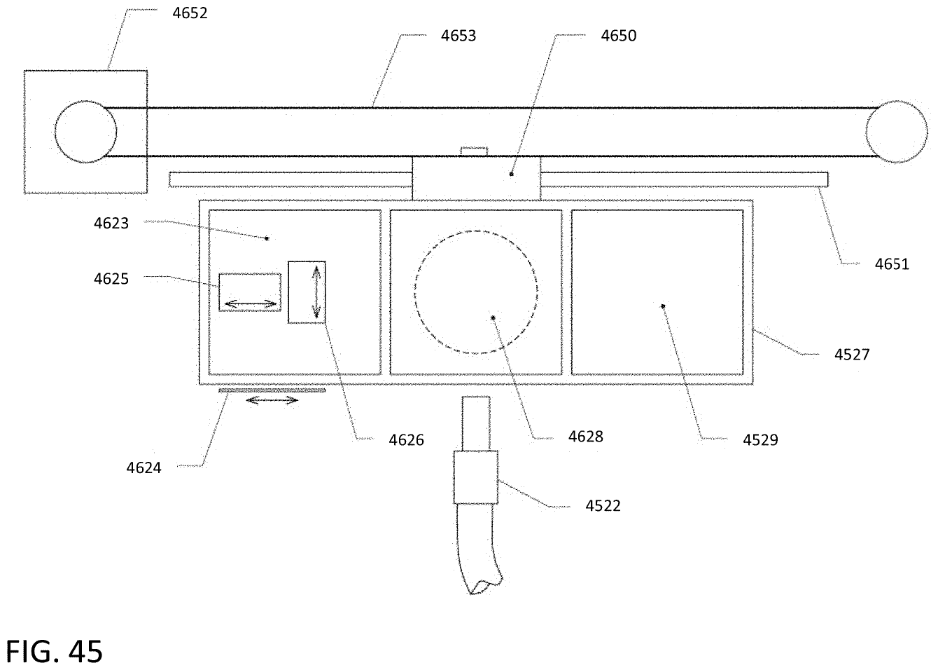

FIG. 45 illustrates the holder 4627 with associated dichroic mirrors 4623, 4628, and 4629 and linear polarizers 4624, 4625, and 4626 according to an exemplary embodiment of the present invention. The holder 4627 is affixed to the slider 4650, which slides along rail 4651 due to the applied force from the motor 4652 through the belt 4653. The holder 4627 moves in a direction perpendicular to the plane defined by the optical axes of the excitation and emission light. Although two different fibers 4522 and 4532 could occupy the fiber position depicted in FIG. 45, for the sake of clarity only fiber 522 is shown.

In the depicted design, there are five possible positions for the holder 4627 relative to the fiber 4522, which delivers the excitation light. The first position, which is depicted in FIG. 45, represents a situation where the center of mirror 4628 is aligned with the optical axis of the fiber 4522. In this position fluorescence polarization based assays cannot be conducted. If the holder 4627 is moved to the left for a distance equal to the distance between the centers of mirror 4628 and 4629, the holder 4627 will be in the second position. In the second position, the mirror 4629 plays an active role, and fluorescence polarization based assays cannot be conducted.

The three other positions of the holder 4627 correspond to three different situations. First, when the right third of the mirror 4623 is positioned in front of the fiber 4522, fluorescence polarization based assays cannot be conducted. Second, when the middle third of the mirror 4623 is positioned in front of the fiber 4522, the linear polarizer 4624 is in the optical path of the excitation light, and the linear polarizer 626 is in the optical path of the emission light. In this case the polarization vectors of the excitation and emission light are crossed. Third, when the left third of the mirror 4623 is positioned in front of the fiber 4522, the linear polarizer 4624 is still in the optical path of excitation light, and another linear polarizer 4625 is in the optical path of the emission light. In this case the polarization vectors of the excitation and emission light are parallel. Thus the linear motion of the holder 4627 not only selects which mirror is placed in the optical path, but also allows for fluorescence polarization measurements.

As shown in FIG. 45, the linear polarizers 4625 and 4626 have parallel surface orientations and perpendicular polarization axis orientations. They have active areas of equal sizes, and each size is comparable to the size of the cross-section of the emission light. The polarization axis of the linear polarizer 4624 is parallel to the polarization axis of the linear polarizer 4625, and perpendicular to the polarization axis of the linear polarizer 4626. The area of the linear polarizer 4624 is at least twice the area of the linear polarizer 4625. The area of the mirror 4623 is at least three time the area of the linear polarizer 4625. The mirror 4623 is partially reflective and partially transparent.

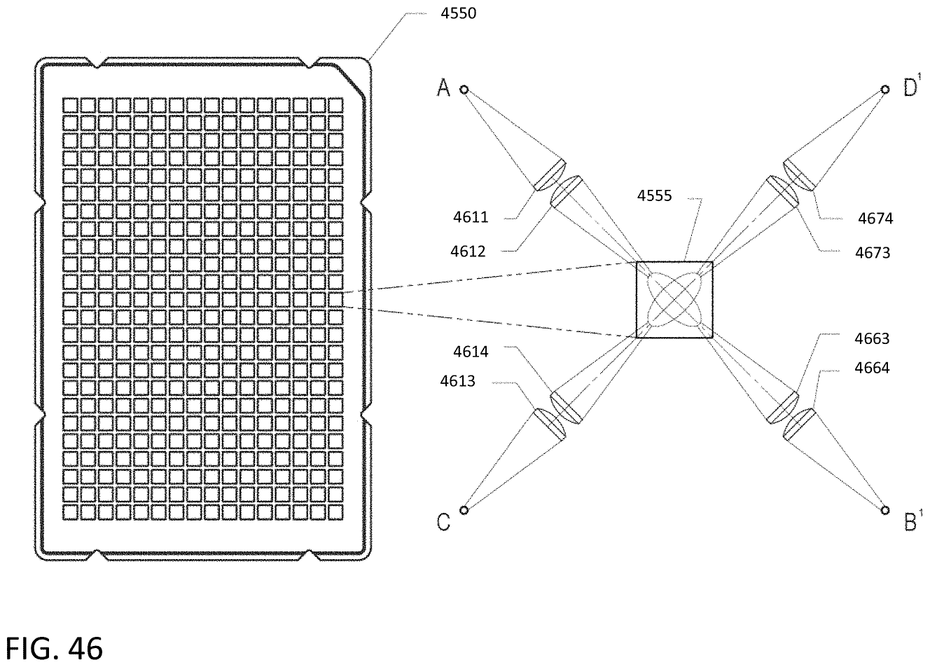

FIG. 46 shows a view from above the sample carrier 4550, along vertical axes toward the sample carrier 4450 of the block 4610 of the excitation-emission separation device 4600. Points A and B′ are input portals of the excitation-emission separation device 4600. Lenses 4611, 4612, 4663, and 4664 focus excitation light onto the wells 4455 in the sample carrier 4550. Lenses 4613, 4614, 4673, and 4674 collect emission light and focus it into points C and D′, which are exit portals of the excitation-emission separation device 4600. The optical axes of lenses 4611, 4612, 4663, 4664, 4613, 4614, 4673, and 4674 are oriented along the diagonals of the wells 4555 defined in the sample carrier 4550. Using this arrangement, a reading may be taken on the same well 4555 simultaneously via filter-based or monochromator-based spectral systems. Because the excitation light from point A is reflected toward point B′ and vice versa, very little excitation light is reflected toward exit portals C and D′. Therefore, the emission light is spatially separated from the excitation light.

### Optical Module

The device may further comprise an optical module positioned to image or scan the samples within the multi-well sample carrier. The optical module may be positioned within the housing. The optical module may be operatively connected to the controller. The optical module may be controlled or operated via the graphical user interface. Furthermore, images or scans obtained by the optical module may be reviewed and/or recorded via the graphical user interface, optionally in real time. Thus, in some embodiments, the optical module is operatively connected to the computer and the computer is configured to display and/or record the image or scan of the samples in real time.

Cell based assays, and in particular live cell assays, are becoming more popular in the field of life science research. Microplates are increasingly used as vessels for investigation of the cell growth process by qualitative and quantitative means. Often the work with cells is performed by a researcher utilizing multiple dedicated devices.

Photoluminescence, e.g., fluorescence and/or phosphorescence, reading with instrumentation that has a light beam diameter sufficiently large to obtain a representative measurement of total well fluorescence, or of beam size to perform an area scanning and mapping of the signal across the well, can be accomplished with a dedicated conventional fluorescence reader or with a multi-detection reader. Most of the devices provide incubation of the plate, fluid injection, and also allow an option of a gas control (CO₂ and/or O₂) similar to tissue culture incubators.

Much more information than just well's fluorescence signal level can be obtained from cells with the wide-field imaging modality. Laboratory microscopes, with bright field and phase contrast for unstained cells and fluorescence imaging for stained cells, are commonly used. Some devices do allow for incubation chambers and environmental control. For sharper imaging or sectioning of 3D cell clusters like spheroids, confocal microscopy is used as a third deviceation option.

Typically these devices are purchased from various vendors, and a user may be forced to physically transfer the vessel, e.g., microplate from one device to another device as needed, as well as to keep track of the overall sample analysis process and to collate and combine data from several devices to obtain complete holistic analysis of the cell sample. Without robotics, it may be nearly impossible to properly conduct a long-term complex experiment or assay. Use of robotics further increases both analysis cost and complexity. The combination of non-imaging analysis modalities (fluorescence, absorbance and chemiluminescence), wide-field fluorescence imaging on a cell level, confocal fluorescence imaging, environmental control, and reagent injections in a single device would provide a complete holistic analysis solution, and would free the user from tedious microplate handling, microplate tracking and data transfer. Solutions for a combined system where the data obtained from individual devices may be stored, collated and analyzed are described herein.

### Consumables

The disclosure provides consumables that can be used for analyzing cell samples in accordance with the systems and methods described herein.

In some embodiments, the system comprises an interface to interact with a consumable. The consumable can be any cell sample holding consumable. Exemplary consumables include, but are not limited to, a flow chip, a microtiter plate with any number of wells, 2D samples, and a 3D tissue or spheroid formation/measuring plate. For example, the microtiter plate can have 6, 12, 24, 48, 96, 384, or more wells. In some embodiments, the consumable comprises a microelectrode if an impedance measurement or electrical excitation is desired. In some embodiments, the consumable is capable of forming a microchamber to allow for a flux measurement. In some embodiments, the consumable is made of materials that limit gas diffusion to increase flux sensitivity. To image the cell samples, the components that make up the image system can be configured to read from below or above the consumable. If imaging from below, the consumable may have a window through the microelectrode to view the cell sample. If imaging from the top, the consumable may have any features above the sample, such as a flux measurement cartridge, removed to view the sample.

The consumables include, but are not limited to, sample carriers (e.g., cell culture plates) with and without impedance electrodes, lids, and cartridges. In some embodiments, the lid can have one or more sensors, e.g., O₂/pH/CO₂ sensors. In some embodiments, the cartridge can have one or more sensors and/or compound/substance ports. The consumables can be shuttled through the different steps of the automated workflow.

In some embodiments, the sample carrier is a cell culture plate. In some embodiments, the sample carrier comprises a plurality of wells. In certain embodiments, a well of the plurality of wells comprises an impedance electrode. In other embodiments, a well of the plurality of wells does not comprise an impedance electrode. For example, the impedance electrode may be wired to detect the real and imaginary impedance components of the cell sample during the growth and/or measurement periods. In some embodiments, the well is made with uniform electrodes on the bottom. In some embodiments, the well is made such that there is a window for imaging the cells at the bottom. Normalization may be performed and applied to the measurement if the well is made such that there is a window for imaging the cells at the bottom. In some embodiments, the well comprises bumps to facilitate formation of a microchamber, which does not interfere with the impedance electrode. A cartridge can be loaded into the well and rest on the bumps during a measurement period. The microchamber can then be refreshed by moving the cartridge off the bumps.

### Sample Control Module

In accordance with certain embodiments, the system further comprises a sampling control module. In various embodiments, the sampling control module may operate in conjunction with an environmental control module, as described in the present application. The sampling control module includes one or more of a sample environmental temperature control element (such as the temperature control module described herein) that is configured to control the temperature of the samples and/or the sample carrier, a gaseous control element that is configured to control the gas content of at least one of O₂, CO₂, and N₂ content of the samples, a humidity control element that is configured to control the humidity of the environment surrounding the sample carriers (e.g., to prevent/reduce/encourage evaporation), and a measurement device control element that is configured to control a temperature of a sensor that interfaces with the samples and/or the wells to determine various characteristics thereof.

Additionally, the sampling control module may operate in conjunction with a fluid handler or cartridge to control the temperature of the various compound/substances (e.g., reagents, agents under test, other media) to be within certain predefined ranges. By controlling the temperature of the compounds/substances added to the wells, the controller can reduce the effects of temperature shock on the samples in those wells for any introduced materials and store the compounds/substances at a different temperature than the temperature at which the compound/substances are delivered (e.g., refrigerating compounds to increase shelf-life, heating compounds to decrease viscosity). In various embodiments, the controller can maintain compounds/substances at a standby temperature different than the rest of the environment in the device while waiting to introduce those compounds/substances to the wells. The controller can additionally or alternatively adjust the temperature of a compound/substance from the temperature of the environment (or standby temperatures) prior to introduction to the wells. For example, a compound may be stored at X degrees as a standby temperature (in an environment with a temperature T=X or T≠X), and then heated (or cooled) to Y degrees for introduction to a well that is maintained at Z degrees, where X≠Y≠Z, X≠Y≥Z, or X≠Y≤Z.

In various embodiments, the sample temperature environmental control element and/or the measurement device control elements are heaters, which generate heat via electrical resistance to a current passed through various heating elements.

In various embodiments, the gaseous control element is in communication with one or more gas canisters containing the gases to control for within the atmosphere of individual sample wells, or in the atmosphere of the cavity within the system in which the sample carrier is inserted. The gaseous control element may contain various sensors that detect the balance of the gas contents in the wells and/or cavity and/or a pressure of the gasses therein. Based on the sensor readings, the gaseous control element can vent, apply negative pressure, or otherwise remove a portion of the gaseous atmosphere from the well and/or cavity, and replace the removed portion with a desired composition of at least one of O₂, CO₂, and N₂ at a desired pressure to maintain a desired atmospheric composition. Additionally or alternatively, the gaseous control element can inject at least one of O₂, CO₂, and N₂ at a desired pressure to adjust an existing atmosphere without venting, suctioning, or otherwise removing a portion of the existing atmosphere.

In various embodiments, the humidity control element includes dehumidifying elements to remove water content from an atmosphere of a well and/or a cavity in which the sample carrier is inserted and/or is in communication with a water source to inject additional water into a sample well or the atmosphere thereof (e.g., via a nebulizer or humidifier element).

In various embodiments, the gaseous control element and the humidity control element operate by opening and closing covers to one or more of the wells in the sample carrier to release undesired atmosphere, and are connected to a liquid handling element or flux/consumable cartridge, which includes the various consumable growth gas supplies used to adjust or reestablish a desired atmospheric composition in a given well in addition to the various growth media, stimulants, regulating agents, and the like that are supplied to the samples held in the wells.

### Signal Processing Module

High impedance transimpedance amplifiers are susceptible to parasitic current paths. Such parasitic current paths may be caused by contamination on the surface due to flux residue or surface cleaners from soldering and manufacturing. Parasitic current paths may also be exacerbated in high humidity environments and absorption of moisture in the dielectric material used to insulate conductive paths.

The device disclosed herein is designed to reduce parasitic current paths by including a signal processing module capable of operating at high relative humidity, for example, 75%, 85%, or even 95% relative humidity. It was unexpectedly discovered that performance of the signal processing module at high relative humidity allows assays and experiments to be performed on the device for a longer time frame. Thus, real time cellular data may be collected from the cell samples and assays may be conducted for more than 1 hour, 2 hours, 3 hours, 4 hours, 5 hours, 6 hours, 7 hours, 8 hours, 9 hours, 10, hours, 11 hours, 12 hours or more, without negatively impacting sensitivity of the sensor units.

The signal processing module is a processor operatively connected to the array of sensor units, configured to receive and amplify the signals from the sensor units. The signal processing module may receive and amplify the plurality signals from the array of sensor unit simultaneously or individually, e.g., sequentially. In some embodiments, the signal processing module may be able to adjust amplification of signal to acquire data at a faster or slower rate, e.g., reduce amplification to increase acquisition speed. In some embodiments, the signal processing module is configured to operate with reduced parasitic current, e.g., reduced interference, dark currents, or noise, associated with the detection and/or amplification of the signals from the sensor units.

The signal processing module may be configured to detect the signals using time-based detection or intensity-based detection. Briefly, the radiation emitted by an excited probe can be measured in intensity units and/or lifetime/time-domain (including, for example, rate of decay, phase shift, or anisotropy detection). Intensity-based detection may include detecting and/or processing ratiometric measurements. Briefly, the measurement may include an analyte-sensitive signal measurement and an analyte-insensitive or largely analyte-insensitive reference measurement. The ratio between the references may be incorporated to facilitate ratiometric assessment of analyte flux or concentration.

In some embodiments, the signal processing module comprises a printed circuit assembly formed of an insulating material having a high dielectric constant. In some embodiments, the signal processing module comprises a printed circuit assembly having a transimpedance amplifier including grounded guard traces. In some embodiments, the signal processing module may comprise one or more light-sensitives component such as semiconductor diodes, photo-multiplier tubes, avalanche photodiodes, CMOS sensors, CCDs, etc. In some embodiments these light-sensitive component may be connected to a transimpedance amplifier. In some embodiments, the signal processing module comprises a printed circuit assembly formed of surface mount components, e.g., substantially free of secondary hand soldered high gain components. In some embodiments, the signal processing module comprises a printed circuit assembly comprising a thermally conductive excitation source, optionally wherein the thermally conductive excitation source is in thermal communication, e.g., thermal contact, with a thermal sink. The thermally conductive excitation source may be any excitation source that changes intensity with respect to temperature, e.g., a laser diode or light emitting diode (LED). In some embodiments, the signal processing module comprises a printed circuit assembly having an integrator design. In some embodiments, the signal processing module comprises a printed circuit assembly having an operational amplifier design.

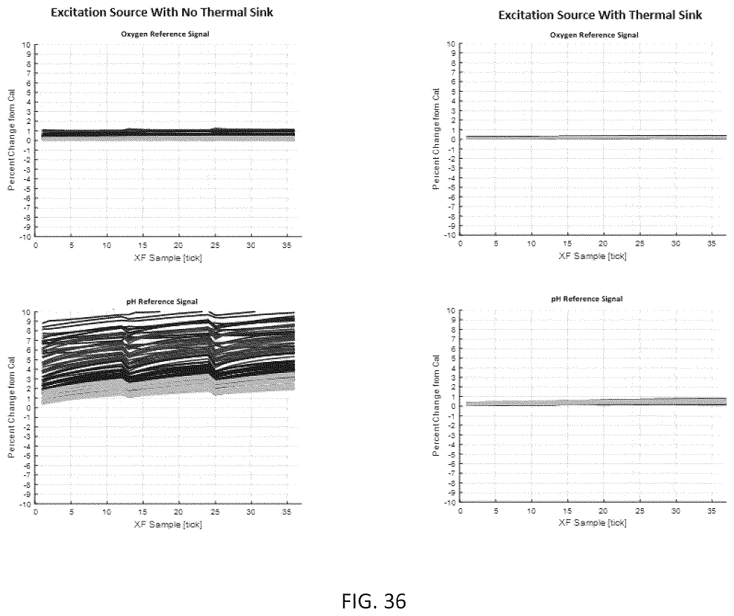

It was surprisingly discovered that the design of the thermally conductive excitation source reduced the thermal drift significantly such that less reference correction is generally required, which may reduce correction errors and thereby improve precision of measurements (FIG. 36). The data shown in the graphs of FIG. 36 demonstrates that reduce in thermal drift after inclusion of a thermally conductive excitation source. In some embodiments, the improved design of the thermally conductive excitation source may alleviate (or remove) the need to include a reference signal detector, reducing complexity of the fiber optic routing and cost of the device while achieving similar and/or improved performance. Thus, in some embodiments, the design of the signal processing module removes the need for a reference signal detector and/or for a light source configured to produce a reference signal. The device may be free of the reference signal detector.

Components and features of the signal processing module are further described in Kester et al. “Section 5: High Impedance Sensors,” and incorporated herein by reference in its entirety for all purposes.

### Transfer Module

In accordance with certain embodiments, the system further comprises a transfer module configured to transfer optical signals from the array of sensor units to the signal processing module. For example, the transfer module may transfer one or more of excitation, reference, and emission optical signals.

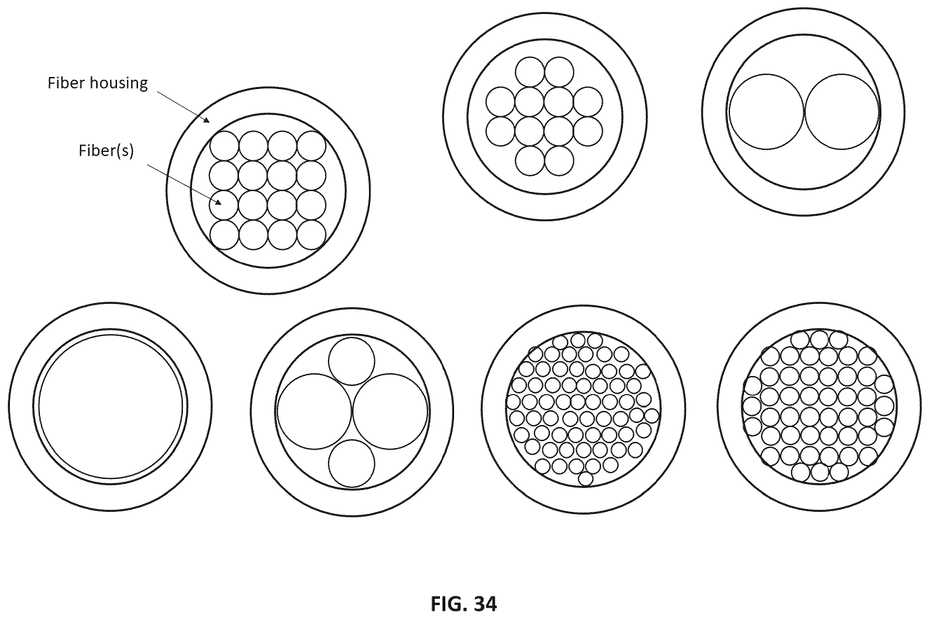

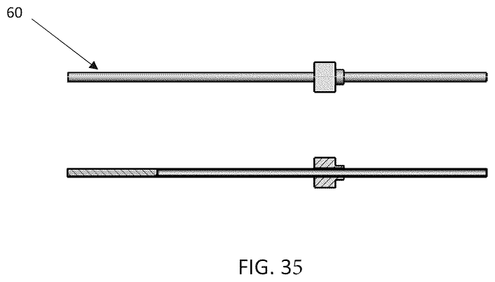

The transfer module may be formed of a multiplexed fiber optic material. FIGS. 34-35 are diagrams showing several views of an exemplary transfer module 60, including a side view (FIG. 35) and a cross-sectional view (FIG. 34) of transfer module 60. In embodiments, the transfer module 60 may comprise an array of fiber optic bundles, each fiber optic bundle in communication with a corresponding sensor unit of the array of sensor units. The fiber optic bundles may be positioned and arranged to directly interface with one or more sensor units. Each fiber optic bundle may be formed of an array of fiber optic cables contained within a fiber probe housing, e.g., a metal fiber and/or plastic probe housing, as shown in the cross-sectional view of FIG. 34.

In certain embodiments, the transfer module may be in the form of a homogenized fiber optic wave guide optically connecting the sensor units to the transfer module, e.g., each sensor unit to a corresponding fiber optic bundle of the transfer module. The homogenized fiber optic wave guide may be configured to uniformly distribute light onto one or more sensor unit. The homogenizer may improve mechanical and optical shuffling.

### Combination of Devices

In certain embodiments, the cells may be analyzed in series by taking serial measurements of the same cell sample. In no particular order, the sample may be analyzed to measure bioenergetic work of the cell, such as the O₂, CO₂, pH. The data may be stored on a cloud-based storage and optionally analyzed on a cloud-based data processing and visualization system. The same cell sample, different samples, or samples from the same cell line may be analyzed using electrochemical measurements, e.g., impedance measurements. The data may be stored on the cloud-based system. The same sample, different samples, or samples from the same cell line may be visually observed for cell growth and morphology. The data may be stored on the cloud-based system. The data obtained from the independent measurements may be correlated with the corresponding samples/measurements by labelling the sample, e.g., by bar-code or other digital identification system. The data may be collected and collated in the cloud-based storage and optionally processed in the cloud-based data processing and visualization system. The collated data from analyzing the same cell sample may be interrogated for patterns and information.

Each of the measurements may be performed within the device described herein or in a combination of devices, each operably connected to the data storage and processing system, e.g., cloud-based system or computer.

In certain embodiments, the sample may be analyzed in parallel by taking one or more aliquots of the original cell sample or samples from the same cell line to produce multiple substantially identical cell samples for each measurement to be taken, e.g., to produce three or more corresponding substantially identical samples. The samples may be analyzed concurrently or substantially concurrently. The data may be collected and collated in the cloud-based storage system, as previously described. The collated data may be interrogated for patterns and information, as previously described.

In certain embodiments, the sample or aliquots of the sample may be analyzed to measure the bioenergetic work of the cell, by measuring parameters such as the O₂, CO₂, pH, or other metabolically relevant parameters, and visually observed for cell growth and morphology at the same time, e.g., concurrently, substantially concurrently, or after an extended duration of time. In some embodiments, the sample or aliquots of the sample may be analyzed to measure the bioenergetic work of the cell, by measuring parameters such as the O₂, CO₂, pH, or other metabolically relevant parameters, and for electrochemical measurements (e.g., impedance) at the same time, e.g., concurrently, substantially concurrently, or after an extended duration of time. In some embodiments, the sample or aliquots of the sample may be visually observed for cell growth and morphology and analyzed for electrochemical, e.g., impedance measurements at the same time, i.e., concurrently, substantially concurrently, or after an extended duration of time, and visually observed for cell growth and morphology at the same time, e.g., concurrently substantially concurrently, or after an extended duration of time.

It is understood that the cell sample is moved between modalities throughout the extended period of time with the cell sample normalizing between modalities. The sample is not continuously measured in one modality for the entire extended duration of time, rather the sample is measured in a modality, allowed to normalized and measured again in the same modality. In one embodiment, the sample is measured in a first modality, allowed to normalize before being measured again at multiple different time points in the first modality during the extended duration of time for the investigation, e.g. measuring extracellular flux of the sample over 72 hours with a measurement time of 3 minutes, a recovery and normalization time of 5, 10, 15, 30, 60 minutes or more prior to a 2^{nd}, 3^{rd}, 4^{th}, 5^{th}, 6^{th}, 7^{th}, 8^{th}, 9^{th}, 10^{th}, N^{th} measurement of extracellular flux. Additionally or alternatively, the sample is measured in one modality and then moved to a second or third modality for a second or third measurement, or any variations thereof. In one embodiment, the sample is measured for an extended duration of time starting with measurement in the first modality (e.g., extracellular flux in response to an analyte (e.g., measuring depletion of O₂ or changes in pH), the sample can them be moved to a second modality (e.g., impedance measurement) and/or a third modality (e.g., imaging) before returning the sample to the first modality (e.g., flux measurement).

In one embodiment, each of the multiple cell samples are monitored by each modality separately, e.g., one sample of the same cell line monitored for bioenergetic metabolism, another sample of the same cell line monitored for impedance, and yet another sample of the same cell line visually monitored for cell growth. In another embodiment, the same cell sample may be analyzed concurrently or substantially concurrently, e.g., the bioenergetic metabolism of the cell sample may be monitored concurrently or substantially concurrently by imaging of the cell sample. In another embodiment, the same cell sample may be analyzed concurrently or substantially concurrently, e.g., the bioenergetic metabolism of the cell sample may be monitored concurrently or substantially concurrently by the impedance measurement. In another embodiment, the same cell sample may be analyzed concurrently or substantially concurrently, e.g., the bioenergetic metabolism of the cell sample may be monitored concurrently or substantially concurrently by the impedance measurement and imaging.

In another embodiment, the same cell sample may be analyzed after an extended duration of time, e.g., the bioenergetic metabolism of the cell sample may be monitored at a first period of time with imaging and the same cell sample may be analyzed for bioenergetic metabolism and imaging after a second, third, fourth, fifth, sixth, seventh, eighth, ninth, tenth, 11^{th}, 12^{th}, 13^{th}, 14^{th}, 15^{th}, 16^{th}, 17^{th}, 18^{th}, 19^{th}, 20^{th} and beyond period of time, e.g., between 6 hours and 72 hours, e.g., between 12 hours and 60 hours, between 24 hours and 48 hours, between 12 hours and 36 hours, between 24 hours and 48 hours, between 36 hours and 60 hours, between 6 hours and 60 hours, between 6 hours and 48 hours, between 6 hours and 36 hours, between 6 hours and 24 hours, between 6 hours and 12 hours, between 60 hours and 72 hours, between 48 hours and 72 hours, between 36 hours and 72 hours, between 24 hours and 72 hours, between 12 hours and 72 hours, between 12 hours and 24 hours, between 24 hours and 36 hours, between 36 hours and 48 hours, between 48 hours and 60 hours, or up to a week (e.g., 168 or 170 hours).

In another embodiment, the same cell sample may be analyzed after an extended duration of time, e.g., the bioenergetic metabolism of the cell sample may be monitored at a first period of time with impedance and the same cell sample may be analyzed for bioenergetic metabolism and impedance after a second, third, fourth, fifth, sixth, seventh, eighth, ninth, tenth, 11^{th}, 12^{th}, 13^{th}, 14^{th} 15^{th}, 16^{th}, 17^{th}, 18^{th}, 19^{th}, 20^{th} and beyond period of time, e.g., between 6 hours and 72 hours, e.g., between 12 hours and 60 hours, between 24 hours and 48 hours, between 12 hours and 36 hours, between 24 hours and 48 hours, between 36 hours and 60 hours, between 6 hours and 60 hours, between 6 hours and 48 hours, between 6 hours and 36 hours, between 6 hours and 24 hours, between 6 hours and 12 hours, between 60 hours and 72 hours, between 48 hours and 72 hours, between 36 hours and 72 hours, between 24 hours and 72 hours, between 12 hours and 72 hours, between 12 hours and 24 hours, between 24 hours and 36 hours, between 36 hours and 48 hours, between 48 hours and 60 hours, or up to a week (e.g., 168 or 170 hours).

In another embodiment, the same cell sample may be analyzed after an extended duration of time, e.g., the bioenergetic metabolism of the cell sample may be monitored at a first period of time concurrently with an impedance measurement and imaging. The same cell sample may be analyzed for bioenergetic metabolism, impedance and imaging after a second, third, fourth, fifth, sixth, seventh, eighth, ninth, tenth, 11^{th}, 12^{th}, 13^{th}, 14^{th}, 15^{th}, 16^{th}, 17^{th}, 18^{th}, 19^{th}, 20^{th} and beyond period of time, e.g., between 6 hours and 72 hours, e.g., between 12 hours and 60 hours, between 24 hours and 48 hours, between 12 hours and 36 hours, between 24 hours and 48 hours, between 36 hours and 60 hours, between 6 hours and 60 hours, between 6 hours and 48 hours, between 6 hours and 36 hours, between 6 hours and 24 hours, between 6 hours and 12 hours, between 60 hours and 72 hours, between 48 hours and 72 hours, between 36 hours and 72 hours, between 24 hours and 72 hours, between 12 hours and 72 hours, between 12 hours and 24 hours, between 24 hours and 36 hours, between 36 hours and 48 hours, between 48 hours and 60 hours, or up to a week (e.g., 168 or 170 hours).

It should be noted that while the disclosure generally refers to measuring metabolism, similar methods may be used to measure or detect cellular microenvironment features, such as environmental conditions experienced by the sample. The conditions may be manipulated to drive towards a desired microenvironmental condition, possibly via environmental control. The conditions may be manipulated to relate to cellular response. As an exemplary embodiment, impedance, a specific imaged cellular parameter, a fluorometrically measured parameter (e.g., cellular metabolism), altering as a function of cellular oxygenation, oxygen or pH, e.g., may be controlled to effectuate a model to delineate the impact of tumor microenvironmental conditions on cellular function. As a further example, such properties may be controlled to analyze beat rate and/or metabolism of cardiomyocytes as a function of reduced oxygen and/or nutrient availability, with beat rate controlled either pharmacologically, or using electrical pacing via the device.

Embodiments described herein overcome the above disadvantages and other disadvantages not described above. Also, the embodiments are not required to overcome the disadvantages described above, and an example embodiment may not overcome any of the problems described above.

According to an aspect of an example embodiment, there is provided a device for analyzing one or more samples, the device including a support for a receptacle that holds a sample; an imaging subsystem that images the sample; and an analyzing subsystem that analyzes the sample.

According to an aspect of an example embodiment, there is provided a sample analysis method including selecting at least one subsystem from among a plurality of subsystems of a sample analysis device that examines one or more samples, the plurality of subsystems comprising an imaging subsystem that images the one or more samples and an analyzing subsystem that analyzes the one or more samples; and controlling the selected at least one subsystem to perform an examination on the one or more samples, the examination comprising an imaging operation of the imaging subsystem that images the one or more samples and an analyzing operation of the analyzing subsystem that analyzes the one or more samples.

According to an aspect of an example embodiment, there is provided a non-transitory computer-readable medium having embodied thereon a program which when executed by a computer causes the computer to execute a sample examination method, the method including selecting at least one subsystem from among a plurality of subsystems of a sample analysis device that examines one or more samples, the plurality of subsystems comprising an imaging subsystem that images the one or more samples and an analyzing subsystem that analyzes the one or more samples; and controlling the selected at least one subsystem to perform an examination on the one or more samples, the examination comprising an imaging operation of the imaging subsystem that images the one or more samples and an analyzing operation of the analyzing subsystem that analyzes the one or more samples.

According to an aspect of an example embodiment, there is provided a device for analyzing a sample. The device may include: a receptacle support configured to support a microplate comprising a microplate well configured to hold the sample, also referred to as a multi-well sample carrier, plate, or sample carrier herein. In one embodiment, imaging of the sample is conducted using devices such as automated cell imaging readers e.g., Cytation™ 5, Cytation™ 7, as disclosed in U.S. Pat. No. 10,072,982, incorporated herein by reference in its entirety for all purposes. In one embodiment, imaging of the sample is conducted using a confocal imaging device including: a receptacle support configured to support a microplate comprising a microplate well configured to hold the sample; an objective configured for imaging the sample; a laser point scanning confocal system configured to image the sample via the objective; and a spinning disk and/or wide field imaging system configured to image the sample via the objective, wherein at least a portion of both the laser point scanning confocal system and the spinning disk and/or wide field imaging system is movably provided such that the laser point scanning confocal system and the spinning disk and/or wide field imaging system are configured to be selectively aligned with the objective for imaging the sample.

It will be appreciated that the cell sample may be observed using any type of imaging modality that can visually examine the cells.

In certain embodiments, the cell sample may be observed using phosphorescence lifetime imaging microscopy (PLIM) and/or fluorescence lifetime imaging microscopy (FLIM), including 2-photon excited imaging.

In certain embodiments, an imaging modality known as confocal imaging may be well-suited for imaging the cell samples, e.g., 3D cell structures such as spheroids. In confocal imaging, a sample may be illuminated one point or portion at a time. For example, light may be passed through a small aperture such as a pinhole positioned at an optically conjugate plane. The point illumination substantially eliminates out of focus light and background light, and thereby increases the optical resolution and contrast of the image. The complete image, built or stitched together point by point via a scanning function, is very sharp with well-defined features. The scanning function may be performed with the spinning disk, also known as scanning disk or Nipkow disk.

Confocal imaging is a particularly well-suited imaging modality to be used with spheroids. With confocal imaging, a spheroid can be sectioned, layer by layer, and a 3D model may be created in a computer for both exact cell counting and 3D image manipulation to observe a spheroid from various angles.

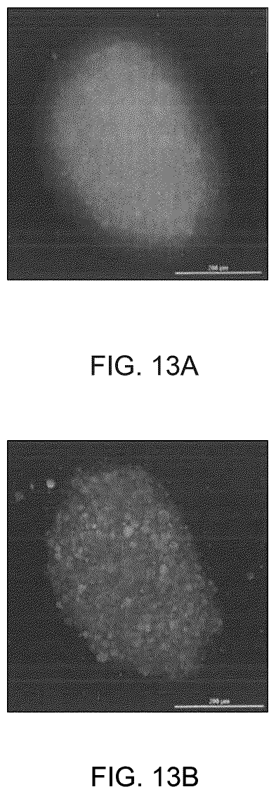

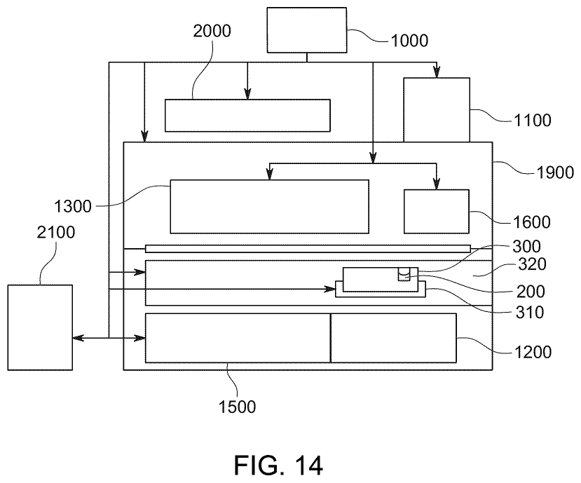

FIGS. 13A-13B are a comparative illustration of a spheroid. FIG. 13A illustrates a spheroid taken at twenty times (20×) magnification with wide field imaging. FIG. 13B illustrates the spheroid taken at twenty times (20×) magnification with and confocal imaging. While the size of the spheroid may be assessed using the image of FIG. 13A, the individual cells and spheroid structure only become visible with the confocal imaging in FIG. 13B.

The advantage of resolution attributed to confocal imaging of FIG. 13B is provided at the expense of decreased light intensity caused by confocal aperture, such that longer exposure times are often required in comparison to wide-field imaging of FIG. 13A.

The addition of confocal fluorescence imaging to an device that also includes non-imaging analysis modalities (fluorescence, absorbance, chemiluminescence, etc.) and wide-field fluorescence imaging on a cell level combined with a controlled live cell environment would deliver to a modern researcher the most versatile single device for analyzing microplate-based assay formats, including those aimed at 3D cell spheroids research.

In an example, there may be a workflow in which wide-field imaging is performed for faster screening, while confocal imaging is performed for publication images related to the O₂, CO₂, pH measurements obtained from sample.

Wide-field imaging may be performed for an HCS type assay, in which the throughput is quicker with wide-field imaging, and the resulting image analysis is still statistically robust. Then, confocal imaging may be employed to acquire representative wells of the “hits” compared to “controls” for publication or presentation purposes.

In an example, there may be a workflow in which wide-field imaging is performed for a quicker primary screening of spheroids based on size. Then, confocal imaging is used for deeper assessment of the size of each “hit” wells, based on nuclear count, which is more accurate using confocal imaging.

Typically, wide-field imaging cannot “see” into the 3D spheroid well enough to reliably count individual nuclei, however, wide-field could still make determinations of “hits” based on total spheroid size. Once “hit” wells are identified with wide-field imaging, identified wells could then be imaged with confocal imaging, to obtain improved image analysis for counting total nuclei in the spheroid, which wide-field imaging alone could not perform.

In an example, there may be a proliferation Assay (3D Endothelial Cell Spheroid Assay) to determine wound healing compound/substance candidates. A primary compound/substance screen may be performed in microplates, in which small endothelial spheroids are treated with an unknown compound library to determine which compounds elicit increased cell growth/proliferation. Compounds that cause increased growth may be contenders for further wound healing studies.

In an analysis workflow, a plate reader may be used to quickly screen the microplate using GFP fluorescence intensity, to determine wells with spheroids of increased size. Wells that meet a threshold of GFP intensity (threshold is statistically determined during assay development) are considered “hits” and selected to be further imaged. Control wells are also always imaged further, as reference wells for comparison with hit wells. Confocal imaging of 3D spheroids may be performed to acquire two-channel z-stack image set (Hoescht 33342 Nuclear marker and GFP marker) of the entire spheroid sample. In image processing and analysis of a maximum projection of Z-stack, a cellular count of spheroid is determined to quantify spheroid size. Visual inspection of distribution of nuclear masks in the image, to determine if there is cell death within the spheroid, is performed. And, results from hit well image analysis are compared to the controls to determine percentage growth against controls.

In an example workflow, 3D tumoroid cytotoxicity and immune response assay (3D Tumoroid Assay from surgical samples to determine Immune and cytotoxic therapeutic response) is performed. The assay involves culturing tumoroids obtained from surgical samples derived from animal models or patients. Because these tumoroids are derived from animals/patients, in-vitro tumor-derived immune cells responses can be evaluated, enabling analysis of tumor response to various therapies. This assay can assess the effectiveness of novel therapeutics in microplate-based format using a heterogeneous multicellular tumor model.

For example, tumoroids may be stained for nuclear count (e.g., blue) and stained for immune cell marker (e.g., red). A microplate reader may be used to assess: wells with high cytotoxicity shown as low blue signal; wells with high immune response shown as high red signal. Wells that meet one or both threshold criteria for cytotoxicity or immune response (threshold is statistically determined during assay development) are considered “hits” and selected to be further imaged. Control Wells are also always imaged further, in order to compare to hit wells. Confocal imaging of 3D tumoroids is performed to acquire two-channel z-stack image set (Hoescht 33342 Nuclear market and CY5 marker) of the entire tumoroid sample. Image processing and analysis is performed for the maximum projection of Z-stack, and cellular count of tumoroid is performed to quantify cellular count. Count of red positive cells is determined for the immune response. Results from hit well image analysis is compared to the controls to determine percentage cytotoxicity or immune response against controls.

Several of the above examples utilize the ability of a single device to run an assay as “hit picking.” The first rapid read identifies the samples of particular interest, typically using a fast reading method that can be fluorescence non-imaging reading or fluorescence or bright field wide-field imaging reading performed at lower magnification. Once wells of interest are identified, called hits, a second more time consuming modality is deployed to determine results of particular interest. This processing is of particular importance if final results are high resolution confocal imaging, in which large data storage is required and gathering vast amount of information on only a few samples that are of interest provide substantial savings of the data storage space. This processing also saves a processing time during data acquisition and data review, as most samples are not “hits” and are dismissed during the first assay step. A single unified device to perform the various disparate processing steps can streamline the analysis.

Other applications of the capabilities of the single device with the diverse functionality to study of spheroids are possible. Spheroids are typically grown in round bottom wells. Often, for the final imaging step, spheroids are transferred into flat bottom plates for the purpose of preventing the rounded well bottom as functioning similar to a lens during imaging, thereby unnecessarily inducing optical aberrations and negatively affecting the resultant image quality. High quality microscope objectives are not designed for such “roundwell” bottom lens in the optical path. After transfer into another well, dish, or plate for the best image quality, the exact location of the spheroid in the well is no longer known. In a preferred embodiment, wide-field imaging at lower magnification but larger field of view to image the well could be performed to locate the spheroid (region of interest), then position the well to bring the found spheroid location (region of interest) in line with the optical axis and use a higher magnification objective with smaller field of view to image the spheroid in confocal modality and perform Z-stack, by collecting multiple images while the objective traverses along the objective's focusing axis, perpendicular to the well bottom surface. The spheroid (region of interest) may be identified by using a non-imaging analysis modality of the device by performing fluorescence read area scan and selecting the region of a maximum fluorescence signal fur imaging.

FIG. 14 is a block diagram illustrating a multi-detection system according to an embodiment.

As illustrated in FIG. 14, the multi-detection system includes a controller 1000, a fluid injection subsystem 1100, an imaging subsystem, including wide-field imaging components 1200 and confocal imaging components 1500, a non-imaging analysis subsystem 1300, an imaging illumination subsystem 1600 for wide-field imaging, housing 1900, a microplate 300, a carriage 310, incubation chamber 320 for incubating a sample in a well 200, an environmental control subsystem 2000, and a confocal imaging subsystem. The multi-detection system may also include an external subsystem 2100.

Samples are placed into wells 200 (e.g., microwells) of the microplate 300. The microplate 300 is transported by the carriage 310 into and out of the measurement and incubation chamber 320. When disposed to be exposed to an external environment of the multi-detection system, the microplate 300 may be accessible outside the incubation chamber 320 and/or housing 1900 for access by a technician or robotics arm. When the microplate 300 is disposed within the chamber, various supported imaging and non-imaging analytical modalities may be performed.

The carriage 310 is part of a microplate transport subsystem for positional manipulation of the microplate 300, and may include any suitable combination of belts, platforms, microplate holders, motors, and positioning software executed under hardware control for the positional manipulation. When the microplate 300 is disposed within the incubation chamber 320, the entire microplate 300 remains incubated. The incubation system and incubation chamber 320 will be later described in detail.

The non-imaging analysis subsystem 1300 may be based on illumination via a flash bulb, dual excitation monochromators, and dual emission monochromators, photomultiplier tubes (PMT), and silicon detectors. The non-imaging analysis subsystem 1300 supports absorbance, fluorescence, and chemiluminescence analysis modalities for detection of corresponding properties of the sample in the well 200. The non-imaging analysis subsystem 1300 may be implemented as a filter-based subsystem or as hybrid of any or all of the above.

The imaging subsystem includes wide-field imaging components 1200 and confocal imaging components 1500, such as objectives, lenses, LEDs, filter cubes, spinning disks, cameras and other components. The imaging illumination subsystem 1600 includes illumination components for wide-field imaging and is able to provide illumination for bright field, color bright field, and phase contrast imaging modalities.

The external subsystem 2100 may be an external confocal illumination subsystem for confocal imaging that can be modularly connected to and disconnected from the imaging subsystem within the housing 1900 via fiber optics for added flexibility of the physical placement of the external subsystem 2100 relative to the device. Alternatively, the confocal imaging illumination subsystem may be disposed to be integrated within the housing 1900.

The fluid injection subsystem 1100 delivers reagent to the wells 200, if required by an assay. The fluid injection subsystem 1100 may include any combination of pumps, reservoirs, lines or tubing, pipettes and tips, and software executed under hardware control for delivering, and if necessary aspirating, fluid to and from the wells.

The environmental control subsystem 2000 shown externally placed relative to housing 1900 may include a gas control module that provides control of atmospheric conditions inside the housing 1900. Other control modules may include modules for control of temperature, humidity, and other conditions, which may be controlled within the housing 1900 under control of the environmental control subsystem 2000. The environmental control subsystem may include any combination of pumps, reservoirs, lines or tubing, fans, heating and cooling elements, and the like for controlling all conditions within the housing 1900. The housing 1900 houses most of the subsystems and defines the physical space in which gas atmosphere, conducive to live cells, can be effectively maintained and controlled by the environmental control subsystem 2000.

The controller 1000 may control all operations of the multi-detection system. The controller 1000 may communicate by wire or wirelessly to each of the various subsystems in the multi-detection subsystem. The controller 1000 may include any combination of hardware (e.g., CPU, memory, cables, connectors, etc.) and software for execution by the hardware for controlling operations of the multi-detection system.

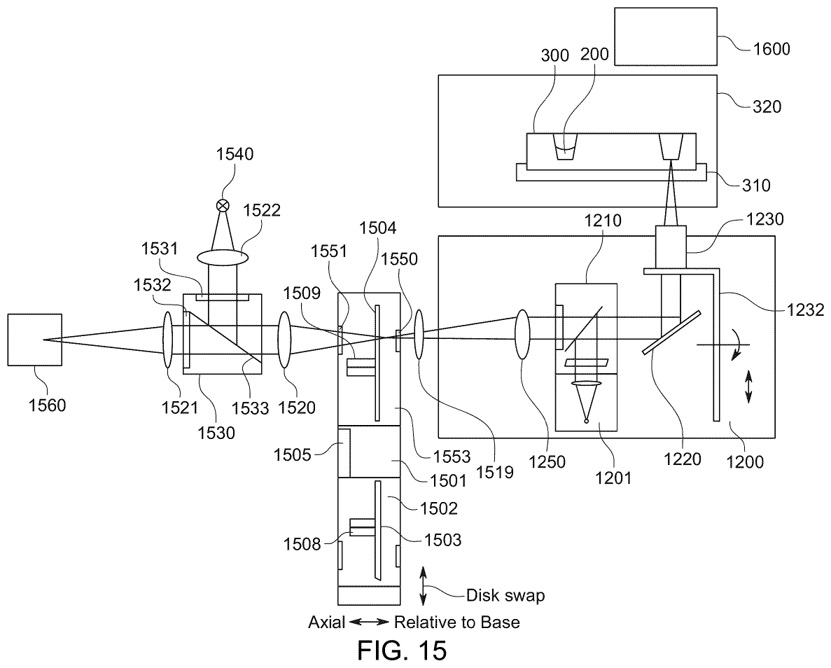

FIG. 15 is a block diagram illustrating a multi-detection system according to an embodiment.

Several imaging modalities are made possible by the multi-detection system. Wide-field imaging in fluorescence, bright field, and phase contrast may be performed in additional to the confocal imaging modality. Optical elements of both the confocal imaging system and wide-field imaging systems are shown in FIG. 15.

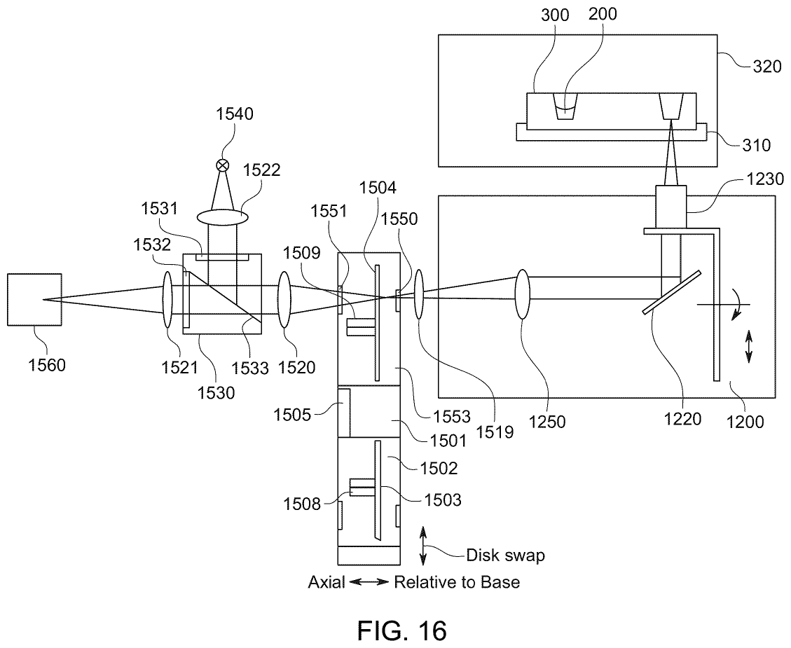

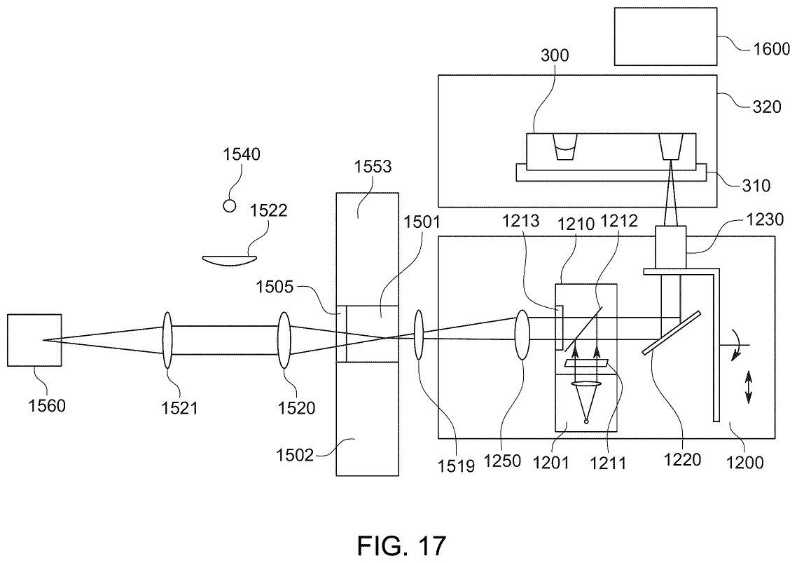

A microplate 300 may be placed onto a carriage 310 (e.g., a carrier for a sample carrier) that positions the well 200 of interest in line with an imaging optical axis of the objectives 1230. An objective may be selected from among several objectives of various magnifications placed on an objective turret 1232. The relative position of the imaging illumination subsystem 1600 is illustrated in FIG. 15, and the imaging illumination subsystem 1600 may be used for bright field, color bright field, and phase contrast imaging to the sample. Many optical elements are shared between wide-field and confocal systems and more detailed description of such sections will be provided below in FIGS. 16-17, in which some elements of FIG. 15 are omitted for clarity.

FIG. 16 is a block diagram illustrating a multi-detection system according to an embodiment.

Confocal imaging as deployed as shown in FIG. 16. Wide-field imaging subsystem elements (e.g. LED cube 1201 and filter cube 1210) are automatically removed from the optical path to the sample and the system shown in FIG. 15 is transformed into the confocal optical system illustrated in FIG. 16, for understanding of the confocal light path.

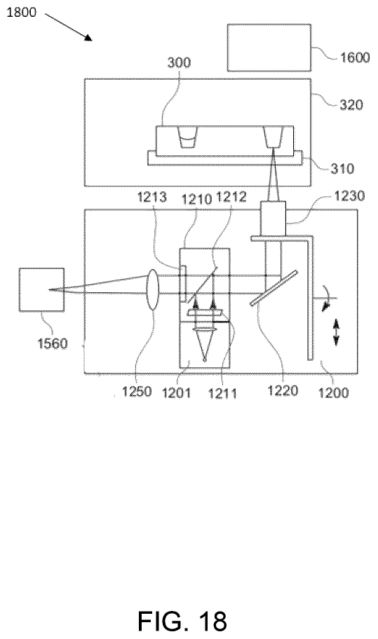

A spinning disk confocal system is deployed as an example embodiment of the confocal imaging system. The system is based on utilizing a spinning disk (FIG. 18) the optical path. The disk is placed in the intermediate image plane conjugal to a sample and detection planes. The disk is thus both in the excitation light path and the emission light path. The disk is typically around 2 mm thick and made from glass or quartz, in an example embodiment. The disk may be coated to be non-transparent, or having a given transparency or opacity, except for clear areas left as a pattern of pin holes or slits. Ideally the disk surface is made to not reflect oncoming light. A sample to be imaged is illuminated by excitation light transmitted via the pin holes. Only radiation emitted by the sample, which is generated from these illuminated spots on the sample, reaches a detector via pin holes of the disk. The pin holes or slits, while many, are spaced far away from each other to act optically independently. The energy from adjacent pin holes does not ideally affect the sample spots illuminated by a given pin hole. The disk spot pattern is typically arranged in several spirals as shown in FIG. 18. The disk may be controlled to continuously spin, thus scanning the sample. As the disk rotates, the sample is illuminated one spot at time and the complete sample image is detected on the detector for reconstruction as a complete image of the sample.

Returning to FIG. 16, the confocal light source 1540 may be any light source suitable for confocal microscopy. For example the confocal light source 1540 may be a solid state light source, such as a light emitting diode (LED) or solid state laser or semiconductor-based laser (laser diode). In an example embodiment, the output tip of the optical fiber may be a light (radiation) source. Radiation is as an embodiment, as the excitation spectrum could be outside of 380-630 nm range that is commonly referred as light. However, the term “light source” is more commonly used in imaging, and the term light will be used interchangeably with radiation herein. The input tip of the fiber can be illuminated from a light source module external to the device to allow flexibility in selecting the best light source match for the sample imaging needs. The fiber also allows flexibility of bifurcating input from multiple external light sources. The output tip of the fiber is imaged by condenser 1522 onto or close to the intermediate sample image plane where spinning disk 1504 is located. The light from the fiber may be sent through excitation filter 1531 and then is reflected from the dichroic mirror 1533 and focused by the tube lens 1520 onto the spinning disk 1504. The term “lens” here and throughout the description may refer to a single lens or group of lenses depending on the embodiment and function, as appreciated by person skilled in the art. As discussed, the disk has a spiral pattern of holes of slits. A field lens 1519 minimizes the light loss and guides the light exiting the disk to be gathered by the tube lens 1250. The tube lens 1250 guides the excitation radiation into objective 1230 via mirror 1220. The objective 1230 illuminates the small spots on the sample near the bottom of well. The sample components have been stained with dye that corresponds to excitation wavelength. Those components are excited with oncoming radiation and emit radiation that typically has a longer wavelength. This emitted light is guided to the detector as follows.

Light emitted by a sample is collimated by objective 1230, and is reflected by mirror 1220 and gathered by tube lens 1250 and field lens 1519 onto spinning disk 1504. The intermediate image of the sample in emitted light is formed at the spinning disk 1504 surface. The tube lens 1520 and lens 1521 invert that image and form a sample image at the detector 1560. The detector 1560 is typically a pixilated digital camera, such as charged couple device (CCD) camera or complimentary metal-oxide semiconductor (CMOS) camera. The sample image is captured by the camera, and may be stored in memory of the multi-detection system or an external computing system, and could be enhanced and analyzed for various properties and/or presented to the user on a visual display.

A confocal cube 1530 (e.g., a confocal excitation/dichroic mirror/emission cube) is shown between the tube lens 1520 and lens 1521, which is an arrangement for fluorescence microscopy. The filters and dichroics may be thin film coatings on glass. Excitation filter 1531 forms a bandpass for excitation and emission filter 1532 forms a bandpass for emission, while the dichroic mirror 1533 separates excitation and emission to fully use the available energy and to suppress magnitude of excitation light reflected from multiple optical surfaces as excitation light travels towards the sample, including the disk surface, that reaches the detector. The lens 1521 (e.g. an emission filter) provides most of the excitation light suppression, but the dichroic mirror 1533 also plays a suppression role. An alternative arrangement for the described cube could be several filter wheels that carry excitation filters, emission filters and dichroics. In the exampled embodiment, cubes are a method of arranging the described elements, which allows very easy exchange by a user as imaging needs change. Several filter cubes (e.g. confocal cubes 1530) can be arranged on a motorized slider and could be identified either by setup in software performed by user or labelled electronically or optically with a code to be read automatically via bar code or some other automatic available method.

The surface of the spinning disk is imaged onto detector along with the sample. Thus, any dust particles that attach to the disk surface may show up as artifacts in the image, for example streaks of bright light due to disk rotation. The small particles can easily adhere to the disk surface with sufficient force that resists centrifugal forces. The spinning disk 1504 and the disk drive motor 1509 are part of a disk module 1553. The disk in the module is typically assembled in clean environment, like clean room, and is sealed from the ambient environment to prevent dust particles from settling on the disk. The windows 1551 and 1550 in the module allow light to pass through, but keep dust out. Ideally, these dust protection windows should be placed as far as feasible from the intermediate image plane so dust that could settle on the window glass does not result in artifacts in the image. The disks are fully contained within the disk modules 1502 and 1553. Thus, the user should not open the modules to avoid introducing particles of dust to the disk.

FIG. 16 illustrates two disk modules 1553 and 1502 installed in the multi-detection device. The disks can be moved to position one disk or another disk into the optical path. Alternatively, both disks can be moved out of the light path and space 1501 placed along the optical axis. This allows for wide-field imaging modality to be performed, such as fluorescence imaging, bright field imaging, or phase contrast imaging.

A great benefit of allowing both confocal and wide-field imaging options for the user in the same device is ability to overlay images in various imaging modalities, such as a wide-field image and the same image in confocal imaging modality, for example. Alternatively, a bright field image may be utilized to locate a region of interest that is then imaged confocally. For this arrangement to properly obtain an image, the magnification in both modalities should match exactly or the images do not overlay properly. The light in the section between the tube lenses 1520 and 1250 is not parallel. In confocal modality, several flat windows are present in the optical path in this section: confocal disk and dust protection windows. There is no need for these windows in the wide-field modality. But, to match optical path length in the non-parallel light path, the glass 1505 is added in the space 1501 between confocal disks through which wide-field imaging takes place. This assures that a sample remains in focus for a fixed objective position when the image modality changes. This assures that magnification in confocal and wide field imaging modes match. The thickness of glass 1505 should match the sum of flat windows of a disk used in confocal imaging (window 1551, spinning disk 1504, and window 1550). The glass 1505 should be placed as far as feasible from the intermediate image plane so dust that could settle on the glass does not result in artifacts in the image.

The pin hole size on the confocal disk is ideally selected based on the parameters of an imaging objective 1230. In an embodiment, the size of image of the disk pin hole made on the sample may be matched to the distance between the first two minima of the Airy diffraction pattern of objective. The formula for Disk pin hole size, as given in Zeiss “Introduction to Spinning disk microscopy,” is

Disk pin hole diameter=1.2*Magnification of objective*Emission Wavelength/Numerical Aperture of Objective.

Both numerical aperture (NA) of the objective and magnification are part of the formula. If a pin hole is too small, too much light is lost and time to take an image increases. If a pin hole is too large, the confocal effect can be reduced or lost altogether. Most commercial spinning disk microscopes feature non interchangeable spinning disk with pin holes in range 50-70 um. This works reasonably well as a compromise with the range of high magnification objectives typically deployed with confocal microscopy. But it is preferred, a disk with appropriate pin holes can be matched to the objective used.

Some spinning disk implementations do not possess a spiral pattern of round holes, but instead employ slit apertures. Slit apertures may provide a relatively brighter illumination of the sample and more intense emission signal, whereas pin hole apertures may provide relatively better axial resolution. Hence, for some imaging applications, including biological fluorescence application slits may be preferred to be able to reduce image acquisition times, which is another reason to change the disk even for a fixed objective.

Multiple disks may be deployed in the imaging device so that selection from among the disks may be performed by the user or automatically by the multi-detection system.

FIG. 16 illustrates an example of two disk modules 1502, 1553 used in the multi-detection device. All disk modules can be configured to be replaced by the user. The modules can be identified either by setup in software controlled by user or labelled electronically or optically with codes to be read automatically via bar code or some other available method, to enable automatic configuration by the multi-detection system.

One additional advantage from a modular disk module is the ability for the user to clean the windows 1551 and 1550, which may provide dust protection, when the disk module is removed from the device and both windows are easily accessible.

Module identification enables automated software setup and to automatically reset and calibrate the module axial position in the optical path. In the spinning disk confocal imager the disk surface plane, detector sensitive element plane and sample planes should be conjugate to each other. This means, if following emission rays from sample, the image of sample plane is coincident with the disk plane, and disk planes and sample planes images are coincident with the detector plane. The detector 1560 sensitive chip plane is fixed by camera design. The objective 1230 can be moved along the focusing axis to sharpen the sample image on the detector. Then, the disk should be ideally placed in the intermediate plane conjugal with both the detector and intermediate sample image plane for all three planes to be conjugate. In a proposed embodiment, a disk axial position is held very close to an ideal conjugate position by disk module design, but the final position of the disk surface can be adjusted automatically by observing the disk pattern on the detector and bringing this pattern into sharp focus on the detector. Multiple image based focusing methods are available and are well known in the industry. Once a best disk surface position is found, this position can be stored in software and memory, and associated with the disk module. If the disk module is removed and reinstalled, the correct disk position can be restored automatically by software. If a new disk module is introduced, the system will alternatively engage the disk focusing routine and will select the best axial position for the new disk module. The user thus can be relieved from keeping track of what disk module is deployed in the device, and the various positioning thereof.

Alternatively, if only a few disk modules are envisioned to be utilized, then a user can setup disk modules via a setup screen in the calibration section of a user interface of software included with the multi-detection system.

The two concepts of user replaceable disk module and automated axial disk positioning work best in tandem, but may be separately implemented. If automated axial disk positioning is unavailable, the disk modules may be configured to be interchangeable relative to the disk position and some datum on the module that assures proper placement in the device. The concept of easily replaceable disk modules, that user does not have to open and thus subject to environment, would still apply and bring benefit to the user who wants flexibility of multiple disks best suited for deployed imaging objectives and samples.

Even if disk modules are limited to one or two in the device, the automatic axial adjustment can be used to alleviate the need to strictly control location of the detector image sensor sensitive surface in the detector 1560 (e.g. camera). In the case to allow user maximum flexibility in camera selection and to also allow upgrade of camera within the multi-detection s system. If the sensor surface after camera replacement moved, the disk surface can be relocated automatically to be conjugate to sensor surface via image-based autofocus routine.

FIG. 17 is a block diagram illustrating a multi-detection system according to an embodiment.

In FIG. 17, wide-field imaging as deployed in an example embodiment is illustrated. As described above, the optical section (with elements labelled 15xx) does allow both confocal imaging (with spinning disks 1504 or 1503 in optical path) and wide-field imaging (via space 1501 between the disks). But, there may be a shortcoming of using this optics and confocal light source 1540 and confocal cubes 1530 for wide-field modality the researcher may want to deploy in a single versatile device. For confocal imaging, the excitation radiation should be directed onto the disk via multiple optical elements (e.g. dichroic mirror 1533, tube lens 1520, window 1551) positioned prior to the disk surface. After the disk, excitation radiation is guided to the sample via more optical elements (e.g. window 1550, field lens 1519, tube lens 1250, mirror 1220, objective 1230). For confocal imaging, there is no choice to this scheme. But, on every surface encountered, some of excitation light is reflected back. Good design then relies on careful ray tracing to ensure that reflected light is kept from the detector as much as possible and on the emission filter 1532 to suppress the unwanted reflected light. The optical elements prior to the disk surface as tube lens 1520 and window 1551 and the spinning disk 1504 surface are exposed to very strong level of excitation radiation that partially gets reflected. Also, any dust particles may get excited and will fluoresce. Despite the best intention of the designer, some of the light does come through to the detector and reduces signal to noise ratio. Thus, a non-fluorescing sample that should appear very dark on the image, may not appear very dark. This may be due to noticeable background signal due to reflected light, the effect that tends to be uniform across the image. For wide-field microscopy using the confocal section excitation elements described above in FIG. 16 would come with significant compromise in image quality and system capabilities.

In an example embodiment, an alternative subsystem is provided in the same device that can be used for wide-filed fluorescence imaging. Confocal cubes 1530 of a confocal subsystem are positioned out the way and spinning disk module gets positioned to the space 1501 for wide-field imaging. This transforms the configuration of FIG. 15 into the configuration of FIG. 17. The dedicated wide-field section elements are an LED cube 1201, and wide-field excitation/emission/dichroic imaging filter cube 1210. The excitation filter 1211, dichroic mirror 1212 and emission filter 1213 are mounted in a filter cube that typically will be matched with the LED cube 1201 for best signal to noise performance. Several of these cube pairs, corresponding to specific chemistry being investigated, can be provided on a slider.

There are several advantages to this design.

First, is that the LED excitation optics is much nearer to the sample, and thus excitation light encounters fewer optical surfaces on the way to sample. Reflections from those surfaces, that can reach the detector, are thus greatly reduced, and signal to noise in the image is improved.

Second, is the wide verity of LEDs used in LED cubes 1201 that are available in the market that may not be powerful enough to be used in the confocal optical tract, but can deliver sufficient excitation if placed closer to the sample as shown in FIG. 17.

Third, particularly important if sample has to be excited in UV range, is that some objectives are rated as UV objectives and transmit UV light and exhibit very low fluorescence when excited by UV. But, in general optical elements commercially available for the rest of optical tract, such as tube lenses, are not assured to be fluorescence free when illuminated by UV light. If a wide-field image of a sample stained with common DAPI nuclear stain is required, a common approach in the confocal optical tract is to use wavelength around 400 nm, and thus to avoid strongly exciting optical elements in addition to the sample. But moving excitation towards 400 nm from 360 nm, the wavelength that is ideal for DAPI stain excitation, reduces emitted light a great deal. A researcher would need to place higher concentration of dye in the sample or raise the detector gain, and thus reduce signal to noise of imaging. Ideally the excitation of DAPI stained sample will be done at 360 nm, but the UV excitation light will not pass through optical elements that may fluoresce. LED Cube 1201 and filter cube 1210 allow just such an optimum option in an example embodiment. The UV excitation enters only objective 1230 that can be selected to not fluoresce. The emitted light does pass back to detector via multiple optical elements common to confocal and wide field tract, but because emitted light is in the visible spectrum range, the optical elements the light encounter do not typically fluoresce at the level they do in UV light.

FIG. 17 shows a relative location of an imaging illumination subsystem 1600 for wide field imaging in non-fluorescing modalities. This can be bright field, color bright field with tri color LEDs switchable one at a time, or phase contrast illumination system with ring apertures that would be matched to phase contrast objectives.

Additional embodiments and components of imaging systems are further described in, PCT Patent Application No. WO2022120047A1 “Universal multi-detection system for microplates with confocal imaging”, which is incorporated herein by reference in its entirety for all purposes. Such components include, e.g., a laser point scanning confocal (LSC) modality laser point scanning confocal (LSC) system, a spinning disk confocal system, and wide field functionality in a single device, etc.

FIG. 18 shows an exemplary widefield imaging system 1800 without confocal option as deployed in an example embodiment. The widefield imaging system includes an imaging subsystem module 1200 has visual access to the microwells 200 of the micro plate 300 located on the carriage 310 housed in the measurement chamber 320, wherein an image of the microwell 200 may be imaged by tube lens 1250 and a camera 1560.

As detailed above, microplate 300 may be placed onto the carriage 310 that positions the well 200 of interest in line with an imaging optical axis of the objectives 1230. An objective may be selected from among several objectives of various magnifications placed on an objective turret 1232. The relative position of the imaging illumination subsystem 1600 is illustrated in FIG. 15, and the imaging illumination subsystem 1600 may be used for bright field, color bright field, and phase contrast imaging to the sample. Many optical elements are shared between wide-field and confocal systems and more detailed description of such sections will be provided below in FIGS. 16-17, in which some elements of FIG. 15 are omitted for clarity.

Further details of the imaging subsystem module are discussed later above with respect to FIGS. 16 and 17. Components of the widefield imaging system are further described in, e.g., U.S. Pat. No. 10,072,982 titled “Universal multidetection system for microplates”, which is incorporated herein by reference in its entirety for all purposes.

A configuration according to embodiments of the present disclosure may also incorporate or include a laser point scanning confocal system, a spinning disk confocal system, and wide field functionality in a single device is described below. However, embodiments of the present disclosure may include any combinations of the above systems and functions.

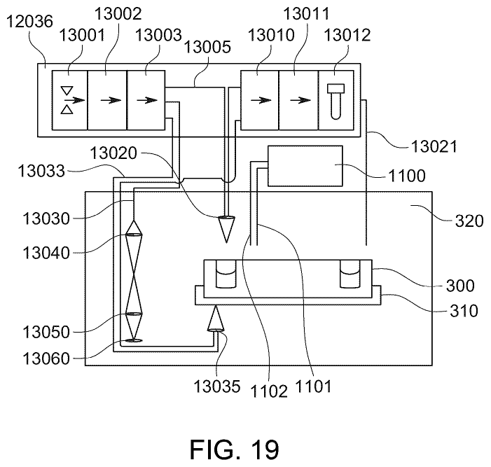

FIG. 19 is a diagram of a non-imaging analyzing subsystem according to an embodiment. Referring to FIG. 19, the non-imaging analysis subsystem 1300 of the multi-detection system is provided.

The analytical modalities of the non-imaging analysis subsystem 1300 may be absorbance, fluorescence from top and bottom, and chemiluminescence. The Xe flash bulb 13001 emits radiation in the range 200-1000 nm. The two stages 13002 and 13003 of fluorescence excitation/absorbance dual monochromator select a narrow band pass of radiation. The radiation is guided towards sample by fiber optics cables to either absorbance channel via fiber 13030, top fluorescence via 13005 or bottom fluorescence via 13033. Only one fiber is acting at a time so there is no cross talk of light among various analytical modes. Absorbance is measured via lenses 13040 and 13050 by silicon detector 13060.

Top fluorescence excitation and emission pick up are performed via lens 13020, which can move up and down to accommodate various microplate and fluid levels. Bottom fluorescence is done in similar manner with lens 13055. Both top and bottom emissions are guided by fiber optics cables to the first stage of the emission dual monochromator 13010 and 13011 and then to photomultiplier 13012. The chemiluminescence fiber 13021 can be connected directly to the photomultiplier to offer measurements for very faint light via bypassing monochromator.

The fluid injection subsystem 1100 can provide researcher with ability to inject reagent via fluid lines 1112 and 1111 and rapidly measure results of injection by analysis subsystem further increasing range of test that can be performed in the device.

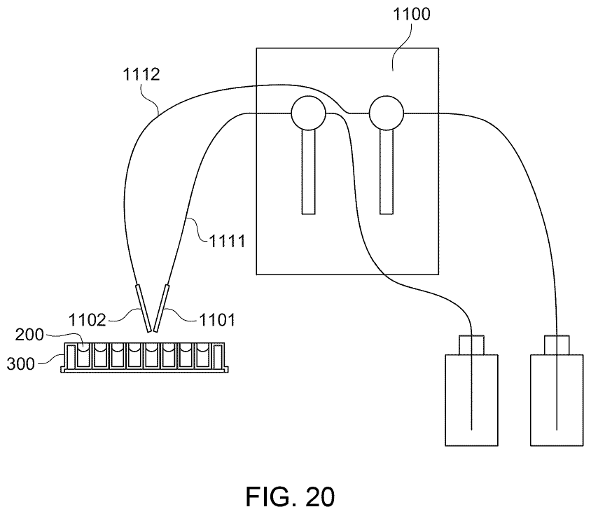

FIG. 20 is a diagram illustrating an injection subsystem according to an embodiment.

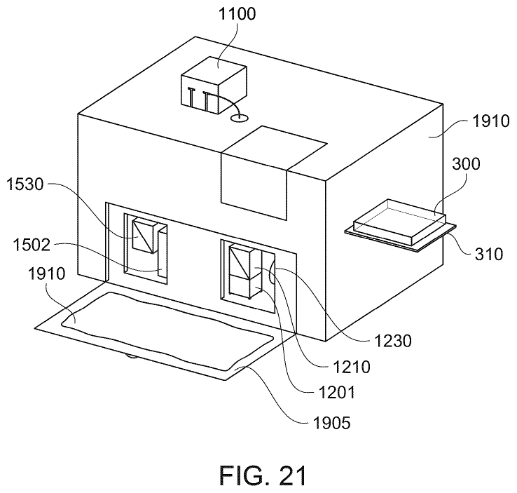

Referring to FIG. 20, an optional injection subsystem is provided. The injection subsystem 1100 can be placed on top of the multi-detection device, and fluid lines 1112 and 1111 fed through the bulkhead access in the top of the housing, as shown in FIG. 21. The reagents are delivered to microwells by pumps in the fluid injection subsystem 1100 via fluid lines 1111 and 1112 that can be PTFE lines, and into wells via injection needles 1102 and 1101, as shown in FIG. 20.

Referring to FIG. 19, environmental control may deployed in the multi-detection system.

The carriage 310 supports the microplate 300 (e.g., sample carrier) and is located in the incubation chamber 320, as shown in FIG. 19. This assures that microplate 300 is maintained at a desired temperature in all the positions of the carriage 310 in the incubation chamber 320. The incubation chamber 320 can be constructed from material that well suited to maintain constant temperature, like continuous aluminum sheets, while still providing access to optical elements via small openings. The incubation chamber 320 is typically thermally insulated. The design of such chambers will be known to a person familiar with the art and from many multi-detection devices. A common controlled temperature range may be from room temperature to the 65 C.

FIG. 21 is a diagram illustrating a multi-detection system according to an embodiment.

For live cells, the temperature is typically 37 C, but in addition control of gas around the sample is required. The control is accomplished by filling the complete housing 1910 of the device of FIG. 21 with appropriate gas mixture. The design avoids trying to contain the gas controlled environment to just measurement chamber or separation partitions. The aim of the design is to allow atmosphere within the housing 1910 to equalize. The design of the housing 1910 is thus made as gas tight as feasible by avoiding gaps in the housing and using soft gasketing material around user access doors.

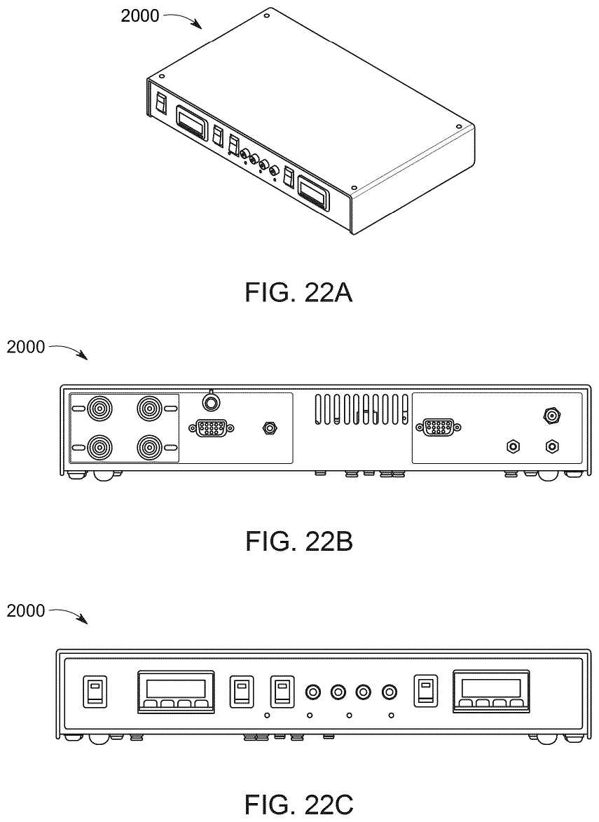

FIGS. 22A-22C is a diagram illustrating a gas control subsystem according to an embodiment.

Referring to FIGS. 22A-22C, an environmental control subsystem 2000 (e.g. a gas control subsystem) may be disposed external to the device. The environmental control subsystem 2000 allows a user to set CO₂ and/or O₂ concentration levels within the chamber to be different from a normal atmosphere: higher CO₂ and lower O₂. A gas sampling line connects the environmental control subsystem 2000 to the inside of the device housing. Based on composition of gas sampled or extracted from the device via the sampling line, the control systems may adjust flow of the CO₂ or N₂ gas being fed into the device, for example by the incoming gas being dispersed with small fan. This allows placement of all gas sensors and valves external to the main device and keeping complexity and reliability of gas control within external gas controller.

The combination of incubation chamber around the XY carrier travel zone and gas control of the atmosphere inside the housing, and thus around the microplate, provides user with ability to run long term live cell experiments.

Referring to FIG. 21, an outside view of the overall device and elements subject to user interaction with the device as implemented in the example embodiment is shown. The carriage 310 presents itself to the user (shown at right) and a microplate 300 is placed onto the carriage 310, for example by a user or robotics arm, and is then positioned within the multi-detection system. The access to confocal cubes 1530, wide-field LED cubes 1201, and wide field filter cubes 1210, confocal disk modules and objectives 1230 is via the front of the device via door 1905. Thus facilitating the user access to more user changeable elements at once.

According to certain embodiments, objectives (e.g. objective 1230 or objective 2210) of the present disclosure may be fluid immersion objectives.

A way to improve optical performance in microscopy is to use fluid immersion objectives. In light microscopy, a fluid immersion objective is a specially designed objective lens used to increase the resolution of the microscope. According to embodiments of the present disclosure, the optical system is an inverted microscope, meaning that the objective is located under the sample and views the sample from underneath. In inverted microscope arrangements of the present disclosure, when performing fluid immersion, a drop of fluid (e.g. water or other fluid) is put on the objective and is held in place by the surface tension of the fluid. The objective is then brought to the sample, where the droplet is sandwiched between the sample and the objective. In this way, the light passing to and from the sample to the objective does not go through air. The higher refractive index of the fluid over air results in increased numerical aperture. This increases resolution and increases the signal level. According to embodiments, the objective may be brought to the sample, and then the drop of fluid is put on the objective.

In addition to water immersion objectives, objectives of the present disclosure may be provided with other types of fluid for increasing numerical aperture. Some examples of the fluid include, for example, oil and glycerol. In embodiments of the present disclosure, the fluid may be water, oil, glycerol, or some other type of fluid that would increase the refractive index.

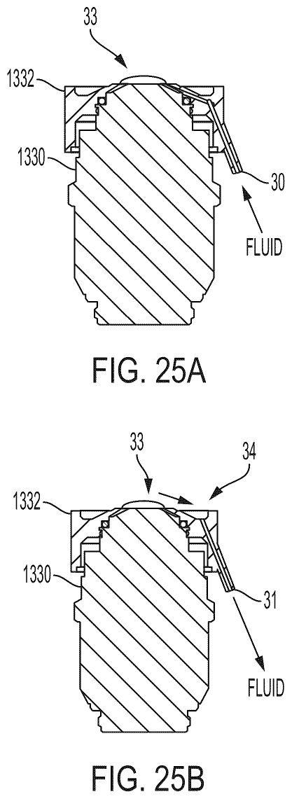

With reference to FIGS. 25A-25B, a liquid immersion objective according to embodiments of the present disclosure is described below. According to embodiments, an objective 1330 may be provided with a sleeve 1332 that fits over the objective 1330. The sleeve 1332 may be configured to provide a fluid path in and out of the sleeve 1332. In addition, the sleeve 1332 helps hold a fluid droplet 33 in place. According to embodiments, the sleeve 1332 has a port for pumping fluid in and a port for pumping the fluid out. According to embodiments, as shown in FIGS. 25A-25B, the inlet and outlet port may be a same port 31. With reference to FIG. 25B, liquid droplet excess 34 may exit the sleeve 1332 through the port 31. In an example embodiment, the sleeve 1332 may be formed of, for example, anodized aluminum, plastic, or other materials.

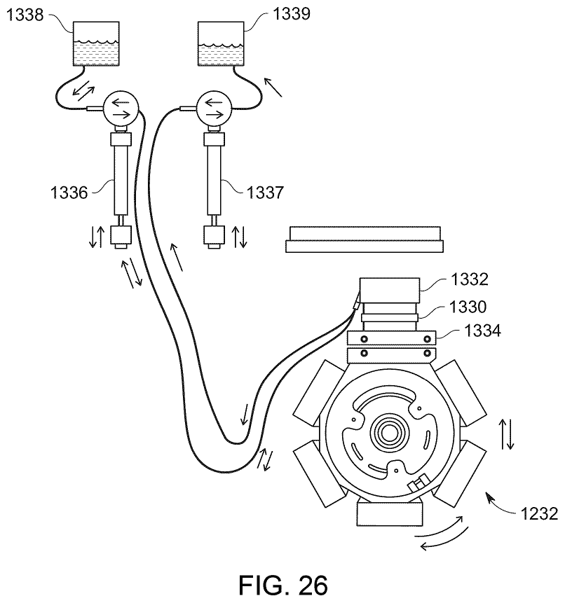

According to embodiments, with reference to FIG. 26, a fluid pump system may provided. The fluid pump system may include a first pump 1336, a second pump 1337, a first reservoir 1338 (a source reservoir), and a second reservoir 1339 (a waste reservoir), The fluid may be pumped by the first pump 1336 from the first reservoir 1338 to the head of the objective 1330. As shown in FIG. 26, the first pump 1336 may be a syringe pump. The fluid is then removed from the objective 1330 via the second pump 1337 pumping the fluid to the second reservoir 1339. The second pump 1337 may be referred to as a waste pump and may also be a syringe pump, as shown in FIG. 26. The first pump 1336 and the second pump 1337 may be other types of pumps that achieve the same or similar functionalities. The sleeve 1332 may be fit to the objective 1330, guide the fluid to the top of the objective 1330, and help to hold the fluid droplet in place. The sleeve 1332 may also have a waste port in which the fluid may be configured to be removed from the sleeve 1332. The objective 1330 may be a specially designed objective optimized for fluid (e.g. water) immersion application. In FIG. 26, the first reservoir 1338 and the second reservoir 1339 are shown as separate source and waste reservoirs, respectively. However, according to embodiments, a single reservoir may be provided, instead of the two separate reservoirs, in which the fluid could be reused. Additionally, the pumps may be multipurpose. For example, the BioTek C10 product has a fluidics dispense module that may be used to dispense reagents into the sample. This same dispense module could be configured to have additional purposes (including the purpose of the first pump 1336 and/or the second pump 1337) so as to reduce cost.

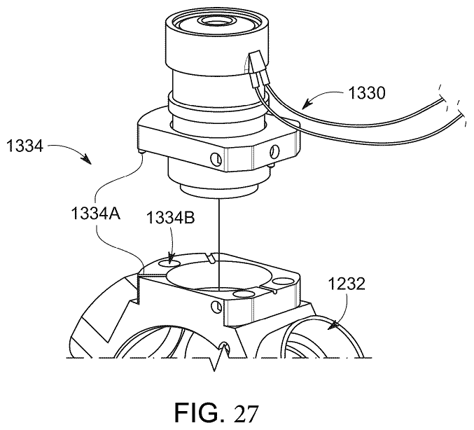

With further reference to FIG. 26, the objective 1330 may be attached to the objective turret 1232 by an objective coupling 1334. Description of the objective coupling 1334 is provided below with reference to FIG. 27.

As shown in FIG. 27, the objective coupling 1334 may include kinematic connections 1334A and magnets 1334B that are configured to couple together the objective 1330 and the objective turret 1232. For example, the objective 1330 may be provided with at least one from among a protrusion or recess as a first part of kinematic connections 1334A, and the objective turret 1232 may be include at least one of the other from among the protrusion or recess as a second part of the kinematic connections 1334A that corresponds to the first part. The magnets 1334B may be provided with one or more of the objective 1330 and the objective turret 1232. According to embodiments, both the objective 1330 and the objective turret 1232 may be provided with the magnets 1334B that correspond to each other and are configured to connect to each other via a magnetic force. In other embodiments, only one from among the objective 1330 and the objective turret 1232 may be provided with the magnets 1334B, which may be configured to connect to a magnetic material (e.g. a metal) provided with the other from among the the objective 1330 and the objective turret 1232.

According to comparative embodiments, objectives may be screwed into an objective turret. However, the use of a sleeve and tubing with an objective may make screwing the objective into an objective turret difficult in at least some embodiments. The use of an objective coupling 1334 that includes kinematic connections 1334A and magnets 1334B, according to embodiments of the present disclosure, enables an objective with a sleeve and tubing to be easily installed.

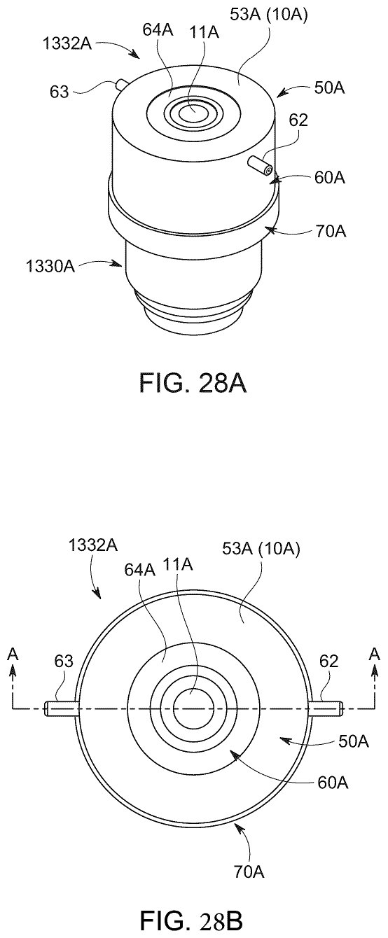

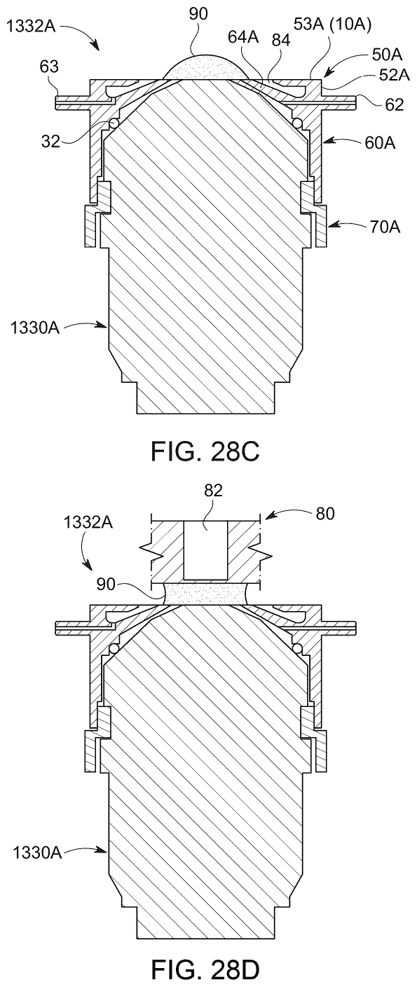

According to embodiments, with reference to FIGS. 28A-31C, the objective 1330 and sleeve 1332 may have various configurations. According to embodiments, the sleeve 1332 may also be referred to as a cap.

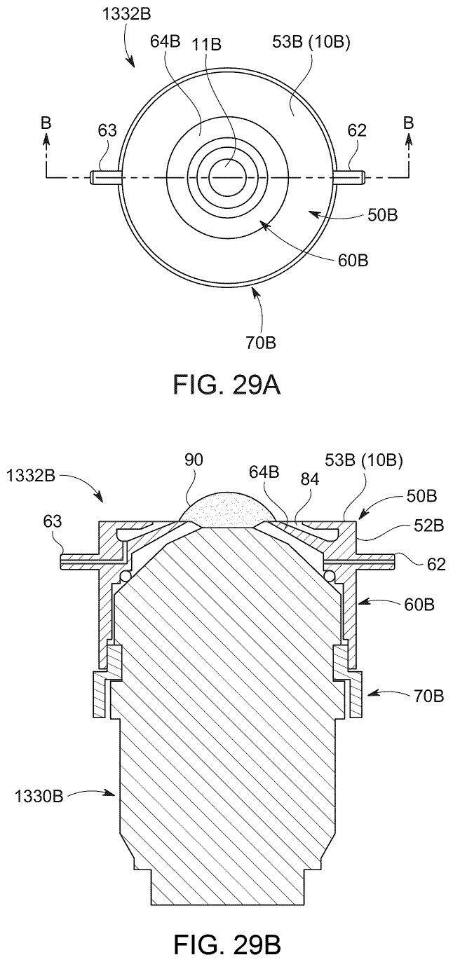

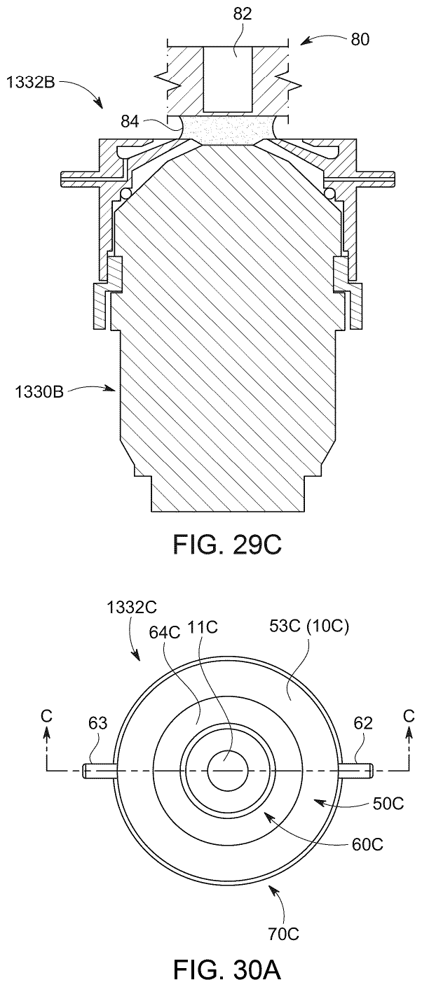

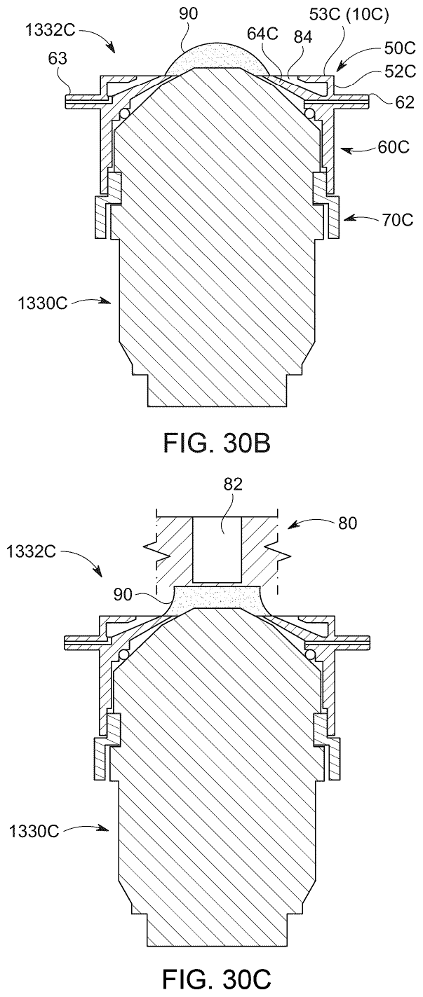

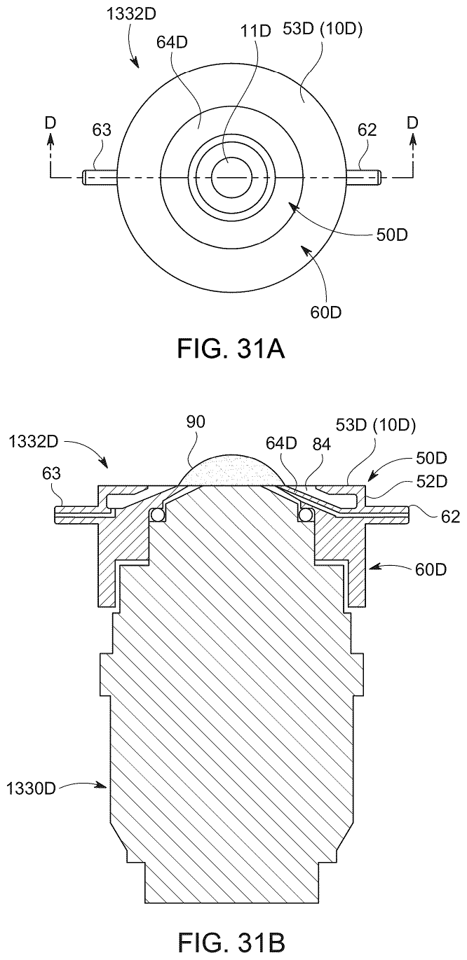

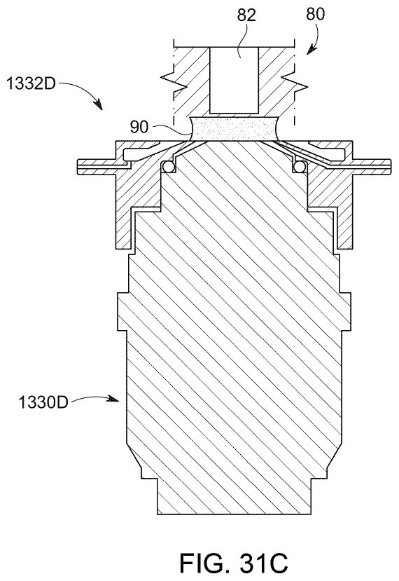

FIG. 27 is a diagram illustrating an objective coupling according to an embodiment; FIG. 28A is a perspective view illustrating a liquid immersion objective according to a first embodiment; FIG. 28B is a top view illustrating the liquid immersion objective according to the first embodiment; FIG. 28C is a first cross-sectional view, taken along line A-A in FIG. 28B, illustrating the liquid immersion objective according to the first embodiment in a state in which a liquid bulb is provided; FIG. 28D is a second cross-sectional view, taken along line A-A in FIG. 28B, illustrating the liquid immersion objective according to the first embodiment, over which a microplate is provided; FIG. 29A is a top view illustrating a liquid immersion objective according to a second embodiment; FIG. 29B is a first cross-sectional view, taken along line B-B in FIG. 29A, illustrating the liquid immersion objective according to the second embodiment, in a state in which a liquid bulb is provided; FIG. 29C is a second cross-sectional view, taken along line B-B in FIG. 29A, illustrating the liquid immersion objective according to the second embodiment, over which a microplate is provided; FIG. 30A is a top view illustrating a liquid immersion objective according to a third embodiment; FIG. 30B is a first cross-sectional view, taken along line C-C in FIG. 30A, illustrating the liquid immersion objective according to the third embodiment, in a state in which a liquid bulb is provided; FIG. 30C is a second cross-sectional view, taken along line C-C in FIG. 30A, illustrating the liquid immersion objective according to the third embodiment, over which a microplate is provided; FIG. 31A is a top view illustrating a liquid immersion objective according to a fourth embodiment; FIG. 31B is a first cross-sectional view, taken along line D-D in FIG. 31A, illustrating the liquid immersion objective according to the fourth embodiment, in a state in which a liquid bulb is provided; and FIG. 31C is a second cross-sectional view, taken along line D-D in FIG. 31A, illustrating the liquid immersion objective according to the fourth embodiment, over which a microplate is provided.

In the below description of FIGS. 28A-31C, the same or similar features are given the same or similar reference characters. For purposes of clarity, redundant descriptions of same or similar features may be omitted.

With reference to FIGS. 28A-28D, a top surface 10A of a sleeve 1332A may be flush with a top surface 11A of a lens of an objective 1330A, and the sleeve 1332A may be configured to clamp to the objective 1330A.

The sleeve 1332A may include, for example, an upper portion 50A, a middle portion 60A, and a lower portion 70A. According to embodiments, the upper portion 50A, middle portion 60A, and the lower portion 70A may be separately or integrally provided with each other so as to constitute a single body or a plurality of bodies. According to embodiments, two from among the upper portion 50A, middle portion 60A, and the lower portion 70A may be integrally provided so as to constitute a single body, while the other from among the upper portion 50A, middle portion 60A, and the lower portion 70A may be separately provided as a separate body that is configured to attach to the other two. According to embodiments, the upper portion 50A, the middle portion 60A, and/or the lower portion 70A may be subdivided into separate bodies, and/or additional bodies may be provided. According to embodiments, any number of the upper portion 50A, the middle portion 60A, and the lower portion 70A may be formed of aluminum.

According to embodiments, any number of the upper portion 50A, the middle portion 60A, and the lower portion 70A may be formed to substantially exhibit rotational symmetry around a center axis of the objective 1330A. The center axis may be, for example, an optical axis of the objective 1330A.

The middle portion 60A may be provided above the lower portion 70A. The middle portion 60A may include an inlet port 62 and an outlet port 63. Fluid may be pumped into the sleeve 1332A via the inlet port 62, and pumped out of the sleeve 1332A via the outlet port 63, by a fluid pump system (e.g. refer to FIG. 26). The inlet port 62 and the outlet port 63 may be provided separately from each other, on opposite sides of the sleeve 1332A. However, the position of the inlet port 62 and the outlet port 63 is not limited to such configuration, and may be variously modified. According to embodiments, the inlet port 62 and the outlet port 63 may be constituted by a single port.

The middle portion 60A may further include a tapered portion 64A that follows a contour of the objective 1330A. For example, the tapered portion 64A may extend upwards and radially inward from an outer portion of the middle portion 60A. The tapered portion 64A may be formed to substantially exhibit rotational symmetry around the center axis of the objective 1330A. According to embodiments, the tapered portion 64A may have shapes other than a taper, so long as the shape follows a contour of the objective 1330A. The shape (e.g. inverted “V” shape that follows a contour of the objective 1330A) of the tapered portion 64A enables a liquid droplet 90 to have a desired shape on the objective 1330A for liquid immersion. According to embodiments, the tapered portion 64A may alternatively be referred to as a protruding portion.

According to embodiments, the inlet port 62 may include a passageway that extends through the tapered portion 64A, to an internal side of the tapered portion 64A, such as to be configured to supply the liquid for the liquid droplet 90 into a space between the objective 1330A and the tapered portion 64A.

The upper portion 50A may include a body. For example, the body may include a side wall 52A that extend upwards from the middle portion 60A, and a top wall 53A that extends radially inwards from the side wall 52A. The side wall 52A and the top wall 53A may substantially extend at 90 degrees from each other. However, an angle is not limited thereto, and may be variously modified according to embodiments. The body, including the side wall 52A and the top wall 53A, may be formed to substantially exhibit rotational symmetry around the center axis of the objective 1330A.

A groove 84 may be formed by and between the upper portion 50A and the middle portion 60A. For example, the groove 84 may be defined by an inner surface of the top wall 52, an inner surface of the side wall 53, and an outer surface of the tapered portion 64A. According to embodiments, the groove 84 may be formed to substantially exhibit rotational symmetry around the center axis of the objective 1330A. The groove 84 may be configured to receive and contain excess amounts of the liquid. According to embodiments, the groove 84 may communicate with the outlet port 63, such that excess amounts of the liquid in the groove 84 exit the sleeve 1332A via a passageway of the outlet port 63 that communicates with the groove 84.

With reference to FIGS. 28C-28D, at least an upper surface of the top wall 53A may constitute the top surface 10A of the sleeve 1332A that is flush with the top surface 11A of the lens of the objective 1330A. According to embodiments, a top surface of the tapered portion 64 may also be flush with the top surface 11A of the lens of the objective 1330A.

According to embodiments, one or more o-rings 32 may be provided between the sleeve 1332A and the objective 1330A. For example, an o-ring 32 may be provided between the middle portion 60A and the objective 1330A. The o-ring 32 may be configured to seal a bottom-side of the space in which liquid is received between the objective 1330A and the tapered portion 64A.

With reference to FIG. 28D, a microplate 80, that holds a sample in at least one well 82, may be provided directly above the sleeve 1332A and the objective 1330A. The liquid droplet 90 on the lens of the objective may come into contact with a bottom surface of the microplate 80, at a position directly below the well 82. The microplate 80 may correspond to, for example, microplate 300 described in the present disclosure, or other microplates.

With reference to FIGS. 29A-29C, a top surface 10B of a sleeve 1332B may be above a top surface 11B of a lens of an objective 1330B, and the sleeve 1332B may be configured to clamp to the objective 1330B.

The sleeve 1332B may include, for example, an upper portion 50B, a middle portion 60B, and a lower portion 70B.

The middle portion 60B may include a tapered portion 64B, and the upper portion 50B may include a body that includes a side wall 52B and a top wall 53B. At least an upper surface of the top wall 53B may constitute the top surface 10B of the sleeve 1332B that is above the top surface 11B of the lens of the objective 1330B. According to embodiments, a top surface of the tapered portion 64B may also be above the top surface 11B of the lens of the objective 1330B, and flush with the top surface of the top wall 53B.

With reference to FIGS. 30A-30C, a top surface 10C of a sleeve 1332C may be below a top surface 11C of a lens of an objective 1330C, and the sleeve 1332C may be configured to clamp to the objective 1330C.

The sleeve 1332C may include, for example, an upper portion 50C, a middle portion 60C, and a lower portion 70C.

The middle portion 60C may include a tapered portion 64C, and the upper portion 50C may include a body that includes a side wall 52C and a top wall 53C. At least an upper surface of the top wall 53C may constitute the top surface 10C of the sleeve 1332C that is below the top surface 11C of the lens of the objective 1330C. According to embodiments, a top surface of the tapered portion 64C may also be below the top surface 11C of the lens of the objective 1330C, and flush with the top surface of the top wall 53C.

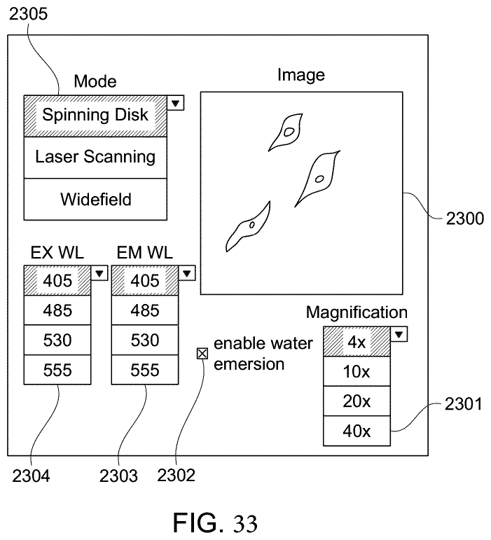

With reference to FIGS. 33A-33C, a top surface 10D of a sleeve 1332D may be flush with a top surface 11D of a lens of an objective 1330D, and the sleeve 1332D may be configured to screw onto the objective 1330D.

According to an embodiment, an internal surface of the sleeve 1332D and an external surface of the objective 1330D may include screw threads that correspond and engage with each other such that the sleeve 1332D and the objective 1330D can be attached to and detached from each by a rotating motion of at least one of the sleeve 1332D and the objective 1330D.

The sleeve 1332D may include, for example, a first portion 60D and a second portion 50D.

The first portion 60D may include a tapered portion 64D, and the second portion 50D may include a body that includes a side wall 52C and a top wall 53C. At least an upper surface of the top wall 53D may constitute the top surface 10D of the sleeve 1332D that is flush with the top surface 11D of the lens of the objective 1330D. According to embodiments, a top surface of the tapered portion 64D may also be flush with the top surface 11D of the lens of the objective 1330D.

According to embodiments, an internal surface of the first portion 60D and may include the screw threads.

According to embodiments, the top surface 10D of the sleeve 1332D may be above or below the top surface 11D of the lens of the objective 1330D. For example, the top surface of the top wall 53D may be above or below the top surface 11D of the lens of the objective 1330D, and the top surface of the tapered portion 64D may be flush with the top surface of the top wall 53D.

According to embodiments of the present disclosure, various embodiments of confocal microscopy may be alternatively or additionally provided. For example, a laser point scanning confocal system may be provided. Laser point scanning confocal microscopy may include focusing a single point of laser light through a small aperture (pinhole) and scanning sequentially across the sample point by point in a zig-zag pattern. The sample fluoresces, and the light is sent back through the optical system. The light then may be read point by point by a detector, which may be a Photo Multiplier Tube (PMT) but could also be detected using other light measurement sensors. The signal from the sensor may be recorded point by point, and each point may constitute a single pixel in an image. There are advantages and disadvantages to a laser point scanning system over a spinning disk confocal. Laser point scanning systems have typically been slower than spinning disk confocals and thus, in many cases, were not appropriate for high throughput applications or live cell images. On the other hand, laser point scanning confocal systems penetrate deeper in the sample and provide better axial and lateral resolution. Recently, there have been improvements made to laser point scanning systems to increase speed and thus are starting to rival spinning disk speeds while still providing increased depth penetrations. The speed of the laser point scanning confocal system is limited by the scanning speed of the motors that drive a scanning mirror of the system.

According to embodiments, confocal subsystems of the present disclosure may comprise both a laser point scanning confocal and a spinning disk confocal. The spinning disk confocal system may be used for live sample imaging and high throughput application, while the laser point scanning confocal system may be used to penetrate deeper into a sample with increased resolution. Like how one could use wide field imaging or other measurement modalities to provide a “hit”, embodiments of the present disclosure may implement spinning disk confocal to quickly scan through a 3D sample and locate some point of interest. The laser point scanning system may then be used to take a more detailed image of the area of interest. Both laser point scanning confocal systems and spinning disk systems are available on the market as two separate devices. However, there are several problems with using two separate devices in such a manner. For one, the cost of both spinning disk and laser confocal microscopes would make putting a workflow as described above impractical. Additionally, there is the technical problem of relocating to a region of interest on an alternate microscope. With both a laser point scanning confocal system and a spinning disk system implemented in a same device, a “hit” could be found, and then the optical system could switch and scan the region of interest without moving the stage. Finally, there is also an issue of studying live cells, whereby the sample changes over time. Moving a sample to a different device takes too long relative to the speed of the changing biology. When moving the sample to another device, the “hit” region of interest may have changed and may no longer be relevant.

Another advantage to having both a laser point scanning confocal and a spinning disk confocal in a same device is that one can leverage the laser point scanning confocal system, not for imaging, but for targeting a specific area of the sample to photobleach it. The laser point scanning confocal system and specific control over an X-Y scanning mirror, provided therein, allows for targeting of a very small and specific area of the sample with the laser. This may be one spot or a block defined in a zig-zag scanning. Then, once the photobleaching has occurred, the device may be quickly switched to the spinning disk confocal to monitor the Fluorescence Recovery after PhotoBleaching (FRAP). Some specific applications include: (a) analysis of molecule diffusion within the cell (e.g. studying F-Actin diffusion in primary dendritic cells after a region of interest has been photobleached); (b) quantifying fluidity of bio membranes (e.g. membrane fluidity in C. elegans); and (c) analysis of protein binding (e.g. monitoring dynamic binding of chromatin proteins in vivo).

The pinpoint accuracy of laser point scanning confocal systems combined with the speed of imaging of a spinning disk system, according to embodiments of the present disclosure, solves an unmet market need in FRAP assays.

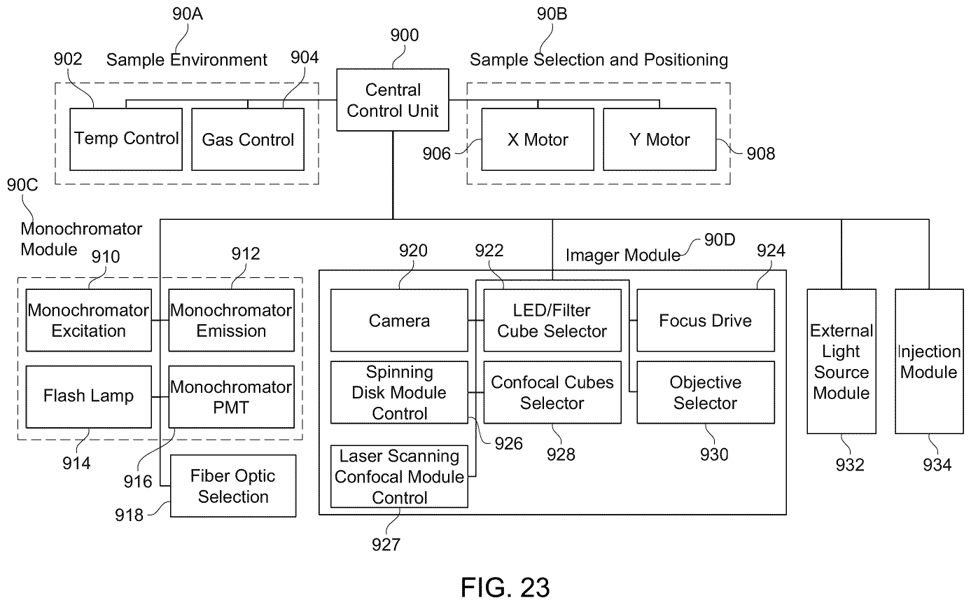

FIG. 23 is a functional block diagram that illustrates the control of modalities of devices according to embodiments.

The operation of modalities may be controlled by a central control unit (e.g., processor, CPU, microprocessor, etc.). According to embodiments, the central control unit may also be referred to as a controller (e.g. controller 1000).

The central control unit 900 may be connected to communicate with and control elements of embodiments of the present disclosure. For example, the central control unit 900 may be connected to communicate with and control elements of the sample environment 90A, elements of sample selection and positioning 90B, elements of the monochromator module 90C, elements of the imager module 90D, an external light source module 932, and an injection module 934.

Elements of sample environment 90A under control may provide temperature control (902) and gas control (904) as described above.

Sample selection and positioning 90B may be controlled through the use of motors for positioning samples in any X and Y directions (906 and 908).

Elements of the monochromator module 90C under control may include monochromator excitation (910), monochromator emission (912), monochromator PMT (916), fiber optics selection (918), and light sources such as a flash lamp 914.

Elements of the imager module 90D under control may include an objective selector 930, an image capturing device such as camera 920, a focus drive 924 for objectives, LED and filter cube selector 922 for wide field imaging, confocal cubes selector 928, and spinning disk module and control (926) (e.g. selection and focusing), and laser scanning confocal module control (927).

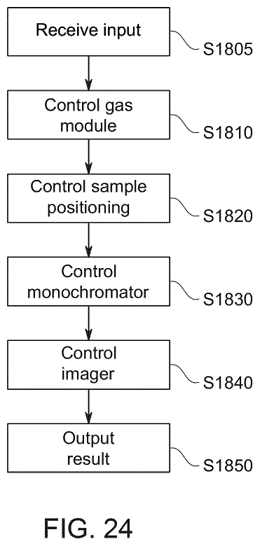

FIG. 24 is a flowchart of control method of a multi-detection system according to an example embodiment.

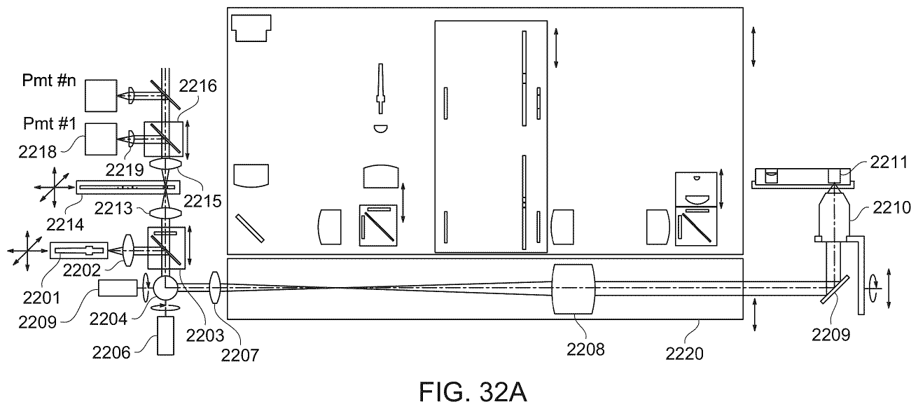

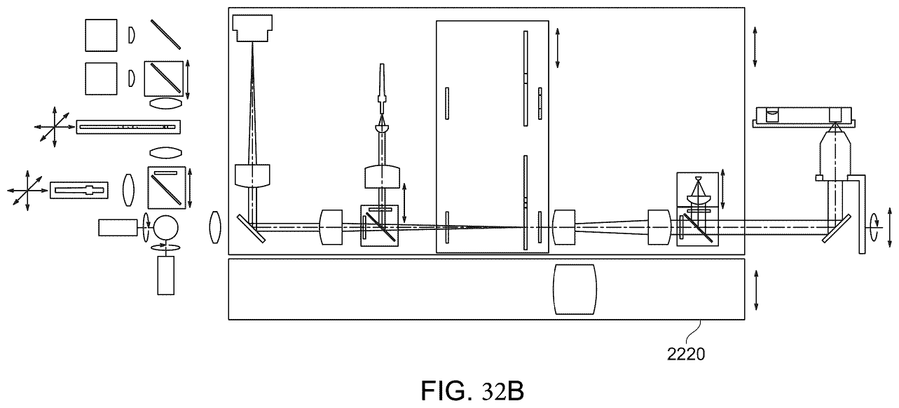

Control of the device may be coordinated through use of the controller, as discussed above with respect to, for example, FIG. 23 and/or FIGS. 32A-32B. Input to the device (step S1805) may be accomplished through a local user interface of the device, such as a touch pad or graphical display, or through communication with the device over a wired or wireless connection, such as over a network.

In the case of input to the device, input may be performed through the use of a user interface or graphical user interface displayed on a computer or other terminal that executes a control application.

The input may be user input, such as setting and parameters for executing control of the device.

In response to receiving input, control of the device may be effectuated through the various elements of the device as, for example, discussed above regarding FIG. 23 and/or FIGS. 32A-32B. For example, in response to receiving user input, the device may be controlled to execute a gas control procedure of the gas module (step S1810), a sample positioning control procedure to control positioning of samples (step S1820), a monochromator control procedure to control operations of the monochromator (step S1830), an imager control procedure to control the imager (step S1840), and to output a result of the controlling of the elements of the device (step S1850).

Although control is presented as illustrated in FIG. 24, elements may be individually controlled in any sequence, and control of all elements is not required. Accordingly, the multiple modalities of the device may be controlled in a single assay.

The control method illustrated in FIG. 24, and other functions described herein that may be performed by a controller, may be implemented through execution of a processing unit (e.g., CPU) controlling elements of the device by executing one or more control programs. The programs may be stored in a memory (i.e., RAM, ROM, flash, etc.), or other computer-readable medium (i.e., CD-ROM, disk, etc.). The program may be executed locally by the device, or by a control device, such as a computer that transmits commands to be executed by the device.

With reference to FIG. 33, embodiments of the present disclosure may include a display, and the controller may be further configured to cause the display to display a user interface. FIG. 33 illustrates an example of the user interface in a case where the device has a combination of various optical modes. Element 2300 is an image of the sample. Element 2301 is a drop-down menu for selecting a magnification. Element 2302 is a selection box to enable/disable water immersion. If selected, and the objective is configured for water immersion, the controller may cause water to be automatically pumped to the objective and may automatically remove water when imaging is completed or the check box of element 2302 is deselected. Element 2303 is a drop-down list for the EM wavelength selection. FIG. 33 illustrates that a selection between 4 different EM wavelengths may be provided, but any number of EM wavelength selections may be provided. Element 2304 is a drop-down list for the EX wavelength selection. FIG. 33 illustrates that a selection between 4 different EX wavelengths may be provided, but any number of EX wavelength selections may be provided. Element 2305 is a drop-down menu allowing one to select between the various modes of the instruction. FIG. 33 illustrates selection between modalities, where the system includes spinning disk, laser scanning, and wide field modalities. According to embodiments, the modalities listed in element 2305 may depend on the modalities present in the system. The system may, for example, have any combination of the above-mentioned modalities (and/or additional modalities), or only a single modality. In a case where only a single modality is provided, element 2305 may not be provided. According to embodiments, elements 2301, 2302, 2303, 2304, and 2305 are not limited to being drop-down menus and selection boxes, and may indicate options for selection in any manner known to a person of ordinary skill in the art.

According to embodiments, the interface may include display elements that enable a user to select a plurality of modalities to automatically be performed in a sequence. For example, based on one or more inputs from a user with respect to the interface, the controller may be configured to control the sequence to automatically be performed. The sequence may include any order of modality operations, including the orders of modality operations described in the present disclosure. For example, an operation using the spinning disk or wide field imaging system and then an operation using the laser point scanning confocal system may be performed.

Components and features of the optical module are further described in U.S. Pat. No. 7,782,454 titled “Universal multidetection system for microplates,” incorporated herein by reference in its entirety for all purposes.

For instance, according to one aspect, there is provided an optical module which includes a first optical device that transmits a narrow waveband of light and includes a first filter and a first monochromator that provide different paths for the narrow waveband of the light. The optical module may also include a light source that generates the light as broadband excitation light, wherein the first optical device transmits a narrow waveband of the broadband excitation light and blocks other wavebands of the broadband excitation light through the first filter or the first monochromator; a second optical device that directs the narrow waveband of the broadband excitation light onto the sample and receives emission light from the sample; a third optical device that transmits a narrow waveband of the emission light; and a detector that converts the narrow waveband of the emission light into an electrical signal; wherein the third optical device includes a second filter and a second monochromator that provide alternative paths for the narrow waveband of the emission light.

### Multimode Measurement in the Cloud-Based System

In certain aspects, the devices and methods disclosed herein may be used to perform a complete analysis of a cell sample by qualitatively and quantitatively measuring different parameters of the same cell sample. The methods may include measuring the cellular metabolic function, bioenergetic poise, bioenergetic capacity, and bioenergetic work of the cell e.g., measuring O₂, CO₂, pH with the sensing subsystem. The methods may include visually observing a property of the sample, e.g., cell growth, cell health, cellular microenvironment, morphological changes, ultrastructural changes, marker expression, of the cell using the optical module, for example, by an automated cell imaging reader such as Cytation™ 5 or Cytation™ 7, as disclosed in U.S. Pat. No. 10,072,982, incorporated herein by reference in its entirety for all purposes. The methods may include detecting attachment, ultrastructural changes, growth, morphological changes, cell-cell interactions by impedance measurements using the sensing system or devices as described in U.S. Pat. Nos. 10,551,371; 10,539,523; 10,215,748; 10,067,121; 9,709,548; 9,612,234; 8,263,375; 8,041,515; 8,026,080; 7,470,533; 7,468,255, 7,560,269; 7,732,127; or U.S. Patent Application Publication No. 2018/0246019 and WO2021202264A1, each of which is hereby incorporated by reference in its entirety for all purposes.

Cell-substrate impedance monitoring generally permits continuous real time monitoring of cells. Cell-substrate impedance monitoring may be used to assess the interaction between cells and electrodes, where changes in cell attachment, growth, morphology and motility over electrodes results in a detectable change. To this end, cell-substrate impedance monitoring is a useful tool that may be employed to assess cell proliferation and cytolysis. Coupled with real time cell analysis by impedance, the brightfield and fluorescence-detection optical module of xCELLigence eSight is an exemplary optical module that provides live cell imaging during impedance measurements, as described in U.S. Patent Application Publication No. 2021/0301245, incorporated herein by reference in its entirety for all purposes.

It will be appreciated that serial analysis may be performed by further devices that take different measurements of the same sample, e.g., mass spectrometry, spectroscopy, phosphorescence lifetime imaging microscopy (PLIM) and/or fluorescence lifetime imaging microscopy (FLIM), including 2-photon excited imaging, and others.

### Applications

The systems, consumables, and methods described herein can have various applications. Exemplary applications are described as follows.

### Cell Migration Adhesion

In an aspect, the system, consumables, and methods described herein are used for analyzing cell migration and/or adhesion.

Metastatic invasion of cancer cells represents a clinical challenge in cancer therapeutics. Cellular migration is typically a bioenergetic expensive process and being able to obtain simultaneous quantitative measurements that correlate cell migration/invasion, and bioenergetic metabolic activity can open a new window for therapeutic development. The combination of impedance measurements as a surrogate measurement of cell migration with OCR/PER measurements will allow testing modulators of cell metabolism that induce inhibition of cell migration without affecting cell viability. These measurements can be further combined with fluorescent biosensors imaging of sensors for signaling cascades.

Similar procedures can be applied to study cell adhesion by coating plates with different extracellular matrix (ECM) and combining changes in impedances representative of cell adhesion with cellular metabolic changes.

### Stem Cell Differentiation

In an aspect, the system, consumables, and methods described herein are used for analyzing stem cell differentiation.

Stem cell differentiation is a long process that can last from weeks to months that involves changes in cellular phenotypes from a proliferating/undifferentiated state to a specialized state. Stem cell differentiation also involves significant changes in cell morphology and metabolic activity that require to be controlled in order to produce specialized cells with the correct phenotype to be used as disease models for therapeutic development or directly as therapeutic in cell and gene therapies for a variety of diseases like tissue regeneration.

Simultaneous monitoring of culture environmental conditions, changes in cell morphology thorough impedance measurement, and metabolic activity will allow optimization of cell model development to determine critical cellular attributes for stem cell-derived therapies.

### EXAMPLES

The embodiments may be further understood with reference to the following examples. The examples are intended to serve as an illustration and are not limiting.

### Example 1: Exemplary Protocol

Cells are seeded in the assay wells of a multi-well microplate at a confluency of 50-90%. Suspension cells are attached to the well bottom to maximize sensitivity. A 96-well sample carrier constructed and arranged to mate with the device is used for this exemplary protocol. However, the multi-well sample carrier may have any number of wells corresponding with the device, e.g., 1, 6, 8, 12, 24, 36, 48, 64, 72, 96, 192, 384 or others. Temperature of the cell suspensions is controlled.

The device lowers the sensor probes into the assay wells. The sensors are positioned 200 microns above the well bottoms, forming transient microchambers, also referred to as “measurement chambers” herein, of approximately 3 microliters. As the oxygen and pH levels change, the changes are measured by the sensors. Measurements are typically made for a predetermined amount of time between 1 minute and 5 minutes, for example, 3 minutes. Rate changes are calculated automatically by a computing device. Upon completion of this measurement period the sensor probes are raised, allowing the extracellular medium to come back to baseline conditions.

The sensor cartridge also contains ports (4 per well) to enable injection of modulators (target analytes) into the cell wells during the assay. When specified by the device protocol, for example, as provided by via graphical user interface, the controller instructs the dispensing system to inject a test compound into the assay wells and perform a gentle mixing step to ensure distribution of the compound throughout the assay medium. All wells are processed in this manner simultaneously. Subsequent measurement cycles, any additional injections specified by the protocol, and rate calculations are performed automatically.

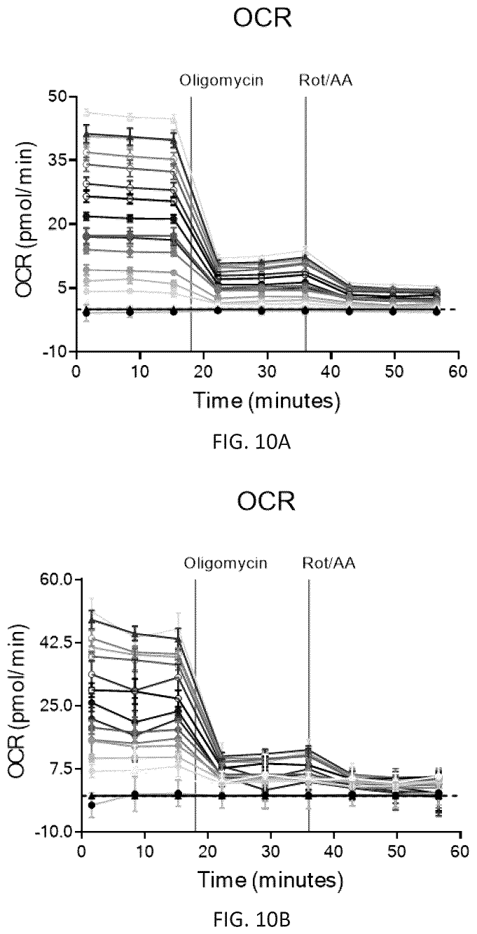

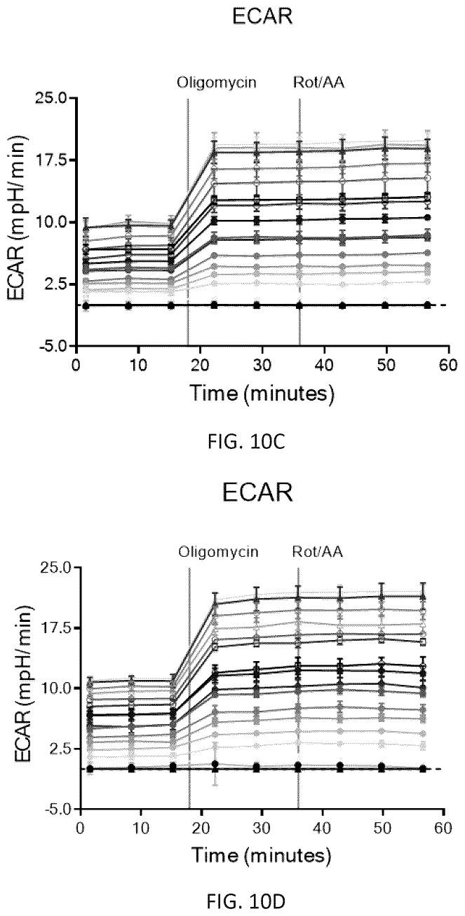

The exemplary protocol was executed with THP-1 cells (human monocytes derived from a patient with acute monocytic leukemia) for test purposes. OCR and ECAR data were measured and reported using a system as described herein. The test was also executed in a comparative system having conventional temperature control, signal processing, and motion actuator motor components. The results are presented in the graphs of FIGS. 10A-10D.

The graph of FIG. 10A shows OCR measurement values over assay time as measured with a system as disclosed herein. The graph of FIG. 10B shows OCR measurement values over assay time as measured with the comparative system. The graph of FIG. 10C shows ECAR measurement values over assay time as measured with a system as disclosed herein. The graph of FIG. 10D shows ECAR measurement values over assay time as measured with the comparative system.

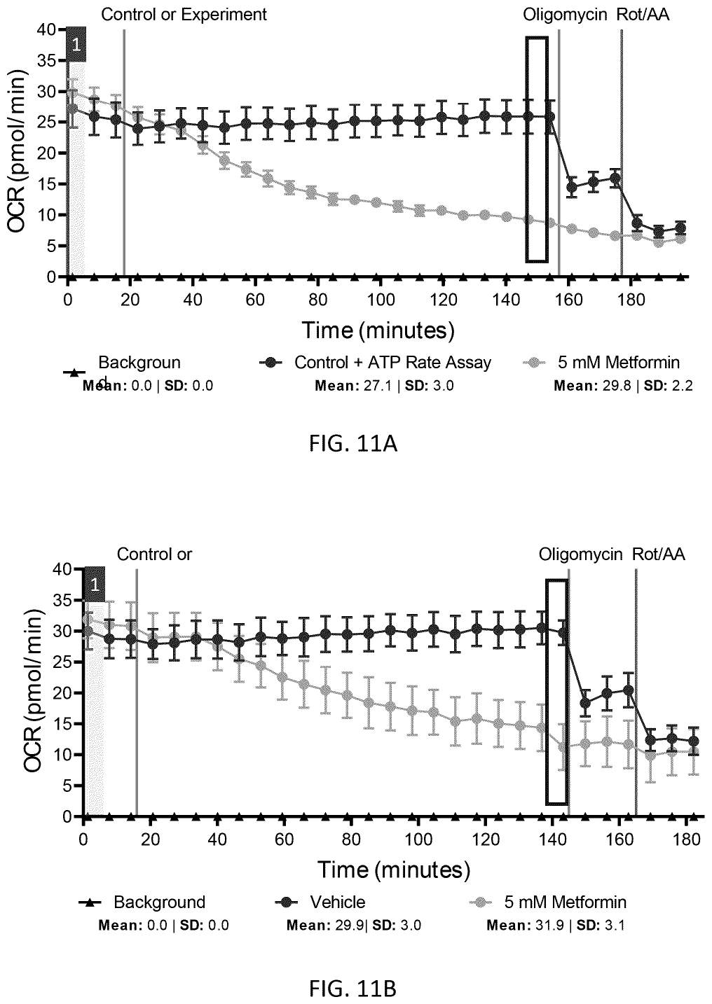

The exemplary protocol was also executed with A549 cells (human lung cancer cells) and administration of 5 mM Metformin as a target agent. OCR data was measured using a system as described herein and the comparative system. The results are presented in the graphs of FIGS. 11A-11B.

The graph of FIG. 11A shows OCR measurement values over assay time as measured with a system as disclosed herein. The graph of FIG. 11B shows OCR measurement values over assay time as measured with the comparative system.

Accordingly, the system having temperature control elements, a signal processing module, and a motion actuator assembly motor as described herein showed a significant improvement in lower limit OCR detection precision and readability over the comparative system while simultaneously detecting ECAR. While not wishing to be bound by theory, it is believed that the improvement in uniformity of temperature across samples within a controlled temperature zone may improve both the performance of the system in sensing target analytes as well as the performance of the biology of the cells.

### Example 2: Evaporation Test Protocol with Water Samples

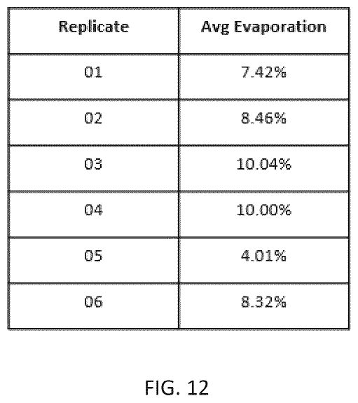

Six assays were run in the system disclosed herein using known volumes of water in the multi-well sample carrier for 6 hours with a modified protocol configured to take 4 measurements per hour. Evaporation from the water samples was measured using a plate reader. A standard curve was created by measuring the absorbance of known volumes of water. Immediately following each assay, absorbance measurements of the test plates were collected. The standard curve was used to calculate the volume of water in each well of the test plates to evaluate the amount of water volume lost to evaporation during the 6-hour assay. The results were calculated as a percentage of total volume lost. Average evaporation for each assay is presented in the table of FIG. 12.

As shown in the table of FIG. 12, the greatest average percentage of water volume lost to evaporation during a 6-hour assay was 10.04%. Accordingly, the volume of sample fluid lost to evaporation was low.

While not wishing to be bound by theory, it is believed that the improvement in uniformity of temperature across samples within a controlled temperature zone may reduce evaporation of sample fluid, improving both the performance of the system in sensing target analytes as well as the performance of the biology of the cells.

### Example 3: Extended Duration Operation in Multi-Modal Analysis

When the device is configured for extended duration analysis of cell cultures across one or more modes of analysis, various environmental and sampling control elements in the device are activated to maintain consistent growth conditions over the extend duration and measurement conditions in the sensors used to monitor the growth conditions.

In various embodiments, the extended duration can be set by an operator to last for at least one hour, two hours, three hours, four hours, five hours, six hours, etc., up to twenty-four hours, forty-eight hours, seventy-two hours, etc., to analyze the cell cultures and other samples for a longer period of time than offered by previous analytical devices without requiring human intervention to maintain growth conditions of that period of time.

The device includes a sensing system and a stage included in a cavity of the device. The stage is configured to receive a sample carrier with a plurality of wells defined in a first surface thereof. In some embodiments, the stage is connected to a motion actuator assembly that moves the stage on one or more of an x-axis, a z-axis, and a y-axis relative to a sensing system. Additionally or alternatively, the motion actuator assembly can move the sensing system relative to the stage on one or more of the x-axis, the z-axis, and the y-axis, which may include rotation in a yaw, a pitch, or a roll orientation. In a multimodal analysis device, the motion actuator assembly can also move the stage and/or the sample carrier or substrate on which the samples are held between various devices or sensors for sequential analysis or access by those devices or sensors.

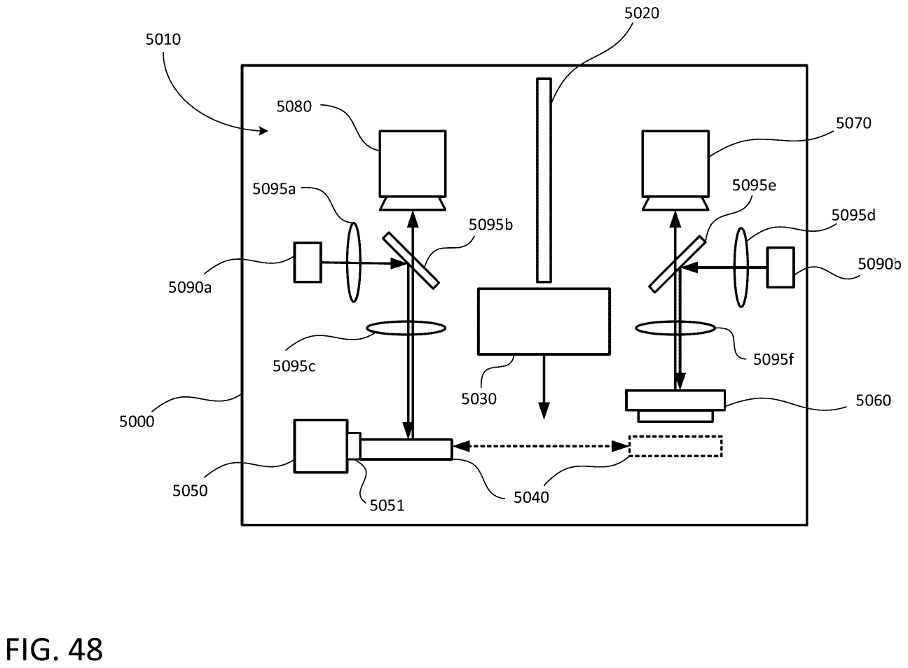

For example, the motion actuator assembly can move the samples to a first positon for access by a flux detector, a second position for access by an imaging module, a third position for access by an electrical measurement module, etc. In various embodiments, a first position is provided for access by an image capture element and a second position is provided for access by an impedance element. In various embodiments, such as is shown in FIG. 48, a first position is provided in the device 5000 for access by an image capture element 5080 and an impedance element 5050 (coupled to the sample carrier 5040 via an electrical interface 5051), and a second position is provided for access by a flux detector 5070. In various embodiments, a fluid handler 5030 may be accessed at a third position, or at one or both of the first position and the second position.

As shown in FIG. 48, various accessory elements for the image capture element 5080 and the flux detector 5070 are provided in alignment with the first and second positions, respectively. For example, excitation sources 5090a-b, and optical conditioning elements 5095a-f (e.g., mirrors, lenses, filters, light paths, etc.) are provided between the image capture element 5080 and the flux detector 5070 and the sample carrier 5040 (when in the associated position) to place the wells and the respective measurement element in optical communication with one another. Additionally, a flux cartridge 5060 can be preloaded with various chemical compounds, growth media, and other compounds that are injected to or exchanged with the wells in the sample carrier 5040.

In various embodiments, the flux cartridge 5060 is moveable relative to sample carrier 5040 (or vice versa), on an axis that is substantially perpendicular to the axis that the sample carrier 5040 moves between he first position and the second position or a plane that intersects each well of the plurality of wells on the sample carrier 5040. The flux cartridge 5060 comprises a plurality of heads that each addresses a given well in the sample carrier 5040 that includes a surface proximal to a surface of the sample carrier 5040 in which the wells are defined to define a closed reaction chamber when placed in contract with the sample carrier 5040. The closed reaction chambers are configured to maintain a seal that limits a volume of liquid included in each sample and/or that reduces a rate of volume of evaporation from the reaction chamber over a duration.

The sensing system includes an array of sensor units that are configured to generate electrical signals proportional to an observed analyte in a sample well. For example, a first sensor in the sensor array may monitor a first analyte in proportion to a gaseous O₂ content in a given well over an extended duration to generate a first signal, while a second sensor in the sensor array may monitor a second analyte in proportion to a pH value in a given well over an extended duration to generate a second signal. The sensor units in the array of sensors units are positioned (via the motion actuator assembly) to correspond with a corresponding well on the sample carrier to analyze the contents thereof for the control and monitoring of the samples held therein.

A liquid handling system is included in the device to dispense various substances into samples within each well of the sample carrier. In various embodiments, the liquid handling system is supplied via a cartridge that is insertable into (and removable from) the device without affecting the atmosphere of the cavity. The cartridge may include tanks for different substances that are supplied to the wells, including, water, water-based solutions (e.g., an aqueous solution of a candidate compound/substance compound or other agent), dyes, cellular growth media, cell cultures, N₂, O₂, CO₂, etc. Components and features of an example as may be used for a cartridge are further described in, e.g., U.S. Pat. No. 9,170,255 titled “Cell analysis device and method,” which is incorporated herein by reference in its entirety for all purposes.

A sampling control element is included in the device to control one or more characteristic measured by the sensing systems for the samples within each well of the sample carrier over the extended duration. The sampling control element controls the characteristics such that the characteristic in for any given sample is within a predefined amount of any other sample within another well of the sample carrier. For example, the sampling control element can include a sample temperature environmental control element, configured to control the temperature of the samples (e.g., within +/−X degrees), a gaseous control element, configured to control the gas content of at least one of O₂, CO₂, and N₂ content of the samples (e.g., within +/−X parts per million (ppm)), and a humidity control element configured to control the humidity of the samples (e.g., within +/−X % relative humidity). In various embodiments, the sample temperature environmental control element is a heater.

In addition to controlling the relative characteristics between different wells in parallel (e.g., a first well vs. a second well at a first time), the sampling control element can longitudinally control the characteristics for a given well over the extended duration (e.g., the first well at a first time and a second time), so that the characteristics monitored in the wells remain within a controlled range of values over the course of the analysis period. The various consumables provided by the fluid handler and/or cartridge allow for the addition of material to replace lost material (e.g., due to evaporation, sublimation, consumption by the sample (e.g., cellular respiration), or dispersion to the environment outside of a well). The material sources (e.g., the cartridge) may be replaced throughout the extended duration to account for consumed material and provide fresh stores of material to supply to the wells when needed to maintain the characteristics in the wells, or supply additional material for analysis (e.g., cellular growth compounds, pharmaceuticals under test, etc.). Accordingly, the described device can maintain consistent growth conditions across a plurality of samples held in a corresponding plurality of wells both in parallel and longitudinally at the same time (e.g., first through nth wells at each of a first through nth times).

At various times during the extended duration analysis period, the device can observe various characteristics of the samples under observation. In various embodiments, the device includes one or both of an image capture element, such as the optical module described herein, and an impedance element, such as the electrical measurement module described herein, which may operate at separate locations within a cavity of the device, at which the motion actuator assembly positions a sample carrier at different times. Each of the various observation modules may be located in various cavities or sub-cavities in the device. For example, as shown in FIG. 48, the imaging capture element 5080 and the flux detector 5070 are both disposed within a cavity 5010 of the device 5000, but are separated by a divider 5020 into different sub-cavities. The divider 5020 may include various vents and atmospheric or environmental controls to provide different temperatures, humilities, or air flow characteristics in different portions of the cavity 5010 at different times.

The image capture element includes one or more cameras and various camera accessory devices (e.g., mirrors, lenses, light sources) to allow for capturing images of samples (or features of the samples) within each well of the sample carrier. These images are captured from an underside of the sample carrier (e.g., opposite to the surface into which the wells are defined) through a transparent or translucent window. When the wells include electrodes (e.g., for electrical stimulation of the samples and/or taking impedance measurements of the samples), the electrodes are positioned to leave gaps of a pre-determined size between one another that define the windows through which imaging occurs. In various embodiments, the image capture element can be configured to captures and processes images from each well of the sample carrier either individually (which an operator can select to image or forgo imaging for specific wells or in a specific order) or in batches of some or all of the wells in parallel.

The impedance element includes an electrode surface configured to measure impedance changes resulting from attachment of samples within each well of the sample carrier, stimulate samples with electrical signals within each well of the sample carrier, or both. In various embodiments, the electrode surface is at a base of the sample carrier (e.g., the side opposite to the side in which the wells are defined), and the electrode surface includes a non-conductive carrier. When positioned to interact with a sample carrier, a plurality of electrode arrays included in the impedance element are positioned in contact with the sample carrier. Each of these electrode arrays comprises at least two electrode structures that positioned on the same plane (e.g., a shard plane) and have substantially the same surface area as one another. The electrode structures interface with (e.g., are in electrical communication with) corresponding members of a plurality of connection pads located on the sample carrier. Accordingly, when in electrical communication with the sample carrier, an impedance meter, impedance analyzer, or impedance measurement circuitry of the impedance element can detect changes in electrical impedance between or among the electrode structures due to changes in the samples. Similarly, a voltage or current source of the impedance element can stimulate the samples with electrical signals when in electrical communication with the sample carrier.

Operations of each of the elements and modules of the device are coordinated by a controller, which may be any type of computing device (e.g., an FPGA array, a microcontroller, a processor and coupled memory, an ASIC, etc.) that is operatively connected to the various elements and modules. The controller is configured to control, for the extended duration, one or more of a temperature, a humidity, and a gas content of each well of the sample carrier via the sampling control element, acquire data corresponding to the first signal and second signal for the respective analyses for at least two points in time spanning the extended duration via the various sensing systems (including an image capture element and an impedance element), and condition the first and second signal. In various embodiments, conditioning the first signal and the second signal includes at least one of: amplification; filtering; time shifting; frequency shifting; and digitizing one or more of the signals at one or more times.

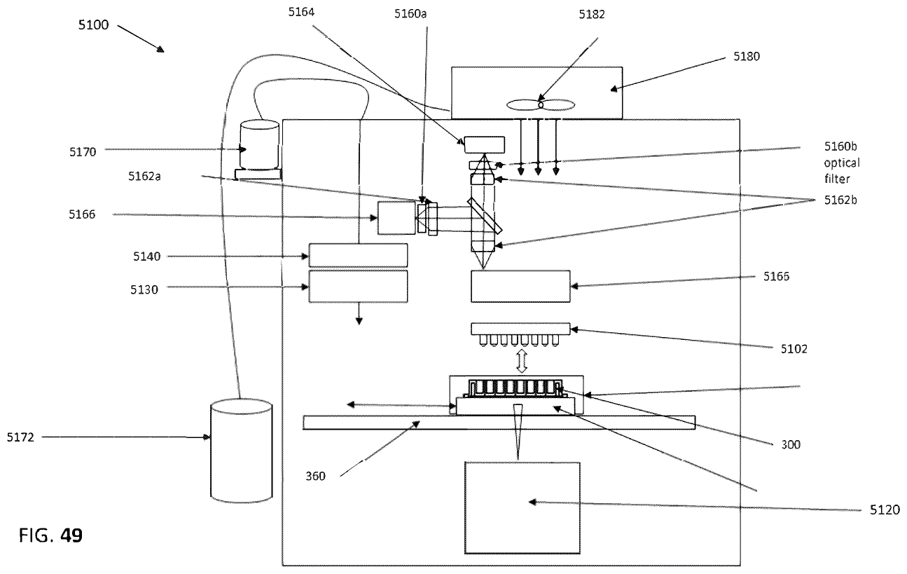

FIG. 49 shows a schematic system diagram of an embodiment of a system 5100 for analyzing live cells, in in particular for measurements of extracellular flux, impedance, and imaging for long-term measurements of cell samples, including simultaneous measurements of one or more combinations of extracellular flux, impedance, and imaging. The system incorporates a sample carrier 300 that is configured to interface with a sensor cartridge 5102. The sample carrier 300, which may also be referred to as a well plate, comprises an array of wells 200 for individually holding cell samples and an impedance and/or stimulator component or array thereof. One or more of the wells comprise an electrode array for acquiring impedance measurements across the well bottom, and a window at the well bottom for transmission of light and imaging through the well bottom, e.g. via an optical subsystem 5120 such as an inverted microscope. Optical subsystem may incorporate any number of optical configurations and/or imaging modalities, e.g., functionalities such as Widefield Florescence Microscopy. Widefield Bright Field Microcopy, or Confocal Fluorescence Microscopy, and any of the imaging system detailed above. An exemplary configuration of windowed sample carrier with impedance and optical measurement capability is described in, e.g., PCT Patent Application No. WO 2021202264 “SYSTEMS AND METHODS FOR ELECTRONICALLY AND OPTICALLY MONITORING BIOLOGICAL SAMPLES”, which is incorporated herein by reference in its entirety for all purposes.

The sample carrier 300 may be positioned on a carriage 310 and heated stage 360 that can move to interact with fluid handling system 5130, which may include a fluid injection manifold 5130 and heater/cooler 5140 for fluid temperature controller (see FIG. 8). In one embodiment, the manifold is configured to grasp the cartridge and move the stage up and down. Substance/media source 5170 is coupled to the manifold 5130 for delivery of fluid to the sample carrier 300.

Optical components, such as optical filters 5160a, 5160b, focusing optics 5162a, 5162b, Excitation source(s) 5166 and detector 5164 are disposed above the sample carrier 300 and cartridge 5102. An optical manifold 5166 Optics (can be fiber optic array with each fiber to an excitation LED or multiplexing one excitation source to many fibers, or an array of glass or plastic slugs and the optic components above can scan.

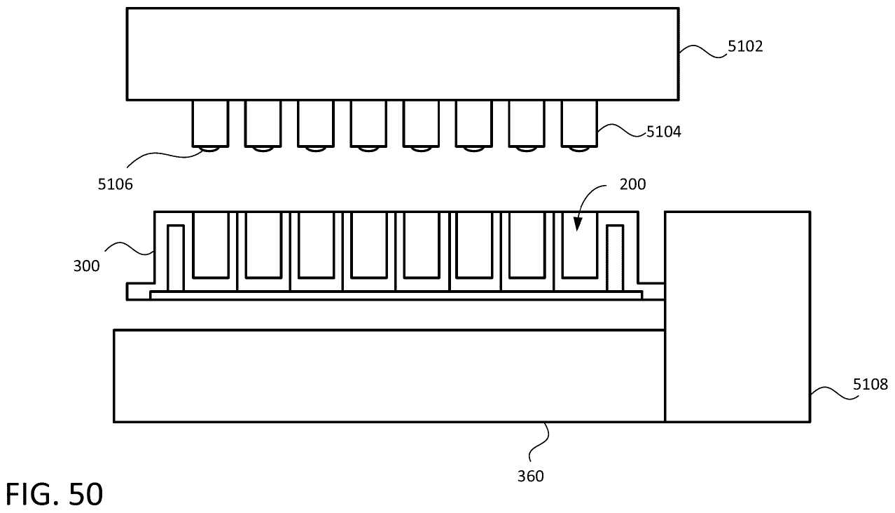

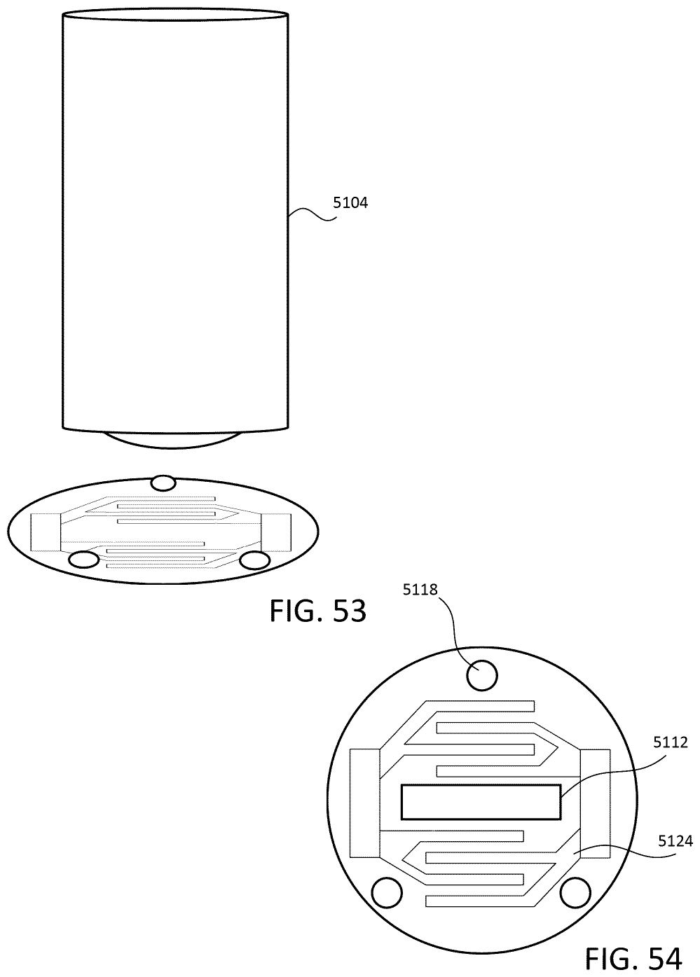

FIG. 50 shows an exploded view of the sample carrier 300 and cartridge 5102, which comprises a plurality of spines 5104 each having an analyte sensor 5106 on its distal tip, wherein the spines are sized and shaped to interface with the wells 200 to form individual microchambers. An electrode interface/impedance reader 5108 is electrically coupled to the sample carrier for receiving and delivering electrical signals from/to the impedance electrodes in the wells 200 (see FIG. 53).

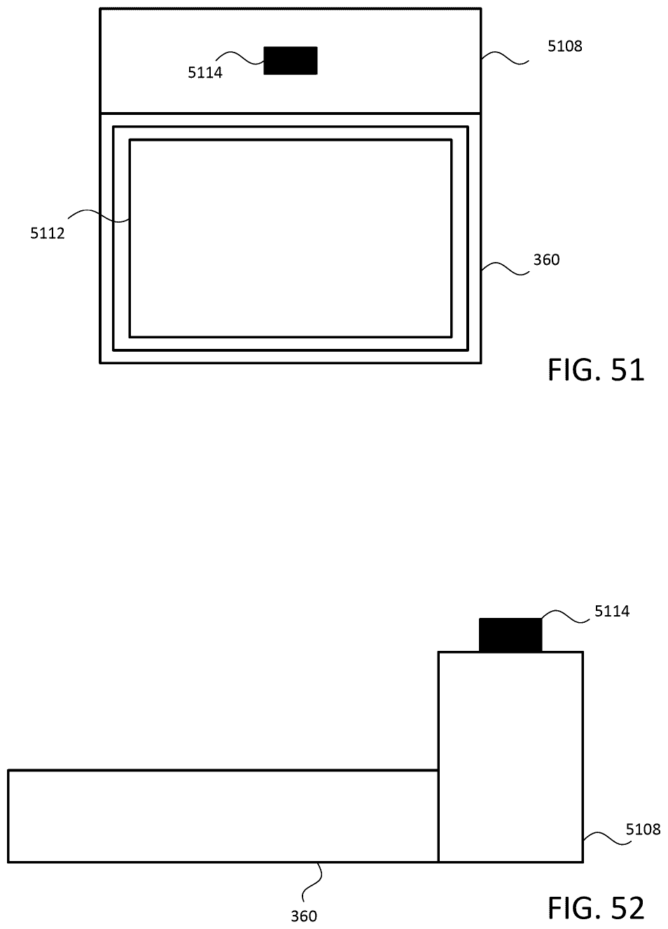

FIG. 49 shows a schematic system diagram of an embodiment of a system 5100 for analyzing live cells FIG. 50 shows an exploded view of the sample carrier 300 and cartridge 5102 FIG. 51 and FIG. 52 show a plan side views, respectively of the stage 360 without sample carrier 300. Stage 360 may comprise a heater/cooler, and may comprise a peripheral feature 5112 to hold and align sample carrier 300. One or more environment characteristic sensors 5114 (e.g. temperature, gas, humidity, etc.) may be included on the stage.

FIG. 53 shows a top and perspective view of bottom surface a well 200 of sample carrier 300. The well bottom may comprise a standoff, which may be in the form of bumps 5118, a shelf or other engagement feature that interfaces with the spines 5104 of the sensor cartridge, such that it forms a stop to allow for the spines to rest on the bumps at a specified distance to define a micro chamber. FIG. 54 further shows a window 5112 dispose in between electrode elements 5124 on the surface of the well, the window 5112 allowing for imaging the well bottom.

### Example 4: Direct Identification of Mitochondrial Toxicity Using a Novel Index Derived from Mitochondrial Oxygen Consumption Rates

Mitochondrial toxicity (MitoTox) is a common issue with therapeutic development, contributing to compound/substance candidate attrition and post-market compound/substance withdrawals (Wallace, K. B., 2008. Mitochondrial off targets of drug therapy. Trends Pharmacol. Sci. 29, 361-366). Among the methods used to assess compound/substance-induced mitochondrial toxicity in compound/substance discovery and pre-clinical safety, direct measurement of mitochondrial oxygen consumption using the Agilent Seahorse XF technology has been well documented as a specific and sensitive marker/indicator (Yvonne Will & James Dykens (2014) Mitochondrial toxicity assessment in industry—a decade of technology development and insight, Expert Opinion on Drug Metabolism & Toxicology, 10:8, 1061-1067, DOI: 10.1517/17425255.2014.939628)(Tilmant K.a,*, Gerets H.a, De Ron P.a, Hanon E.a, Bento-Pereira C.a,b,1, Atienzar F. A In vitro screening of cell bioenergetics to assess mitochondrial dysfunction in drug development. a,c Toxicology in Vitro 52 (2018) 374-383).

Thus, disclosed herein is a standardized XF solution that allows for assessment of compounds exhibiting mitochondrial toxicity. As described herein, the XF Pro analyzer has several novel design features that provide enhanced sensitivity, precision, and consistency. Here we exploit these improvements to detect compound/substance-indued mitochondrial dysfunction using for OCR measurements.

The Agilent Seahorse XF Mito Tox Assay workflow includes sequential injections of oligomycin and FCCP, but includes a separate control group that is provided rotenone/antimycin A prior to the assay. Compounds to be assessed for mitochondrial toxicity are provided to the cells at a designated time prior to the assay.

Based on responses in either basal, oligomycin and/or FCCP OCRs of the test compounds compared to appropriate controls, the XF Mito Tox Assay can identify 3 distinct types of mitochondrial toxicity: direct/indirect inhibition of the ETC or other mitochondrial processes, uncoupling of the ETC from OxPhos, and (potential) specific inhibition of the OxPhos machinery (CV, ANT, PiT).

Significant improvements are provided through the extraction of a novel parameter, a Mito Tox Index (MTI), derived from oxygen consumption rates (OCRs) measured by a system as disclosed herein (the Agilent Seahorse XF Analyzer).

This approach of deriving an easily interpretable mitochondrial toxicity metric is surprisingly enabled by the improvements in sensing precision achieved through implementation of the device and methods disclosed herein, providing an easy and robust way to screen and validate toxicity in vitro. The workflow enables the reduction of complex respirometric responses to a Mitochondrial Toxicity Index (MTI) metric, providing two types of MTI scoring the inhibitor effect on the electron transport chain (ETC) and the uncoupler effect on negative and positive scales respectively. The inhibitor MTI is designed to calculate the relative inhibitory effect on the maximal OCR to the effect of the ETC inhibitor control, rotenone/antimycin A mix. In contrast, the uncoupler MTI is to calculate the relative elevation in minimal OCR measured after the oligomycin injection to the FCCP effect in the vehicle control group. Among the compounds showing no significant score in either MTIs, potential ATP synthase inhibitors can be identified by monitoring the basal OCR-specific suppression since ATP synthase inhibitors do not affect the maximal OCR. The capacity to derive a defined metric enables additional functionality such as the convenient generation of dose response relationships or convenient threshold setting for ‘hit’ identification.

### Defining the Mitochondrial Toxicity Index (MTI)

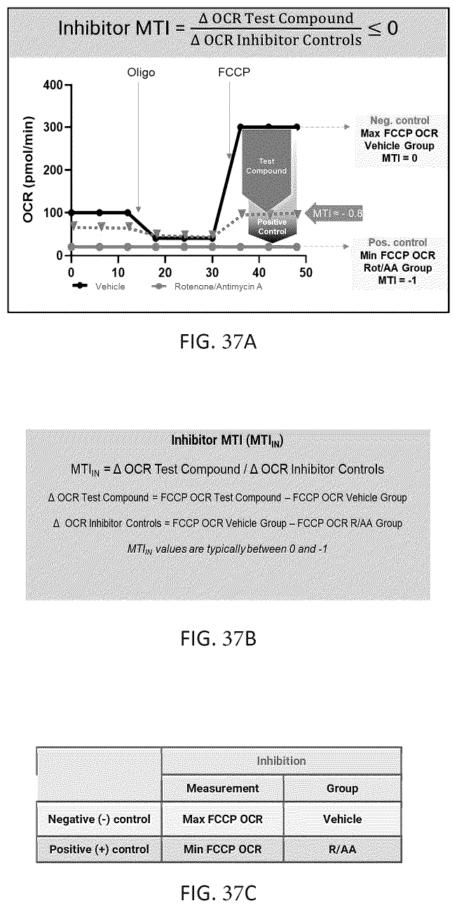

In order to discriminate among the three modes of mitochondrial toxicity described above, as well as to quantitate the magnitude of toxicity, the Mito Tox Index (MTI) value was derived leveraging the increased measurement precision enabled by the device disclosed herein. Mito toxicity due to inhibition, where inhibition is defined and detected as a decrease in FCCP OCR of the test compound compared to maximal FCCP OCR of the vehicle group, results in a negative MTI value (typically between 0 and −1) and is illustrated and described in FIGS. 37A-37C.

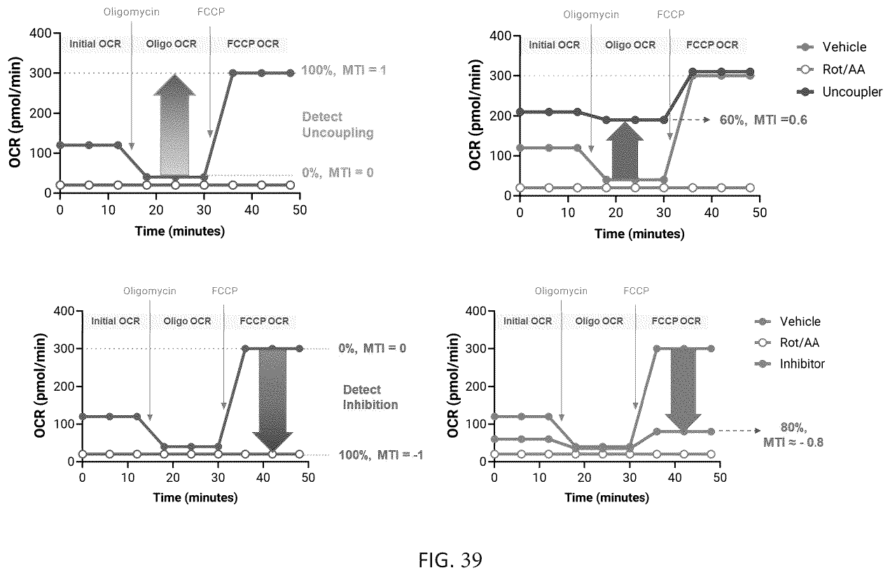

FIG. 37A refers to a scenario where a test compound results in a decrease in FCCP induced OCR, compared to Vehicle (neg) control (MTI=0), then the compound is categorized as an Inhibitor, with a negative MTI value (e.g. MTI=−0.8). Note that Rot/AA OCR serves as a positive (+) control for inhibition (MTI=−1). FIGS. 39B-39C provide a summary of measurements and groups used for inhibition controls.

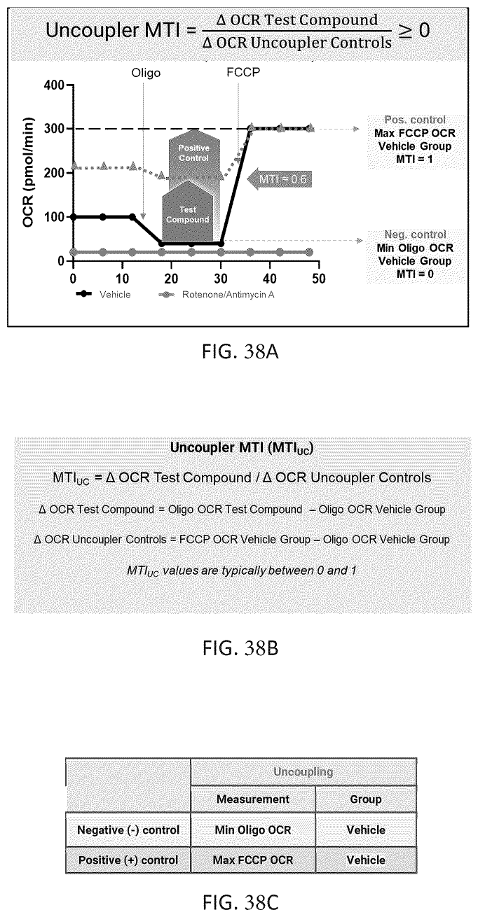

Mito toxicity due to uncoupling, where uncoupling is defined and detected as an increase in Oligo OCR of the test compound compared to minimal Oligo OCR of the vehicle group, results in a positive MTI value (typically between 0 and 1) and is illustrated and described in FIGS. 38A-38C.

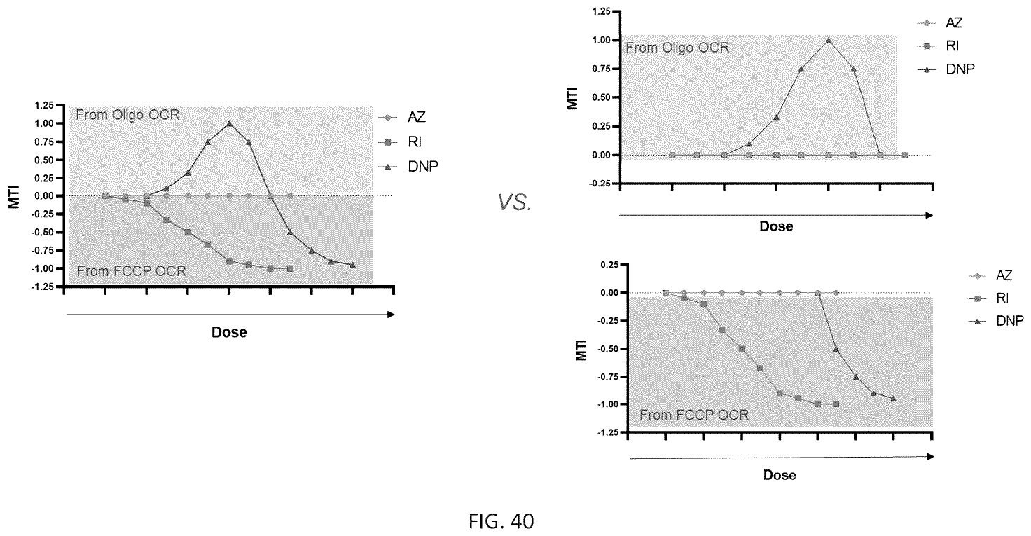

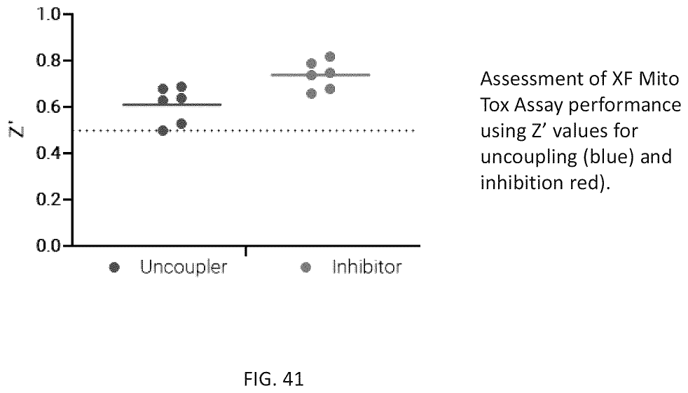

FIG. 38A refers to a scenario where a test compound results in an increase in Oligo induced OCR, compared to Vehicle (neg) control (MTI=0), then the compound is categorized as an Uncoupler, with a positive MTI value (e.g. MTI=0.6). Note that Vehicle FCCP OCR serves as a positive (+) control for uncoupling (MTI=1). FIGS. 40B-40C provide a summary of measurements and groups used for uncoupling controls.

In summary, the MTI is the fraction value of test compound effect compared to respective controls for either uncoupling and/or inhibition. The Uncoupler MTI is calculated as positive index number and is defined as the fraction of uncoupling elicited by a test compound compared to maximal uncoupling (FCCP OCR of the vehicle group, positive control). Note that Oligo OCR of the Vehicle group serves as the negative control for uncoupling. Conversely, the Inhibitor MTI is calculated as negative index number and is defined as the fraction of inhibition elicited by a test compound compared to maximal inhibition. (FCCP OCR of the Rot/AA group, positive control). Note that FCCP OCR of the Vehicle group serves as the negative control in this case. Upon transformation, both uncoupler and inhibitor MTIs can be generated for each well. Exemplary MTI detection graphs are shown in FIG. 39.

A specific case of mito tox due to decreased of mito function is the direct inhibition of the ATP synthase (CV), or other components of the OxPhos machinery (e.g. ANT, Pi transporter). This type of inhibition often shows a decrease in basal OCR, while oligo and FCCP OCRs are significantly less affected (FIGS. 42A-42D). If a test compound treatment results in a decrease in Basal OCR, compared to Vehicle (neg) control (MTI=0), BUT does not result in significant decrease in maximal/FCCP induced OCR then the compound is categorized as an OPI.

### XF Mito Tox Assay Performance Metrics

The Z-factor is used as a measure of assay quality or assay performance (Zhang). Z′ factors are typically between 0 and 1.0 and may be interpreted as follows: Z′=1.0 is considered ideal assay performance. If 0.5<Z′<1.0, this is considered an excellent assay, meaning greatly decreased chances of reporting false positive or false negative results. If 0.0<Z′<0.5, this is considered to be marginal assay performance, with increased chances of reporting false positive and negative results. If the Z′ is less than 0, there is too much overlap between the positive and negative controls for the assay to be useful.

Z-factor can therefore be used as a measure of the quality or power of a screening assay. (Note Z′ is not the same as the z-score). In a screening campaign, there is typically a comparison of large numbers of single measurements of unknown samples to well-established positive and negative control samples. The purpose of the assay is to determine which, if any, of the single measurements are significantly different from the controls. To this end, the distribution of measurements from the positive control, negative control, and the other single measurements must be considered in order to determine the probability that each measurement may have occurred by chance. Further, these distributions cannot be determined a priori, the performance must be assessed post assay to show/predict that the assay would be useful in a screening (or user defined) setting. The greater the Z′ value, the less chance that the assay is reporting false positives and/or false negatives.

In the XF Mito Tox Assay, corresponding Z′ Factors are provided for both Uncoupling and Inhibition to allow assessment of assay performance, as each has respective positive and negative control. The Z′ Factor is calculated as follows:

Z′=1−[3(mean of pos control+mean of neg control)/(Std Dev of pos control−Std Dev of neg control)]

Surprisingly, the precision improvements of the device described here-in enable a simplifying Mito Tox metric (MTI) that is capable of achieving excellent Z′ values (>0.5) even in the absence of cell normalization (where data are corrected to accounted for variation in cell growth across a microplate) (FIG. 41).

### Examples of Use

This performance means that the XF Mito Tox Assay may be performed as a compound screen (e.g., up to 80 individual compounds at a single dose per plate) or used to perform dose response assays (e.g. 8 compounds, 10 concentrations/compound per plate). When used together with respective software tools, resulting kinetic OCR data is automatically transformed into MTI values for each test compound.

Modes of Mito Tox detected and measured using the XF Mito Tox Assay were calculated. Compound/substances that exert effects on transport, TCA, FAO, ETC (compound/substances that result in decreases FCCP induced) OCR are categorized as Inhibitors. Compound/substances that act as protonophores which uncouple the ETC from the OxPhos that result in increases in Oligo OCR are categorized as Uncouplers. Compound/substances that cause inhibition of the OxPhos machinery (ATP synthase, ANT, Pi transporter) and result in decreases in Basal OCR only are categorized as “OPIs”.

Dependent on the context/goal of the mito tox investigation, test compounds may be further subject to dose response assays including dose response curves and IC50/EC50 values. FIG. 40 shows kinetic dose response OCR data for 3 compounds, which were then transformed to MTI values for each dose and plotted vs. compound concentration (FIG. 40). IC50 (or EC50) values were calculated for each sample.

### Experimental Methods

All cell lines were maintained according to manufacturer recommendations. HepG2 cells were seeded in XF Pro Moat cell culture microplates at a density of 2.0×10⁴ cells per well and cultured in DMEM low glucose (Gibco 11885) supplemented with 2 mM Glutamax and 10% serum. All cells were incubated overnight at 37° C., 5% CO₂. The following day, cells were washed twice with Mito Tox Assay Media (XF DMEM pH 7.4 plus 10 mM XF Glucose, 1 mM XF Pyruvate, and 2 mM XF Glutamine) and incubated at 37° C., no CO₂, for 60 minutes. Pretreatment solutions were added at the time of cell washing. Cell plates were then transferred to XF Pro analyzers for assay performance, using sequential injection of oligomycin (1.5 μM), FCCP (1.5 μM), rotenone/antimycin A (0.5 μM each)(final concentrations), cells were then counted using a Cytation 5 device.

All XF assays were performed as described in the XF Mito Tox Kit User Guide, including compound dilutions and sensor cartridge preparation. Agilent Seahorse Analytics is a web-based software platform that provides a simple, streamlined data analysis workflow for the XF Mito Tox assay. Seahorse Analytics was used to calculate key parameters of the XF Mito Tox assay—Mito Tox Index (MTI value) and/or IC50/EC50 values. Instructions to perform data analysis using Seahorse Analytics User Guide.

### Example 5: The Presently Disclosed Analyzer Exhibits Improved Measurement Precision, Relative to a Comparative Analytical Instrument

THP-1 cells were cultured in RPMI cell culture medium (supplemented with 10% FBS, 10 mM glucose, 2 mM glutamine, and 1 mM pyruvate) at 37 C in 5% CO₂. Cell density was maintained below 10⁶ cells/mL and culture medium was refreshed every 48-72 hours.

The cell suspension was transferred to a centrifuge tube, and the cells were centrifuged at 1000×g for 10 minutes. Cells were resuspended in an assay medium consisting of RPMI supplemented with 1 mM HEPES buffer (wherein sodium bicarbonate was replaced with an osmotic equivalent concentration of NaCl) pH 7.4, 10 mM Glucose, 2 mM glutamine, and 1 mM pyruvate. The resuspended cells were diluted in separate tubes to concentrations of 2×10⁴, 5×10⁴, 1×10⁵, 1.5×10⁵, 2×10⁵, 3×10⁵, and 4×10⁵ cells/well. Six replicate wells were seeded for each concentration on each of two 96-well plates that were pre-coated with poly-D-lysine and pre-warmed at 37° C. overnight. 50 μL of resuspended cells were added to each well such that the final concentrations in each well were 1×10³, 2.5×10³, 5×10³, 7.5×10³, 1×10⁴, 1.5×10⁴, or 2×10⁴ cells/well. The 96-well plates were centrifuged at 200×g for 1 minute and assay medium was added such that each well had a final volume of 180 μL. The 96-well plates were incubated at 37 C in a non-CO₂ incubator for 30 min.

One of the 96-well plates was placed in an analytical instrument as described herein. The other plate was placed in a comparative analytical instrument having conventional temperature control, signal processing, and motion actuator motor components. Each instrument was programmed with command instructions. In this case, the instrument was programmed to take three measurements, inject each well with 20 μL of the solution from port A from a cartridge disposed above the cell sample in a well, conduct three measurements, inject each well with 22 μL of the solution from port B from a cartridge disposed above the cell sample in a well, and take a final three measurements. The instrument was programmed to take a measurement every six minutes, with each six minute interval comprising a three minute mixing step and a three minute measuring step.

An oligomycin solution was prepared to 15 μM in assay media. A mix solution of 5 μM rotenone and 5 μM antimycin A was prepared in assay media. Ports of a pre-hydrated cartridge for each well were loaded with the 15 μM oligomycin solution (Port A) and the 5 μM Rotenone+5 μM antimycin A solution (Port B). The hydrated assay cartridge containing the indicated reagents was loaded into the instrument and the experiment was performed according to the instrument protocol. The instrument measured OCR as described in the exemplary protocol of Example 1. Basal OCR was calculated as the average of the six replicate wells in each plate of the third measurement.

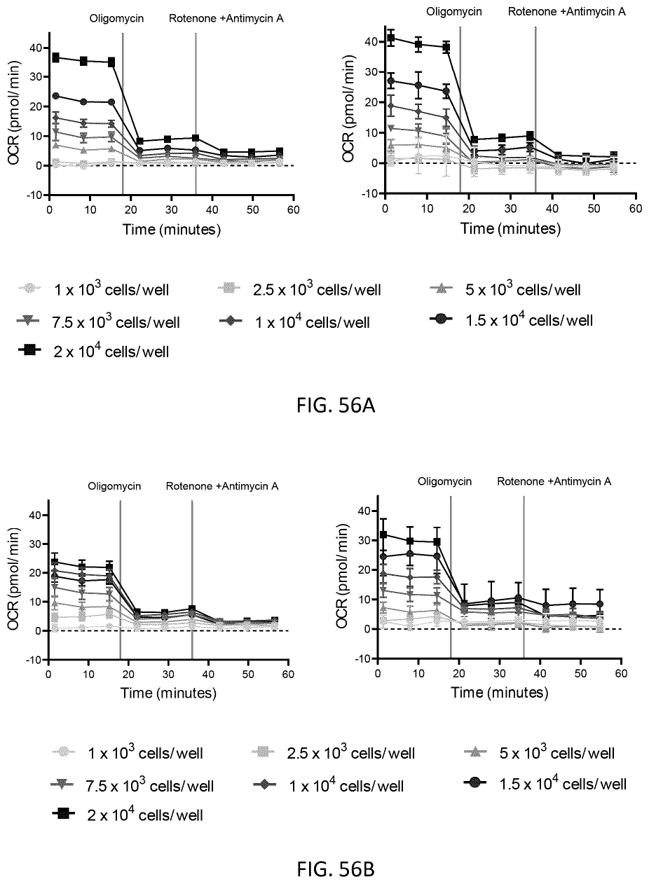

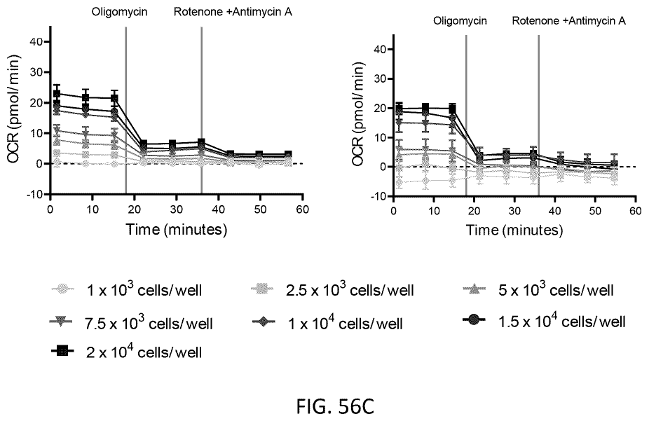

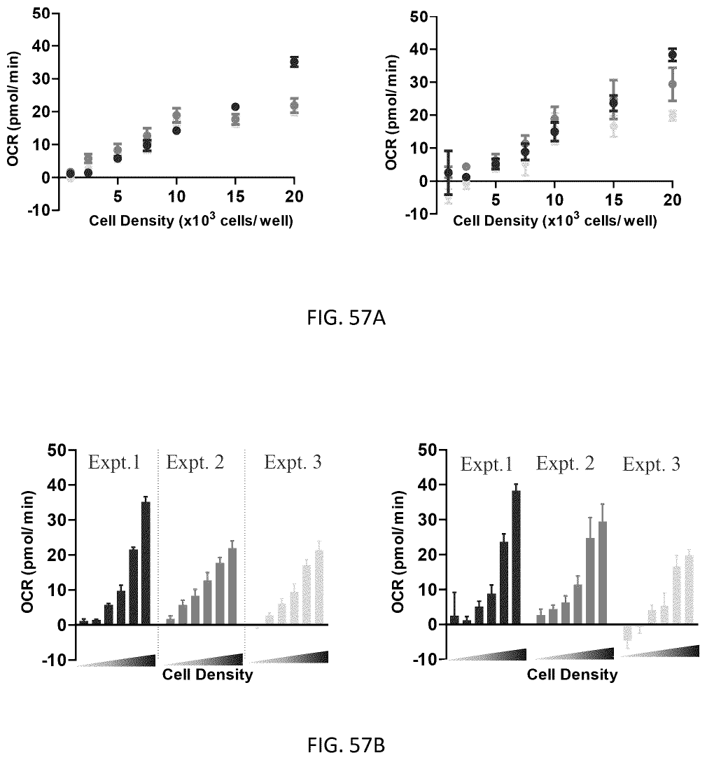

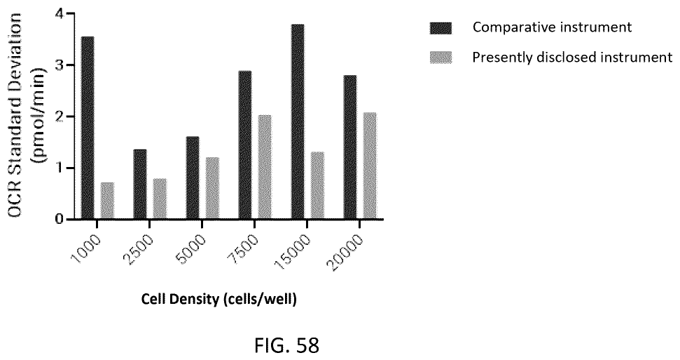

This experiment was performed three times and the results from each trial are shown individually in FIGS. 56A-56C. The basal OCRs from all the trials are summarized in FIGS. 57A-57B and the standard deviations across the trials are shown in FIG. 58. Collectively these data showed improved measurement performance of the instrument described herein, relative to the comparative analytical instrument at low oxygen consumption rates (OCR). Specifically, the data collected on the instrument described herein resulted in reduced occurrence of negative rates at low densities or after rotenone+antimycin A injections, lower standard deviations, reduced inter- and intra-plate variability, and more consistent measurements at low OCR. This was demonstrated using a combination of titrated seeding densities and with injections of mitochondria-inhibiting compounds. These improvements enabled more confident cell data interpretation due to repeatability and better resolution between assay groups.

### INCORPORATION BY REFERENCE

All publications, patents, and Accession numbers mentioned herein are hereby incorporated by reference in their entirety as if each individual publication or patent was specifically and individually indicated to be incorporated by reference.

### Exemplary Embodiments

The present disclosure may be understood as providing various different embodiments of the concepts that provide for multimode systems and methods for analyzing cells, which may include:

Clause 1: A device with extended duration measurement capabilities, comprising: a sensing system comprising an array of sensor units configured to generate a first signal in response to a first analyte over an extended duration, and a second signal in response to a second analyte, over the extended duration, each sensor unit of the array of sensor units positioned to correspond with a corresponding well on a sample carrier comprising an array of wells; a stage configured to receive the sample carrier; a motion actuator assembly configured to position at least one of the stage and the sensing system relative to one another on one or more of an x-axis, a z-axis, and a y-axis; a liquid handling system to dispense a substance into at least one well of the sample carrier; a sample control element configured to control a characteristic of samples within at least one well of the sample carrier over the extended duration to be within a predefined amount of another sample within another well of the sample carrier; and a controller operatively connected to the sensing system and the sample control element, configured to: control, for the extended duration, one or more of a temperature, a humidity, and a gas content of an environment surrounding the sample cater; and acquire data corresponding to the first signal and second signal for at least two points spanning the extended duration.

Clause 2: The device as described in any of clauses 1-21, wherein the extended duration measurement is made in a microchamber with a reduced volume of no greater than 3 microliters produced by the sensor unit of the array of sensor units moving down a predefined positioned into a corresponding well in the sample carrier.

Clause 3: The device as described in any of clauses 1-21, wherein the extended duration measurement is made in a non-continuous manner between a single modality selected from the group consisting of flux measurement, impedance measurement, and imaging.

Clause 4: The device as described in any of clauses 1-21, wherein the extended duration measurement is made in a non-continuous manner between at least two modalities selected from the group consisting of flux measurement, impedance measurement, and imaging.

Clause 5: The device as described in any of clauses 1-21, wherein the control element controls a sample environment to maintain environmental parameters at target levels of an associated well in the sample carrier.

Clause 6: The device as described in any of clauses 1-21, wherein the target levels for the environmental parameters are programmatically changed over a time of the extended duration measurement.

Clause 7: The device as described in any of clauses 1-21, wherein the control element controls the sample environment to achieve a target cellular microenvironment for a biological model in the sample via at least one of direct cellular/intracellular/pericellular/proximate measurements of sample parameters.

Clause 8: The device as described in any of clauses 1-21, wherein the cellular microenvironment is controlled on a per-sample basis.

Clause 9: The device as described in any of clauses 1-21, wherein the target levels for the sample parameters are programmatically changed over a time of the extended duration measurement.

Clause 10: The device as described in any of clauses 1-21, further comprising a venting system configured to change a headspace gas composition in a cellular microenvironment.

Clause 11: The device as described in any of clauses 1-21, wherein the sample control element comprises one or both of: a sample temperature control element configured to control the temperature of the sample; or a sample environmental control element comprising one or both of: a gaseous control element configured to control the gas content of one or more of O2, CO2, and N2 content of the sample, or a humidity control element configured to control the humidity of the environment.

Clause 12: The device as described in any of clauses 1-21, wherein the sample control element comprises a heater.

Clause 13: The device as described in any of clauses 1-21, wherein the first signal measures the first analyte in proportion to an O2 content in a given well and the second signal measure the second analyte in proportion to a pH value in the given well.

Clause 14: The device as described in any of clauses 1-21, wherein the first signal is measured in parallel to the second signal.

Clause 15: The device as described in any of clauses 1-21, wherein the extended duration is between 6 hours and 72 hours, 6 hours to 170 hours, 6 hours to 168 hours between 12 hours and 60 hours, between 24 hours and 48 hours, between 12 hours and 36 hours, between 24 hours and 48 hours, between 36 hours and 60 hours, between 6 hours and 60 hours, between 6 hours and 48 hours, between 6 hours and 36 hours, between 6 hours and 24 hours, between 6 hours and 12 hours, between 60 hours and 72 hours, between 48 hours and 72 hours, between 36 hours and 72 hours, between 24 hours and 72 hours, between 12 hours and 72 hours, between 12 hours and 24 hours, between 24 hours and 36 hours, between 36 hours and 48 hours, or between 48 hours and 60 hours.

Clause 16: The device as described in any of clauses 1-21, further comprising: an image capture element configured to image a sample or a feature of the sample within each well of a plurality of wells defined in the sample carrier through an opening or a window; wherein the image capture element is configured to capture and process at least one image from each well of the sample carrier.

Clause 17: The device as described in any of clauses 1-21, wherein the sample carrier comprises: a plurality of wells configured to hold a predetermined amount of a sample, wherein each well of the plurality of wells comprises the opening or the window that allows for an image capture element to capture at least one image from each well of the sample carrier.

Clause 18: The device as described in any of clauses 1-21, further comprising: an electrode surface comprising a non-conductive carrier on a base of the sample carrier; a plurality of electrode arrays positioned on the sample carrier, wherein each electrode array comprises at least two electrode structures positioned on a single plane and having substantially a same surface area; and a plurality of connection pads located on the sample carrier, wherein each connection pad is in electrical communication with at least one of the electrode structures in each well of the plurality of wells.

Clause 19: The device as described in any of clauses 1-21, wherein a plurality of wells configured to hold a predetermined amount of a sample are positioned above the plurality of electrode arrays, wherein each well of the plurality of wells comprises the opening or the window that allows for the image capture element to capture at least one image from each well of the sample carrier.

Clause 20: The device as described in any of clauses 1-21, further comprising: an impedance measurement device configured to: measure impedance changes resulting from attachment of samples within each well of the sample carrier; or stimulate samples with electrical signals within each well of the sample carrier, wherein the electrode surface is at a base of the sample carrier, and wherein the electrode surface comprises a non-conductive carrier; a plurality of electrode arrays positioned on the sample carrier, wherein each electrode array comprises at least two electrode structures positioned on a shared plane and having substantially a same surface area; a plurality of connection pads located on the sample carrier, wherein each connection pad is in electrical communication with at least one of the electrode structures; wherein the impedance element detects a change in electrical impedance between or among the electrode structures or stimulates the sample with electrical signals; and wherein the impedance element detects a change in electrical impedance between or among the electrode structures or stimulation outputs of the sample from electrical signals.

Clause 21: The device as described in any of clauses 1-21, wherein a plurality of wells configured to hold a predetermined amount of a sample are positioned above the plurality of electrode arrays, wherein each well of the plurality of wells comprises the opening or the window that allows for the image capture element to capture at least one image from each well of the sample carrier

Clause 22: A device with extended duration measurement capabilities, comprising: a sensing system comprising an array of sensor units configured to generate a first signal in response to a first analyte over an extended duration of at least six hours, and a second signal in response to a second analyte, over the extended duration, each sensor unit of the array of sensor units positioned to correspond with a corresponding well on a sample carrier comprising an array of wells; a stage configured to receive the sample carrier; a motion actuator assembly configured to position one or both of the stage and the sensing system relative to one another on one or more of an x-axis, a z-axis, and a y-axis; a liquid handling system to dispense agents into samples within each well of the sample carrier; a sample control element comprising one or both of: a sample temperature control element configured to control temperature within each well of the sample carrier to be within a predetermined temperature of each other; or a sample environmental control element comprising one or both of: a gaseous control element configured to control O2, CO2, and N2 content of each well of the sample carrier to be within a predetermined ratio of each other; or a humidity control element configured to control a humidity within each well of the sample carrier to be within a predetermined amount of each other; an image capture element, configured to image a sample or a feature of the sample within each well of the sample carrier through an opening, wherein the image capture element is configured to capture at least one image from each well of the sample carrier; an impedance element comprising an electrode surface configured to measure impedance changes resulting from attachment of samples or to stimulate samples with electrical signals within each well of the sample carrier, wherein the electrode surface is at a base of the sample carrier, and wherein the electrode surface comprises a non-conductive carrier; a plurality of electrode arrays positioned on the sample carrier, wherein each electrode array comprises at least two electrode structures positioned on a shared plane and having substantially a same surface area; a plurality of connection pads located on the sample carrier, wherein each connection pad is in electrical communication with at least one of the electrode structures; and wherein the impedance element detects a change in electrical impedance between or among the electrode structures or stimulates the sample with electrical signals; and a signal processing module operatively connected to the sensing system, configured to receive and condition the first signal and the second signal from sensor unit, and process at least one image from the image capture element and measure the change in electrical impedance from the impedance element between or among the electrode structures or stimulation output of the sample from electrical signals.

Clause 23: A device with extended duration measurement capabilities comprising: a sensing system comprising an array of sensor units configured to generate a first signal in response to a first analyte over an extended duration of at least six hours, and a second signal in response to a second analyte, over the extended duration, each sensor unit of the array of sensor units positioned to correspond with a corresponding well on a sample carrier comprising an array of wells; a stage configured to receive the sample carrier; a motion actuator assembly configured to position at least one of the stage and the sensing system relative to one another on one or more of an x-axis, a z-axis, and a y-axis; a liquid handling system configured to dispense agents into samples within each well of the sample carrier; a sample control element comprising one or both of: a sample temperature control element configured to control temperature within each well of the sample carrier to be within a predetermined temperature of each other; or a sample environmental control element comprising one or both of: a gaseous control element, configured to control O2, CO2, and N2 content of each well of the sample carrier to be within a predetermined ratio of each other; and a humidity control element configured to control a humidity within each well of the sample carrier to be within a predetermined amount of each other; an impedance element comprising an electrode surface configured to measure impedance changes resulting from attachment of samples or to stimulate samples with electrical signals within each well of the sample carrier, wherein the electrode surface is at a base of the sample carrier, and wherein the electrode surface comprises a non-conductive carrier; a plurality of electrode arrays positioned on the sample carrier, wherein each electrode array comprises at least two electrode structures positioned on the same plane and having substantially the same surface area; a plurality of connection pads located on the sample carrier, wherein each connection pad is in electrical communication with at least one of the electrode structures; and wherein the impedance element detects a change in electrical impedance between or among the electrode structures or stimulates samples held in the sample carrier with electrical signals; and a signal processing module operatively connected to the sensing system, configured to receive and condition the first signal and the second signal from sensor unit, and measure the change in electrical impedance from the impedance element between or among the electrode structures or stimulation output of the sample from electrical signals.

Clause 24: The device as described in clause 23, further comprising: an image capture element configured to image a sample or a feature of the sample within each well of the sample carrier through an opening, wherein the image capture element is configured to capture at least one image from each well of the sample carrier.

Clause 25: A device with extended duration measurement capabilities, comprising: a sensing system comprising an array of sensor units configured to generate a first signal in response to a first analyte over an extended duration of at least six hours, and a second signal in response to a second analyte, over the extended duration, each sensor unit of the array of sensor units positioned to correspond with a corresponding well on a sample carrier comprising an array of wells; a stage configured to receive the sample carrier; a motion actuator assembly configured to position at least one of the stage and the sensing system relative to one another on one or more of an x-axis, a z-axis, and a y-axis; a liquid handling system configured to dispense agents into samples within each well of the sample carrier; a sample control element comprising one or both of: a sample temperature control element configured to control temperature within each well of the sample carrier to be within a predetermined temperature of each other; or a sample environmental control element comprising one or both of: a gaseous control element, configured to control O2, CO2, and N2 content of each well of the sample carrier to be within a predetermined ratio of each other; or a humidity control element configured to control a humidity within each well of the sample carrier to be within a predetermined amount of each other; an image capture element configured to image a sample or a feature of the sample within each well of the sample carrier through an opening, wherein the image capture element is configured to capture at least one image from each well of the sample carrier; and a signal processing module operatively connected to the sensing system, configured to receive and condition the first signal and the second signal from sensor unit, and process at least one image from the image capture element.

Clause 26: The device as described in clause 25, further comprising: an impedance element comprising an electrode surface configured to measure impedance changes resulting from attachment of samples or to stimulate samples with electrical signals within each well of the sample carrier, wherein the electrode surface is at a base of the sample carrier, and wherein the electrode surface comprises a non-conductive carrier; a plurality of electrode arrays positioned on the sample carrier, wherein each electrode array comprises at least two electrode structures positioned on the same plane and having substantially the same surface area; a plurality of connection pads located on the sample carrier, wherein each connection pad is in electrical communication with at least one of the electrode structures; and wherein the impedance element detects a change in electrical impedance between or among the electrode structures or stimulates the sample with electrical signals.

Clause 27: A device with extended duration measurement capabilities comprising: an impedance element comprising an electrode surface configured to perform one or both of: measurement of impedance changes resulting from attachment of a sample; or stimulation of a sample with an electrical signal within each well of a plurality of wells defined in a sample carrier, wherein the electrode surface is at a base of the sample carrier, and wherein the electrode surface comprises a non-conductive carrier; a plurality of electrode arrays positioned on the sample carrier, wherein each electrode array comprises at least two electrode structures positioned on a single plane and having substantially a same surface area; a plurality of connection pads located on the sample carrier, wherein each connection pad is in electrical communication with at least one of the electrode structures, wherein the impedance element detects a change in electrical impedance between or among the electrode structures or stimulates the sample with electrical signals; an image capture element configured to image a sample or a feature of the sample within each well of the sample carrier through an opening, wherein the image capture element is configured to capture at least one image from each well of the sample carrier; and a signal processing module operatively connected to the impedance element, configured to measure the change in electrical impedance from the impedance element and process at least one image from the image capture element.

Clause 28: A sample carrier, comprising: a plurality of wells configured to hold a predetermined amount of a sample, wherein each well of the plurality of wells comprises an opening that allows for an image capture element to capture at least one image from each well of the sample carrier; an electrode surface comprising a non-conductive carrier on a base of the sample carrier; a plurality of electrode arrays positioned on the sample carrier, wherein each electrode array comprises at least two electrode structures positioned on a single plane and having substantially a same surface area; a plurality of connection pads located on the sample carrier, wherein each connection pad is in electrical communication with at least one of the electrode structures in each well of the plurality of wells; and a plurality of structures that when mated with a sensor unit of an array of sensor units create a microchamber with a reduced volume.

Clause 29: The sample carrier as described in any of clauses 29-38, wherein the reduced volume is less than or equal to 3 microliters.

Clause 30: The sample carrier as described in any of clauses 29-38, wherein structures of the plurality of structures are shelves, lips, bumps, or stops that are configured to control how far the sensor unit is able to project downward into the plurality of wells to a predefined distance.

Clause 31: The sample carrier as described in any of clauses 29-38, wherein the sample carrier is a microtiter plate, a flow chip, or a 3D tissue or spheroid formation/measuring plate.

Clause 32: The sample carrier as described in any of clauses 29-38, wherein one or more wells of the sample carrier are made of materials that limit gas diffusion.

Clause 33: The sample carrier as described in any of clauses 29-38, wherein one or more wells of the sample carrier comprise a window through the electrodes, that allows for viewing the cell sample or imaging from the bottom of the well.

Clause 34: The sample carrier as described in any of clauses 29-38, wherein one or more wells of the sample carrier do not comprise a window through the electrodes such that viewing the cell sample or imaging is performed from a top of the well opposite to where the electrodes are defined.

Clause 35: The sample carrier as described in any of clauses 29-38, wherein the sample carrier comprises a lid.

Clause 36: The sample carrier as described in any of clauses 29-38, wherein the lid comprises one or more sensors that measure at least one of O2, pH, and CO2.

Clause 37: The sample carrier as described in any of clauses 29-38, wherein the sample carrier comprises a cartridge.

Clause 38: The sample carrier as described in any of clauses 29-38, wherein the cartridge comprises one or more sensors or compound/substance ports.

Clause 39: A device, comprising: a sample carrier comprising a plurality of wells, wherein each well of the plurality of wells: is in fluid isolation from each other wells of the plurality of wells and includes an electrode configured: for measuring impedance of a sample disposed within a given well; and to define a window through which the sample is visible from outside of the sample carrier; a flux detector, configured to individually address each well of the plurality of wells of the sample carrier and detect a first analyte; an image capture element configured to image a sample disposed in a well of the plurality of wells of the sample carrier through the window and to capture an image from each well of the plurality of wells of the sample carrier; and an environmental control module for maintaining environmental parameters ambient to the sample carrier within a predetermined range for a duration of at least six hours at a time.

Clause 40: The device as described in any of clauses 39-48, wherein the environmental control module maintains a CO2 concentration, an O2 concentration, and an N2 concentration in an atmosphere of an environment surrounding the plurality of wells.

Clause 41: The device as described in any of clauses 39-48, further comprising: a flux cartridge that is moveable, relative to the sample carrier, on an axis that is substantially perpendicular to a plane that intersects each well of the plurality of wells of the sample carrier, wherein the flux cartridge comprises a plurality of heads, wherein: the flux cartridge is configured such that each well of the plurality of wells of the sample carrier is addressable by a head from the plurality of heads; and each head of the plurality of heads, which addresses a given well, comprises a surface proximal to the sample carrier, that defines a reaction chamber within the well, and is configured to limit a volume of liquid or evaporation from the reaction chamber.

Clause 42: The device as described in any of clauses 39-48, wherein each well of the plurality of wells comprises a volume defining member configured to:
limit a range of motion between the sample carrier and a second element of the device; or
define a minimum non-zero distance between the sample carrier and the second element of the system.

Clause 43: The device as described in any of clauses 39-48, wherein the volume defining member comprises at least one of: a shelf; a bump; a lip; and a positional control for a motor that moves the sample carrier relative to the sensor array that stops at a certain distance above a base of a corresponding well.

Clause 44: The device as described in any of clauses 39-48, wherein the sample carrier is movable relative to the flux detector and the image capture element to permit the flux detector and the imaging element sequential access to the sample carrier.

Clause 45: The device as described in any of clauses 39-48, further comprising a liquid handling module configured to deliver a liquid to the sample carrier.

Clause 46: The device as described in any of clauses 39-48, wherein the sample carrier is movable relative to the liquid handling module.

Clause 47: The device as described in any of clauses 39-48, wherein the liquid handling module is configured to deliver the liquid to an individual well of the plurality of wells.

Clause 48: The device as described in any of clauses 39-48, wherein the flux detector is configured to detect a second analyte.

Clause 49: A device, comprising: a chamber configured to accept: a sample carrier, that includes a plurality of wells; and a cartridge, including a compound; a camera, disposed in the chamber beneath where the sample carrier is accepted into the chamber, configured to capture images of contents of individual wells of the plurality of wells; a sensor, disposed in the chamber, configured to monitor cell growth in the individual wells of the plurality of wells; a temperature controller, configured to regulate a temperature of samples held in the individual wells of the plurality of wells and the sensor; a fluid handler, in communication with the sample carrier and the compound, configured to deliver the compound from the cartridge to a given well of the plurality of wells based on one or more of pH of the contents of the given well and an image of the given well captured by the camera.

Clause 50: The device as described in clause 49, further comprising an environmental controller, configured to regulate a temperature of an atmosphere in the chamber, a CO2 concentration of the atmosphere, and an O2 concentration of the atmosphere.

Clause 51: A device, comprising: a chamber configured to accept: a sample carrier, that includes a plurality of wells, each well of the plurality of wells having a first electrode in contact with a first side of the well and a second electrode contact with a second side, opposite to the first side, of the well that are each in electrical communication with an electrical measurement module on the sample carrier; and a cartridge, including a compound and at least one delivery port for the compound; a temperature controller, configured to regulate a temperature of samples held in individual wells of the plurality of wells and the electrical characteristic measurement module; and a fluid handler, in communication with the sample carrier and the cartridge, configured to deliver the at least one compound from the cartridge to a given well of the plurality of wells and a measurement of sample in the given well taken by the electrical measurement module between the first electrical contact and the second electrical contact.

Clause 52: The device as described in any of clauses 51-53, wherein the measurement of sample is measurement of cell growth in the given well as an impedance value or is a measurement of cell stimulation.

Clause 53: The device as described in any of clauses 51-53, further comprising an environmental controller, configured to regulate a temperature of an atmosphere in the chamber, a CO2 concentration of the atmosphere, and an O2 concentration of the atmosphere.

Clause 54: A device, comprising: a chamber configured to accept: a sample carrier, that includes a plurality of wells, wherein each well of the plurality of wells having a first electrode in contact with a first side of the well and a second electrode in contact with a second side, opposite to the first side, of the well that are each in electrical communication with an impedance meter on the sample carrier; and a cartridge, including a compound and at least one delivery port for the compound; a camera, disposed in the chamber below where the sample carrier is accepted, configured to capture images of a cell culture in each individual well of the plurality of wells via an associated window in each individual well when the sample carrier is positioned at a first location in the chamber; a fluid handler, in communication with the sample carrier and the cartridge when the sample carrier is positioned at a second location in the chamber, configured to deliver the compound from the cartridge to a given well of the plurality of wells based on an impedance measurement of a sample in the given well taken by the impedance meter between the first electrical contact and the second electrical contact; and a motion stage in contact with the sample carrier configured to move the sample carrier between the first location and the second location.

Clause 55: The device as described in any of clauses 54-56, further comprising: a temperature controller, configured to regulate a temperature of samples held in the individual wells of the plurality of wells.

Clause 56: The device as described in any of clauses 54-56, further comprising: an environmental controller, configured to regulate a temperature of an atmosphere in the chamber, a CO2 concentration of the atmosphere, and an O2 concentration of the atmosphere.

Clause 57: A method of using a device of any of the preceding claims, comprising: loading a sample carrier comprising one or more cell samples, each sample disposed within a corresponding well of the sample carrier, into the device.

Clause 58: The method as described in any of clauses 57-59, wherein the sample is analyzed over an extended duration between 6 hours and 72 hours.

Clause 58: The method as described in any of clauses 57-59, wherein the cell samples comprise live cells.

Clause 60: A method of analyzing a cell sample, comprising: providing a device of any of the preceding claims; and loading a sample carrier comprising one or more cell samples, each sample disposed within a corresponding well of the sample carrier, into the device; thereby analyzing the cell sample.

Clause 61: The method as described in any of clauses 60-80, wherein the sample is analyzed over an extended duration between 6 hours and 72 hours.

Clause 62: The method as described in any of clauses 60-80, further comprising positioning one or both of the stage and the sensing system relative to one another on one or more of an x-axis, a z-axis, and a y-axis.

Clause 63: The method as described in any of clauses 60-80, further comprising dispensing a compound into the sample within each well of the sample carrier.

Clause 64: The method as described in any of clauses 60-80, further comprising controlling a temperature within each well of the sample carrier to be within a predetermined temperature of each other.

Clause 65: The method as described in any of clauses 60-80, further comprising controlling a gas content of each well of the sample carrier to be within a predetermined ratio of each other.

Clause 66: The method as described in any of clauses 60-80, comprising generating a first signal in response to a first analyte over an extended duration, and a second signal in response to a second analyte over the extended duration.

Clause 67: The method as described in any of clauses 60-80, further comprising receiving and conditioning the first signal and the second signal from the sensor unit.

Clause 68: The method as described in any of clauses 60-80, further comprising calculating one or more metabolic flux parameters, including at least one of: oxygen consumption rate (OCR), extracellular acidification rate (ECAR), and/or proton efflux rate (PER).

Clause 69: The method as described in any of clauses 60-80, further comprising imaging a sample or a feature of the sample within each well of the sample carrier through an opening.

Clause 70: The method as described in any of clauses 60-80, further comprising processing at least one image from the image capture element.

Clause 71: The method as described in any of clauses 60-80, further comprising measuring impedance changes of the sample.

Clause 72: The method as described in any of clauses 60-80, wherein the sample comprises live cells.

Clause 73: The method as described in any of clauses 60-80, wherein the sample comprises one or more of loose cells, cell constructs, loose tissue, tissue constructs, organelles, enzymes, cell products or byproducts, and conditioned medium.

Clause 74: The method as described in any of clauses 60-80, wherein the sample comprises mammalian cells or tissue.

Clause 75: The method as described in any of clauses 60-80, wherein the sample comprises stem cells.

Clause 76: The method as described in any of clauses 60-80, wherein the sample comprises cells of the cardiovascular system.

Clause 77: The method as described in any of clauses 60-80, wherein the sample comprises non-mammalian cells or tissue.

Clause 78: The method as described in any of clauses 60-80, wherein the sample comprises single-celled organisms.

Clause 79: The method as described in any of clauses 60-80, wherein the sample comprises whole animal model tissues.

Clause 80: The method as described in any of clauses 60-80, wherein the sample comprises whole plant model tissues or plant model cells.

### EQUIVALENTS

While specific embodiments of the subject invention have been discussed, the above specification is illustrative and not restrictive. Many variations of the invention will become apparent to those skilled in the art upon review of this specification and the claims below. The full scope of the invention should be determined by reference to the claims, along with their full scope of equivalents, and the specification, along with such variations.

What is claimed is:

1. A device with extended duration measurement capabilities, comprising:
a sensing system comprising an array of sensor units configured to generate a first signal in response to a first analyte over an extended duration, and a second signal in response to a second analyte, over the extended duration, each sensor unit of the array of sensor units positioned to correspond with a corresponding well on a sample carrier comprising an array of wells;
a stage configured to receive the sample carrier;
a motion actuator assembly configured to position at least one of the stage and the sensing system relative to one another on one or more of an x-axis, a z-axis, and a y-axis;
a liquid handling system to dispense a substance into at least one well of the sample carrier;
a sample control element configured to control a characteristic of samples within at least one well of the sample carrier over the extended duration to be within a predefined amount of another sample within another well of the sample carrier; and
a controller operatively connected to the sensing system and the sample control element, configured to:
control, for the extended duration, one or more of a temperature, a humidity, and a gas content of an environment surrounding the sample carrier; and
acquire data corresponding to the first signal and second signal for at least two points spanning the extended duration.

2. The device of claim 1, wherein the extended duration measurement is made in a microchamber with a reduced volume of no greater than 3 microliters produced by the sensor unit of the array of sensor units moving down a predefined positioned into a corresponding well in the sample carrier.

3. The device of claim 1, wherein the extended duration measurement is made in a non-continuous manner between a single modality selected from the group consisting of flux measurement, impedance measurement, and imaging.

4. The device of claim 1, wherein the extended duration measurement is made in a non-continuous manner between at least two modalities selected from the group consisting of flux measurement, impedance measurement, and imaging.

5. The device of claim 1, wherein the control element controls a sample environment to maintain environmental parameters at target levels of an associated well in the sample carrier.

6. The device of claim 5, wherein the target levels for the environmental parameters are programmatically changed over a time of the extended duration measurement.

7. The device of claim 1, wherein the control element controls the sample environment to achieve a target cellular microenvironment for a biological model in the sample via at least one of direct cellular/intracellular/pericellular/proximate measurements of sample parameters.

8. The device of claim 7, wherein the cellular microenvironment is controlled on a per-sample basis.

9. The device of claim 5, wherein the target levels for the sample parameters are programmatically changed over a time of the extended duration measurement.

10. The device of claim 1, further comprising a venting system configured to change a headspace gas composition in a cellular microenvironment.

11. The device of claim 1, wherein the sample control element comprises one or both of:
a sample temperature control element configured to control the temperature of the sample; or
a sample environmental control element comprising one or both of:
a gaseous control element configured to control the gas content of one or more of O₂, CO₂, and N₂ content of the sample, or
a humidity control element configured to control the humidity of the environment.

12. The device of claim 11, wherein the sample control element comprises a heater.

13. The device of claim 1, wherein the first signal measures the first analyte in proportion to an O₂ content in a given well and the second signal measure the second analyte in proportion to a pH value in the given well.

14. The device of claim 1, wherein the first signal is measured in parallel to the second signal.

15. The device of claim 1, wherein the extended duration is between 6 hours and 72 hours, 6 hours to 170 hours, 6 hours to 168 hours between 12 hours and 60 hours, between 24 hours and 48 hours, between 12 hours and 36 hours, between 24 hours and 48 hours, between 36 hours and 60 hours, between 6 hours and 60 hours, between 6 hours and 48 hours, between 6 hours and 36 hours, between 6 hours and 24 hours, between 6 hours and 12 hours, between 60 hours and 72 hours, between 48 hours and 72 hours, between 36 hours and 72 hours, between 24 hours and 72 hours, between 12 hours and 72 hours, between 12 hours and 24 hours, between 24 hours and 36 hours, between 36 hours and 48 hours, or between 48 hours and 60 hours.

16. The device of claim 1, further comprising:
an image capture element configured to image a sample or a feature of the sample within each well of a plurality of wells defined in the sample carrier through an opening or a window;
wherein the image capture element is configured to capture and process at least one image from each well of the sample carrier.

17. The device of claim 1, wherein the sample carrier comprises:
a plurality of wells configured to hold a predetermined amount of a sample, wherein each well of the plurality of wells comprises the opening or the window that allows for an image capture element to capture at least one image from each well of the sample carrier.

18. The device of claim 1, further comprising:
an electrode surface comprising a non-conductive carrier on a base of the sample carrier;
a plurality of electrode arrays positioned on the sample carrier, wherein each electrode array comprises at least two electrode structures positioned on a single plane and having substantially a same surface area; and
a plurality of connection pads located on the sample carrier, wherein each connection pad is in electrical communication with at least one of the electrode structures in each well of the plurality of wells.

19. The device of claim 1, wherein a plurality of wells configured to hold a predetermined amount of a sample are positioned above the plurality of electrode arrays, wherein each well of the plurality of wells comprises the opening or the window that allows for the image capture element to capture at least one image from each well of the sample carrier.

20. The device of claim 1, further comprising:
an impedance measurement device configured to:
measure impedance changes resulting from attachment of samples within each well of the sample carrier; or
stimulate samples with electrical signals within each well of the sample carrier, wherein the electrode surface is at a base of the sample carrier, and wherein the electrode surface comprises a non-conductive carrier;
a plurality of electrode arrays positioned on the sample carrier, wherein each electrode array comprises at least two electrode structures positioned on a shared plane and having substantially a same surface area;
a plurality of connection pads located on the sample carrier, wherein each connection pad is in electrical communication with at least one of the electrode structures;
wherein the impedance element detects a change in electrical impedance between or among the electrode structures or stimulates the sample with electrical signals; and
wherein the impedance element detects a change in electrical impedance between or among the electrode structures or stimulation outputs of the sample from electrical signals.

21. The device of claim 20, wherein a plurality of wells configured to hold a predetermined amount of a sample are positioned above the plurality of electrode arrays, wherein each well of the plurality of wells comprises the opening or the window that allows for the image capture element to capture at least one image from each well of the sample carrier
